(19) United States
(12) Patent Application Publication
(10) Pub. No.: US 2026/0332931 A1
(43) Pub. Date: Oct. 22, 2026

(54) IN-EAR WEARABLE DEVICE

(71) Applicant: Earweiss Technology (Shenzhen) Co., Ltd., Shenzhen (CN)

(72) Inventors: Chunhong YU, Shenzhen (CN); Xinchao XIAO, Shenzhen (CN); Yizhou WANG, Shenzhen (CN); Rong TIAN, Shenzhen (CN)

(21) Appl. No.: 19/723,966

(22) Filed: Jun. 29, 2026

Related U.S. Application Data
(63) Continuation-in-part of application No. 19/225,652, filed on Jun. 2, 2025.
Application No. 19/225,652 is a continuation of application No. 18/187,998, filed on Mar. 22, 2023, now Pat. No. 12,323,756.

(30) Foreign Application Priority Data
Mar. 22, 2022 (CN) 202210286056.2
Jun. 27, 2025 (CN) 202521333844.8
Dec. 23, 2025 (CN) 202522731614.3
Dec. 26, 2025 (CN) 202522807558.7

(51) Int. Cl. H04R 1/10

(52) U.S. Cl. CPC H04R 1/1016; H04R 2420/07; H04R 2460/11

(57) ABSTRACT

An in-ear wearable device includes: a housing, a first speaker and a vent. The housing includes the first to fourth mounting portions. When a user is wearing the in-ear wearable device, the first mounting portion is disposed corresponding to the user's ear canal, the second mounting portion is disposed corresponding to the user's intertragic notch, the third mounting portion is disposed corresponding to the user's cymba conchae, and the fourth mounting portion is disposed corresponding to the user's cavum conchae. The first speaker is close to the first mounting portion, the vent is disposed on one of the second to fourth mounting portions, and the vent is configured to permit or restrict communication between the user's ear canal and the external environment. Thus, by reasonably arranging the components, a cavity can accommodate both the first speaker and the vent, thereby reducing the occlusion effect, improving comfortability and sound quality.

### CROSS-REFERENCE TO RELATED APPLICATIONS

This application is a continuation-in-part of U.S. application Ser. No. 19/225,652, filed on Jun. 2, 2025, which, in turn, is a continuation of U.S. application Ser. No. 18/187,998, filed on Mar. 22, 2023, the entire contents of each of which are incorporated herein by reference.

In addition, this application claims priority from Chinese Patent Application No. 202210286056.2, filed on Mar. 22, 2022, Chinese Patent Application No. 202521333844.8, filed on Jun. 27, 2025, Chinese Patent Application No. 202522731614.3, filed on Dec. 23, 2025, and Chinese Patent Application No. 202522807558.7, filed on Dec. 26, 2025, the entire contents of each of which are incorporated herein by reference.

### TECHNICAL FIELD

The disclosure relates to wearable devices, and particularly to an in-ear wearable device.

### BACKGROUND OF THE INVENTION

As the application scenarios of mobile devices such as smart phones are becoming extensive, and people use more and more audio and video services, wireless earphones are rapidly popularized because of the advantages such as portability and no entanglement, and TWS (True Wireless Stereo) Bluetooth earphones have become mainstream products of the wireless earphones due to the advantages such as short delay and good sound quality. However, the TWS Bluetooth earphones at present are most of standard sizes, which will cause discomfort to wearing users' ears after being worn for a long time, thereby limiting the wearing time and the application scenarios. In addition, when an in-ear wireless earphone is worn for a long time, an external acoustic meatus will be closed to generate an ear occlusion effect, such that the pressures inside and outside the ear are unbalanced and reduce the comfort, and moisture and infection may be caused due to the lack of ventilation in the acoustic meatus.

The occlusion effect also is a problem common to in-ear wearable devices; when the ear canal is closed by an in-ear wearable device, the speaking voice of a user may be transmitted into the ear canal by the skull, and due to a small volume of the ear canal, the reflection of low-frequency sound is enhanced, causing the use to perceive “echoey” or “hollow” sounds. Thus, when having worn the in-ear wearable device for a long time, the user may feel discomfort, thereby affecting the user experience.

Therefore, there is a need for an in-ear wearable device and an in-ear wireless earphone with improved wearing comfort.

### SUMMARY OF THE INVENTION

An objective of the disclosure is to provide an in-ear wearable device capable of improving the wearing comfort. Another objective of the disclosure is to provide an in-ear wearable device capable of being adapted to different use scenarios. Another objective of the disclosure is to provide an in-ear wearable device capable of ventilating an acoustic meatus. Another object of the disclosure is to provide an in-ear wearable device capable of defining different audio effects.

An aspect of the disclosure provides an in-ear wearable device, comprising: a customized housing having a housing wall and an inner cavity surrounded by the housing wall, the customized housing comprising a first portion before being inserted into an acoustic meatus of a user and matching with a shape of the acoustic meatus, and a second portion for being exposed to an external environment when the first portion is inserted into the acoustic meatus; a panel mounted to the customized housing at an open end of the second portion away from the first portion; a ventilation hole at least partially disposed in the customized housing, wherein a section of the ventilation hole disposed in the customized housing is formed in the housing wall; and a ventilation rate adjusting device mounted in the ventilation hole, wherein the ventilation hole and the ventilation rate adjusting device constitute at least a part of a ventilation channel which is isolated from the inner cavity of the customized housing, the ventilation channel is configured to fluidly connect the acoustic meatus of the user to the external environment when the user wears the in-ear wireless earphone, and the ventilation rate adjusting device is configured to electrically adjust a ventilation rate of the ventilation channel to adjust audio characteristics of the in-ear wearable device.

According to some embodiments of the disclosure, the ventilation channel is completely disposed in the customized housing.

According to some embodiments of the disclosure, the ventilation channel comprises a first section disposed in the customized housing and a second section disposed in the panel.

According to some embodiments of the disclosure, the ventilation hole comprises a first orifice for being exposed to the acoustic meatus and a second orifice for being exposed to the external environment when the user wears the in-ear wearable device, and the ventilation rate adjusting device is disposed at the second orifice of the ventilation hole.

According to some embodiments of the disclosure, the ventilation hole comprises a first orifice for being exposed to the acoustic meatus and a second orifice for being exposed to the external environment when the user wears the in-ear wearable device, and the ventilation rate adjusting device is disposed at a middle position of the ventilation hole spaced apart from both the first orifice and the second orifice.

According to some embodiments of the disclosure, the ventilation channel is a straight-through channel or a bent channel.

According to some embodiments of the disclosure, the ventilation rate adjusting device is configured to be electrically operable to switch between a fully open state for fully opening the ventilation channel and a fully closed state for fully closing the ventilation channel.

According to some embodiments of the disclosure, the ventilation rate adjusting device is configured to be electrically operable to be in a state of partially opening the ventilation channel.

According to some embodiments of the disclosure, the ventilation rate adjusting device is further configured to be electrically operable to continuously adjust the ventilation rate of the ventilation channel.

According to some embodiments of the disclosure, the ventilation rate adjusting device comprises a movable portion, a fixed portion and an electric actuator, and the electric actuator is configured to electrically drive the movable portion to move relative to the fixed portion to adjust the ventilation rate of the ventilation channel.

According to some embodiments of the disclosure, the customized housing comprises a window facing the inner cavity, and the electric actuator is electrically connected to a battery of the in-ear wearable device through the window.

According to some embodiments of the disclosure, the customized housing has an integral structure.

According to some embodiments of the disclosure, the ventilation rate adjusting device is disposed to be not exposed from an outer surface of the customized housing.

According to some embodiments of the disclosure, the ventilation rate adjusting device adopts an electromagnetic valve structure and comprises a piston as the movable portion, an outer shell as the fixed portion and an electromagnetic unit as the electric actuator, the outer shell comprises an opening communicated with the ventilation hole, and the ventilation rate adjusting device is configured to adjust the ventilation rate of the ventilation channel by using the electromagnetic unit to drive the piston to move relative to the outer shell.

According to some embodiments of the disclosure, the ventilation rate adjusting device comprises a connecting tube which connects the outer shell and the ventilation hole to isolate the ventilation channel from the inner cavity.

According to some embodiments of the disclosure, the electromagnetic unit comprises an electromagnetic coil, the piston comprises a magnet, and a moving direction of the piston is substantially parallel to an extending direction of the ventilation hole at the ventilation rate adjusting device.

According to some embodiments of the disclosure, the electromagnetic unit comprises an electromagnet, the piston comprises a magnet, and a moving direction of the piston is substantially perpendicular to an extending direction of the ventilation hole at the ventilation rate adjusting device.

According to some embodiments of the disclosure, the ventilation rate adjusting device adopts a butterfly valve structure, and comprises a valve plate as the movable portion, a valve body as the fixed portion and a motor as the electric actuator, the valve body comprises an opening communicated with the ventilation hole, the valve plate is disposed inside the valve body, and the ventilation rate adjusting device is configured to adjust the ventilation rate of the ventilation channel by using the motor to drive the valve plate to rotate in the valve body.

According to some embodiments of the disclosure, the ventilation rate adjusting device further comprises a first toothed engagement portion which is connected with the valve plate in a non-rotatable way and a second toothed engagement portion which is connected with an output shaft of the motor in a non-rotatable way, and the first toothed engagement portion and the second toothed engagement portion are meshed with each other.

According to some embodiments of the disclosure, the first toothed engagement portion is integrally formed with the valve plate.

According to some embodiments of the disclosure, the ventilation rate adjusting device further comprises a valve plate fixing member disposed outside the valve body, and the valve plate comprises an extending portion configured to pass through a wall of the valve body to be fixedly connected to the valve plate fixing member.

According to some embodiments of the disclosure, the extending portion is fixedly connected to the valve plate fixing member by an adhesive.

According to some embodiments of the disclosure, the ventilation rate adjusting device adopts a rotary-cover-with-opening structure and comprises a rotary cover as the movable portion, a base as the fixed portion and a motor as the electric actuator, the rotary cover comprises an opening, the base comprises an opening, and the ventilation rate adjusting device is configured to adjust the ventilation rate of the ventilation channel by using the motor to drive the rotary cover to rotate relative to the base.

According to some embodiments of the disclosure, the ventilation rate adjusting device further comprises a first toothed engagement portion which is connected with the rotary cover in a non-rotatable way and a second toothed engagement portion which is connected with an output shaft of the motor in a non-rotatable way, and the first toothed engagement portion and the second toothed engagement portion are meshed with each other.

According to some embodiments of the disclosure, the first toothed engagement portion is integrally formed with the valve plate.

According to some embodiments of the disclosure, the ventilation rate adjusting device further comprises a rotary cover fixing member disposed at an end of the base away from the rotary cover and a pin, and the pin is configured to pass through the base to fixedly connect the rotary cover and the rotary cover fixing member.

According to some embodiments of the disclosure, the pin is integrally formed with the rotary cover fixing member, the pin comprises external threads, and the rotary cover comprises an internal threaded hole engaged with the external threads of the pin.

According to some embodiments of the disclosure, a rotation axis of the rotary cover is substantially parallel to an extending direction of the ventilation hole at the ventilation rate adjusting device.

According to some embodiments of the disclosure, the ventilation rate adjusting device adopts an one-way valve structure and comprises a valve core as the movable portion, a valve seat as the fixed portion and a motor as the electric actuator, the valve seat comprises a fluid channel communicated with the ventilation hole, and the ventilation rate adjusting device is configured to adjust the ventilation rate of the ventilation channel by using the motor to drive the valve core to move relative to the valve seat.

According to some embodiments of the disclosure, the ventilation rate adjusting device further comprises a spring configured to apply an elastic force to the valve core, and the ventilation rate adjusting device is configured to drive the valve core to move relative to the valve seat against the elastic force of the spring by using the motor.

According to some embodiments of the disclosure, a moving direction of the valve core is substantially parallel to an extending direction of the ventilation hole at the ventilation rate adjusting device.

According to some embodiments of the disclosure, the ventilation rate adjusting device further comprises a first toothed engagement portion engaged with the valve core and a second toothed engagement portion which is connected with an output shaft of the motor in a non-rotatable way, and the first toothed engagement portion and the second toothed engagement portion are meshed with each other.

According to some embodiments of the disclosure, the ventilation rate adjusting device adopts an aperture structure, and comprises a plurality of blades as the movable portion, a fixed seat as the fixed portion, a rotary ring and a motor as the electric actuator, the fixed seat comprises a fluid channel communicated with the ventilation hole, and the ventilation rate adjusting device is configured to adjust the ventilation rate of the ventilation channel by using the motor to drive and rotate the rotary ring so as to move the blades relative to the fixed seat.

According to some embodiments of the disclosure, the blade comprises a first protrusion protruding from one surface and a second protrusion protruding from the other surface, the rotary ring comprises a driving groove for matching with the first protrusion, and the fixed seat comprises a sliding groove for matching with the second protrusion.

According to some embodiments of the disclosure, the ventilation rate adjusting device further comprises a first toothed engagement portion which is connected with the rotary ring in a non-rotatable way and a second toothed engagement portion which is connected with an output shaft of the motor in a non-rotatable way, and the first toothed engagement portion and the second toothed engagement portion are meshed with each other.

According to some embodiments of the disclosure, the first toothed engagement portion is integrally formed with the rotary ring.

According to some embodiments of the disclosure, the ventilation rate adjusting device adopts a plug structure, and comprises a plug member as the movable portion, a plug seat as the fixed portion and a motor as the electric actuator, the plug seat comprises a fluid channel communicated with the ventilation hole, and the ventilation rate adjusting device is configured to adjust the ventilation rate of the ventilation channel by using the motor to drive the plug member to move relative to the plug seat.

According to some embodiments of the disclosure, the plug member is configured to be driven by the motor so as to be inserted into and pulled out of the plug seat.

According to some embodiments of the disclosure, the plug member comprises a fluid channel, and the fluid channel of the plug member is in fluid communication with the fluid channel of the plug seat when the plug member is inserted into the plug seat.

According to some embodiments of the disclosure, the plug seat is integrally formed with the customized housing.

According to some embodiments of the disclosure, the ventilation rate adjusting device further comprises a first engagement portion fixedly connected to the plug member and a second engagement portion which is connected with an output shaft of the motor in a non-rotatable way, and the first engagement portion and the second engagement portion are threadedly engaged with each other.

According to some embodiments of the disclosure, the plug member is which is connected with an output shaft of the motor in a non-rotatable way, so that the motor can drive the plug member to rotate to be inserted into or pulled out of the plug seat.

According to some embodiments of the disclosure, the ventilation rate adjusting device further comprises a first toothed engagement portion fixedly connected to the plug member and a second toothed engagement portion which is connected with an output shaft of the motor in a non-rotatable way, and the first toothed engagement portion and the second toothed engagement portion are meshed with each other.

According to some embodiments of the disclosure, the first toothed engagement portion is integrally formed with the plug member.

According to some embodiments of the disclosure, the in-ear wearable device is an in-ear wireless earphone.

According to the embodiments of the disclosure, the in-ear wearable device comprises the ventilation hole in which the ventilation rate adjusting device is disposed. By electrically opening or closing the ventilation hole with the ventilation rate adjusting device, it is possible to switch between different use modes to overcome the ear occlusion effect, improve the wearing comfort for the user, and adapt to different use scenarios.

Another aspect of the disclosure provides an in-ear wearable device, including: a housing, the housing including a first mounting portion, a second mounting portion, a third mounting portion and a fourth mounting portion, wherein when a user is wearing the in-ear wearable device, the first mounting portion is disposed corresponding to an ear canal of the user, the second mounting portion is disposed corresponding to an intertragic notch of the user, the third mounting portion is disposed corresponding to a cymba conchae of the user, and the fourth mounting portion is disposed corresponding to a cavum conchae of the user, and the housing being provided with an accommodating cavity;
a first speaker, the first speaker being disposed in the accommodating cavity, and being close to the first mounting portion; and
a vent, the vent being disposed in the accommodating cavity, being disposed on one of the second mounting portion, the third mounting portion and the fourth mounting portion, and being configured to permit or restrict communication between the ear canal of the user and the external environment.

In one of the embodiments, one of the second mounting portion, the third mounting portion and the fourth mounting portion is provided with an accommodating recess, and at least a part of the vent is disposed in the accommodating recess.

In one of the embodiments, the first speaker divides the accommodating cavity into a front cavity and a rear cavity; and the in-ear wearable device further includes a ventilation channel, and the vent is configured to permit or restrict communication between the front cavity and the rear cavity through the ventilation channel.

In one of the embodiments, the ventilation channel is formed in a side wall of the housing; or the ventilation channel and the housing are independent of each other.

In one of the embodiments, the vent is disposed in the rear cavity, a wall of the rear cavity is provided with an accommodating recess, and a wall of the accommodating recess is provided with a communication hole; and the ventilation channel has a first end disposed in the front cavity and a second end disposed in the rear cavity, the first end is provided with a first ventilation hole, the first ventilation hole being in communication with the front cavity, and the second end is provided with a second ventilation hole, the second ventilation hole being in communication with the communication hole.

In one of the embodiments, the vent is provided with an air outlet hole, and the air outlet hole is in communication with the second ventilation hole through the communication hole.

In one of the embodiments, a wall of the rear cavity is provided with an air release hole the vent is provided with a valve and an air outlet hole, the air outlet hole is in communication with the front cavity through the ventilation channel, and the valve can be opened, so that the air outlet hole is in communication with the external environment through the air release hole.

In one of the embodiments, the in-ear wearable device further includes a main board a a flexible circuit board, the main board and the flexible circuit board are both disposed in the accommodating cavity, and the vent is electrically connected to the main board through the flexible circuit board.

In one of the embodiments, the vent is provided with an air outlet hole, the flexible circuit board is provided with a through hole, and the through hole is in communication with the air outlet hole and the ventilation channel.

In one of the embodiments, the housing is provided with an accommodating recess, at least a part of the vent is disposed in the accommodating recess, and a wall of the accommodating recess is provided with a communication hole; and at least a part of the flexible circuit board is disposed between the wall of the accommodating recess and the vent, and the air outlet hole is in communication with the ventilation channel via the through hole and the communication hole.

In one of the embodiments, the in-ear wearable device further includes a protective member, and the protective member is disposed on the vent, and is configured to prevent impurities from entering the vent from the rear cavity.

In one of the embodiments, the in-ear wearable device further includes a main board, the vent is electrically connected to the main board, and an extension direction of the vent intersects with an extension direction of the main board.

In one of the embodiments, the first speaker is a moving coil unit.

In one of the embodiments, the in-ear wearable device further includes a wearing state detector, and the wearing state detector is used for detecting whether the user is wearing the in-ear wearable device; the housing further includes a fifth mounting portion, and when the user is wearing the in-ear wearable device, the fifth mounting portion is disposed corresponding to a crus of helix of the user; the vent is disposed on the second mounting portion, and the wearing state detector is disposed on one of the third mounting portion, the fourth mounting portion and the fifth mounting portion; or, the vent is disposed on the third mounting portion, and the wearing state detector is disposed on one of the second mounting portion, the fourth mounting portion and the fifth mounting portion; or, the vent is disposed on the fourth mounting portion, and the wearing state detector is disposed on one of the second mounting portion, the third mounting portion and the fifth mounting portion.

In one of the embodiments, the in-ear wearable device further includes a charging assembly, and the charging assembly is disposed in the accommodating cavity; and the vent is disposed on one of the second mounting portion and the third mounting portion, and the charging assembly is disposed on the fourth mounting portion.

In one of the embodiments, the in-ear wearable device further includes a wearing state detector, and the wearing state detector is used for detecting whether the user is wearing the in-ear wearable device; the housing further includes a fifth mounting portion, and when the user is wearing the in-ear wearable device, the fifth mounting portion is disposed corresponding to a crus of helix of the user; and the vent is disposed on the third mounting portion, the charging assembly is disposed on the fourth mounting portion, and the wearing state detector is disposed on the fifth mounting portion.

In one of the embodiments, the in-ear wearable device further includes a wearing state detector, a charging assembly, a main board and a flexible circuit board, the wearing state detector, the charging assembly, the main board and the flexible circuit board are all disposed in the accommodating cavity, and the vent, the wearing state detector and the charging assembly are electrically connected to the main board through the flexible circuit board.

In one of the embodiments, the flexible circuit board is provided with a bendable portion.

In one of the embodiments, when the flexible circuit board is unfolded, the vent, the wearing state detector and the charging assembly are disposed on the same side of the flexible circuit board.

According to the in-ear wearable device, when the user uses the in-ear wearable device, the first speaker is disposed at an ear canal opening of the user or is close to the ear canal opening of the user, and the vent is disposed on one of the intertragic notch, the cymba conchae and the cavum conchae of the user. Thus, by reasonably arranging the first speaker and the vent, the accommodating cavity having a confined space can accommodate both the first speaker and the vent, thereby solving the problem of the occlusion effect, improving the comfort of the user when wearing the in-ear wearable device, and also improving sound quality.

Another aspect of the disclosure provides an in-ear wearable device. The in-ear wearable device includes a housing and a vent. The housing is provided with an output hole and an air outlet hole, and is internally provided with a first channel and a second channel, wherein the first channel is in communication with the output hole, the second channel is in communication with the air outlet hole, at least part of the housing is configured to be inserted into an ear canal, the output hole is configured to communicate with the ear canal, and the air outlet hole is configured to communicate with an external environment. The vent is disposed inside the housing and is connected to the first channel and the second channel, and the vent is switchable between an open state and a closed state; wherein when the vent is in the open state, the first channel is in communication with the second channel, so that the ear canal is in communication with the external environment; and when the vent is in the closed state, the first channel is isolated from the second channel, so that the ear canal is isolated from the external environment.

When the in-ear wearable device is worn, in cases where the vent is in the closed state, the first channel is isolated from the second channel, so that the effect of isolating noise in the external environment can be achieved; and when the vent is switched to the open state, the air outlet hole may communicate with the interior of the ear canal through the second channel, the vent, the first channel and the output hole in sequence. The vent is in communication with the external environment through the second channel, so that the ventilation efficiency is high, and the “occlusion effect” during wearing can be weakened or eliminated, thereby improving the comfort of wearing the in-ear wearable device for a long time.

In some embodiments of the present application, the air outlet hole is disposed in an outer wall of the housing along a first direction, and the second channel extends along the first direction.

The extension direction of the second channel is the same as the extension direction of the air outlet hole, so that the smoothness of air flowing in the second channel and the air outlet hole can be improved, thereby increasing the ventilation efficiency between the vent and the external environment, so as to achieve the effect of weakening or eliminating the “occlusion effect”.

In some embodiments of the present application, the second channel includes a first extension portion extending along a second direction and a second extension portion extending along a third direction, the second direction intersecting with the third direction. The first extension portion is in communication with the second extension portion, the first extension portion is in communication with the air outlet hole, and the second extension portion is connected to the vent.

Since the second direction intersects with the third direction, the first extension portion is inclined relative to the second extension portion. When foreign matter enters the first extension portion, a bottom wall of the first extension portion or an inner wall of the second extension portion may block the foreign matter, thereby reducing the risk of the vent being damaged by contact between the foreign matter and the vent.

In some embodiments of the present application, the second direction is perpendicular to the third direction.

By making the second direction perpendicular to the third direction, the risk of contact between the foreign matter entering the first channel and the vent can be further reduced.

In some embodiments of the present application, the in-ear wearable device includes a sound-generating unit, wherein the sound-generating unit is disposed in the housing, sound emitted from the sound-generating unit is transmitted to the ear canal via the output hole, the sound-generating unit divides the housing into a front cavity and a rear cavity, and the first channel is in communication with the output hole through the front cavity.

The first channel and the sound-generating unit share the output hole, which can simplify the structural design.

In some embodiments of the present application, the in-ear wearable device further includes a damper that includes a mounting portion and a damping portion connected to the mounting portion, the damping portion being provided with several vent holes; wherein the mounting portion is at least partially inserted into the air outlet hole, and the vent holes are in communication with both the air outlet hole and the second channel.

By inserting at least part of the mounting portion into the air outlet hole, the damper mounted in the housing to adjust the ventilation volume of the second channel; and the size or number of the vent holes corresponds to different damping coefficients, and different damping coefficients correspond to different ventilation volumes. A user may mount or replace dampers of different damping coefficients as needed to adjust the ventilation volume of the second channel, so as to adapt to different application scenarios.

In some embodiments of the present application, the vent includes a first end and a second end, the first end being disposed toward the first channel, and the second end being disposed toward the second channel; wherein one of the first end and the second end is provided with a control valve, and the other of the first end and the second end is provided with a ventilation hole. The control valve has an open state and a closed state; when the control valve is in the open state, the first channel is in communication with the second channel, so that the ear canal is in communication with the external environment; and when the control valve is in the closed state, the first channel is isolated from the second channel, so that the ear canal is isolated from the external environment.

By controlling the state of the control valve, the state of the vent can be switched, thereby achieving a simple structure and facilitating control.

In some embodiments of the present application, the vent includes a first end and a second end; the housing is internally provided with a fixing groove, an inner wall of the fixing groove including a first wall and a second wall, the first channel extending through the first wall, and the second channel extending through the second wall; wherein the vent is disposed in the fixing groove, the first end faces the first wall, and the second end faces the second wall.

The vent is disposed in the fixing groove, and the fixing groove has a constraint effect on the vent, so that the stability of fixing the vent can be improved.

In some embodiments of the present application, a first sealing member is disposed between the first end and the first wall, and a second sealing member is disposed between the second end and the second wall.

The first sealing member is configured to seal a gap between the first end and the first wall, and the second sealing member is configured to seal a gap between the second end and the second wall, so that the air tightness of connection between the first channel and the first end and connection between the second channel and the second end can be improved.

In some embodiments of the present application, the first sealing member and/or the second sealing member is elastic and elastically abuts against the vent.

Since the first sealing member or the second sealing member having elasticity elastically abuts against the vent, the vent can be kept fixed relative to the inner wall of the fixing groove, so as to further improve the stability of keeping the vent fixed, and thus the risk of the vent being disengaged from the fixing groove can be reduced.

In some embodiments of the present application, the first sealing member is provided with a first through hole that is in communication with the first channel; the second sealing member is provided with a second through hole that is in communication with the second channel; wherein when the vent is in the open state, the first through hole is in communication with the second through hole; and when the vent is in the closed state, the first through hole is isolated from the second through hole.

By providing the first through hole and the second through hole, the obstruction to an airflow by the first sealing member or the second sealing member can be reduced, so as to avoid affecting the ventilation efficiency between the ear canal and the external environment.

In some embodiments of the present application, a protective mesh is disposed between the first end and the first channel and/or between the second end and the second channel.

The protective mesh may block impurities such as dust from entering the first channel, thereby reducing the risk of the impurities such as dust entering the ear canal and polluting the ear canal; and the protective mesh disposed between the second end and the second wall can block dust, sweat and the like from entering the second end, thereby reducing the risk of the vent being damaged by the impurities such as dust and sweat.

In some embodiments of the present application, the in-ear wearable device includes a main circuit board, a first flexible circuit board and a reinforcement plate, wherein the vent is connected to the main circuit board through the first flexible circuit board, the reinforcement plate is disposed on the side of the first flexible circuit board facing away from the vent, and the reinforcement plate is provided with several vent apertures allowing the airflow to flow through.

The reinforcement plate covers the first flexible circuit board, and thus has a protective effect on the flexible circuit board; and the vent apertures of the reinforcement plate both allow the airflow to flow through, and block foreign matter, thereby reducing the risk of the vent being damaged by the foreign matter.

In some embodiments of the present application, the housing includes an in-ear portion and a main body portion, the main body portion including a cavum conchae fitting portion and a cymba conchae fitting portion connected to the cavum conchae fitting portion, and at least part of the in-ear portion being configured to be inserted into the ear canal, wherein at least part of the cavum conchae fitting portion is configured to be inserted into a cavum conchae, and at least part of the cymba conchae fitting portion is configured to be inserted into a cymba conchae.

By providing the cymba conchae fitting portion and inserting at least part of the cymba conchae fitting portion into the cymba conchae, the position and state of the in-ear portion in the ear canal can be determined, so that the in-ear portion is fully attached to an inner wall of the ear canal, and the cavum conchae fitting portion is fully attached to an inner wall of the cavum conchae, so that the wearing comfort can be improved, and the sealing effect of the in-ear portion for the ear canal can be improved. Moreover, the cymba conchae fitting portion is inserted into the cymba conchae, so that the cymba conchae fitting portion is connected to the cymba conchae, and thus the risk of the in-ear wearable device falling off can be reduced.

In some embodiments of the present application, the vent is disposed inside the cymba conchae fitting portion; and/or, the air outlet hole is disposed in the cymba conchae fitting portion.

By using an internal space of the cymba conchae fitting portion to accommodate the vent, the utilization of an internal space of the housing can be increased, and the possibility of the vent interfering with the mounting of other components in the housing can be reduced.

Another aspect of the disclosure provides an in-ear wearable device the first rear ventilation section and the second rear ventilation section are the same ventilation section, and the first ventilation hole and the second ventilation hole are the same ventilation hole.

In some optional embodiments, the first air outlet hole and the second air outlet hole the same air outlet hole.

In some optional embodiments, the first ventilation hole and the second ventilation hole are different ventilation holes.

In some optional embodiments, the second valve member is replaceable.

In some optional embodiments, in a worn state, the second ventilation hole is located in an intertragic notch.

In some optional embodiments, the second valve member is at least partially disposed in the second ventilation hole.

In some optional embodiments, the second valve member includes a tube body and a protective member, the tube body being disposed at least in the second ventilation hole, the protective member being disposed at one end of the tube body and being in communication with the second channel, wherein the protective member is provided with a plurality of through holes that are spaced apart from each other, the through holes providing communication between the second ventilation hole and the second channel.

In some optional embodiments, the housing, the first channel, the second channel, the first air outlet hole, the second air outlet hole, the first ventilation hole and the second ventilation hole are integrally manufactured using 3D printing technology.

By providing the first channel and the second channel in the housing, and controlling opening or closing of the first channel and the second channel through the corresponding first valve member and second valve member, the ear canal can communicate with the external environment through the first channel alone, and can also communicate with the external environment through the second channel alone. When a user requires a large ventilation volume, the first valve member and the second valve member permit the ear canal to communicate with the external environment through both the first channel and the second channel, thereby reducing or eliminating the occlusion effect and improving the ventilation performance within the confined space of the housing. When the user requires sound insulation or high-quality audio listening, the first valve member and the second valve member restrict communication between the ear canal and the external environment through both the first channel and the second channel, thereby reducing ambient sound interference or audio leakage.

### BRIEF DESCRIPTION OF THE DRAWINGS

FIG. 1 shows a perspective view of an in-ear wireless earphone according to some embodiments of the disclosure.

FIG. 2 shows a perspective view of a customized housing of an in-ear wireless earphone according to some embodiments of the disclosure.

FIG. 3 shows a cross-sectional view of an in-ear wireless earphone according to some embodiments of the disclosure.

FIG. 4A shows a perspective view of an in-ear wireless earphone according to some embodiments of the disclosure.

FIG. 4B shows a cross-sectional view of an in-ear wireless earphone according to some embodiments of the disclosure.

FIG. 4C shows a schematic view of a ventilation rate adjusting device of an in-ear wireless earphone according to some embodiments of the disclosure.

FIG. 4D shows a cross-sectional view of a ventilation rate adjusting device in an open state according to some embodiments of the disclosure.

FIG. 4E shows a cross-sectional view of a ventilation rate adjusting device in a closed state according to some embodiments of the disclosure.

FIG. 5A shows a cross-sectional view of an in-ear wireless earphone according to some embodiments of the disclosure.

FIG. 5B shows an exploded view of a ventilation rate adjusting device of an in-ear wireless earphone according to some embodiments of the disclosure.

FIG. 5C shows a cross-sectional view of a ventilation rate adjusting device in an open state according to some embodiments of the disclosure.

FIG. 5D shows a cross-sectional view of a ventilation rate adjusting device in a closed state according to some embodiments of the disclosure.

FIG. 6A shows a cross-sectional view of an in-ear wireless earphone according to some embodiments of the disclosure.

FIG. 6B shows an exploded view of a ventilation rate adjusting device of an in-ear wireless earphone according to some embodiments of the disclosure.

FIG. 6C shows a cross-sectional view of a ventilation rate adjusting device in an open state according to some embodiments of the disclosure.

FIG. 6D shows a cross-sectional view of a ventilation rate adjusting device in a closed state according to some embodiments of the disclosure.

FIG. 7A shows a cross-sectional view of an in-ear wireless earphone according to some embodiments of the disclosure.

FIG. 7B shows an exploded view of a ventilation rate adjusting device of an in-ear wireless earphone according to some embodiments of the disclosure.

FIG. 7C shows a schematic view of a ventilation rate adjusting device in an open state according to some embodiments of the disclosure.

FIG. 7D shows a schematic view of a ventilation rate adjusting device in a closed state according to some embodiments of the disclosure.

FIG. 8 shows a perspective view of an in-ear wireless earphone according to some embodiments of the disclosure.

FIG. 9A shows a perspective view of an in-ear wireless earphone according to some embodiments of the disclosure.

FIG. 9B shows a cross-sectional view of an in-ear wireless earphone according to some embodiments of the disclosure.

FIG. 9C shows an exploded view of a ventilation rate adjusting device of an in-ear wireless earphone according to some embodiments of the disclosure.

FIG. 9D shows a schematic view of a ventilation rate adjusting device according to some embodiments of the disclosure.

FIG. 9E shows a partial cross-sectional view of a ventilation rate adjusting device in an open state according to some embodiments of the disclosure.

FIG. 9F shows a partial cross-sectional view of a ventilation rate adjusting device in a closed state according to some embodiments of the disclosure.

FIG. 10A shows a cross-sectional view of an in-ear wireless earphone according to some embodiments of the disclosure.

FIG. 10B shows an exploded view of a ventilation rate adjusting device of an in-ear wireless earphone according to some embodiments of the disclosure.

FIG. 10C shows a schematic view of a ventilation rate adjusting device in an open state according to some embodiments of the disclosure.

FIG. 10D shows a schematic view of a ventilation rate adjusting device in a closed state according to some embodiments of the disclosure.

FIG. 11A shows a perspective view of an in-ear wireless earphone according to some embodiments of the disclosure.

FIG. 11B shows a cross-sectional view of an in-ear wireless earphone according to some embodiments of the disclosure.

FIG. 11C shows an exploded view of a ventilation rate adjusting device of an in-ear wireless earphone according to some embodiments of the disclosure.

FIG. 11D shows a schematic view of a ventilation rate adjusting device in an open state according to some embodiments of the disclosure.

FIG. 11E shows a partial cross-sectional view of a ventilation rate adjusting device in an open state according to some embodiments of the disclosure.

FIG. 11F shows a schematic view of a ventilation rate adjusting device in a closed state according to some embodiments of the disclosure.

FIG. 11G shows a partial cross-sectional view of a ventilation rate adjusting device in a closed state according to some embodiments of the disclosure.

FIG. 11H shows a partial cross-sectional view of a ventilation rate adjusting device in a partially open state according to some embodiments of the disclosure.

FIG. 12A shows an exploded view of a ventilation rate adjusting device of an in-ear wireless earphone according to some embodiments of the disclosure.

FIG. 12B shows a schematic view of a ventilation rate adjusting device in an open state according to some embodiments of the disclosure.

FIG. 12C shows a schematic view of a ventilation rate adjusting device in a closed state according to some embodiments of the disclosure.

FIG. 13A shows a cross-sectional view of an in-ear wireless earphone according to some embodiments of the disclosure.

FIG. 13B shows an exploded view of a ventilation rate adjusting device of an in-ear wireless earphone according to some embodiments of the disclosure.

FIG. 13C shows a schematic view of a ventilation rate adjusting device in an open state according to some embodiments of the disclosure.

FIG. 13D shows a schematic view of a ventilation rate adjusting device in a closed state according to some embodiments of the disclosure.

FIG. 14A shows a cross-sectional view of an in-ear wireless earphone according to some embodiments of the disclosure.

FIG. 14B shows an exploded view of a ventilation rate adjusting device of an in-ear wireless earphone according to some embodiments of the disclosure.

FIG. 14C shows a schematic view of a ventilation rate adjusting device in an open state according to some embodiments of the disclosure.

FIG. 14D shows a schematic view of a ventilation rate adjusting device in a closed state according to some embodiments of the disclosure.

FIG. 15 is a schematic structural diagram of an in-ear wearable device according to o embodiment of the present application.

FIG. 16 is a schematic structural diagram of the in-ear wearable device shown in FIG. 15 at another angle of view.

FIG. 17 is a sectional view along A-A in FIG. 16.

FIG. 18 is a schematic diagram of an internal structure of an in-ear wearable device according to one embodiment of the present application.

FIG. 19 is a schematic structural diagram of the in-ear wearable device shown in FIG. 18 at another angle of view.

FIG. 20 is a schematic structural diagram of the in-ear wearable device shown in FIG. 19 at another angle of view.

FIG. 21 is a sectional view along B-B in FIG. 20.

FIG. 22 is a schematic structural view of a wearing state detector shown in FIG. 15 after being assembled in a housing.

FIG. 23 is a sectional view along C-C in FIG. 22.

FIG. 24 is a schematic structural diagram of a vent, a wearing state detector, a charging assembly, a flexible circuit board and a speaker shown in FIG. 15.

FIG. 25 is a schematic structural diagram of an in-ear wearable device according to another embodiment of the present application.

FIG. 26 is a schematic diagram of an internal structure of the in-ear wearable device shown in FIG. 25.

FIG. 27 is a schematic structural diagram of the in-ear wearable device shown in FIG. at another angle of view.

FIG. 28 is a sectional view along D-D in FIG. 27.

FIG. 29 is a schematic structural view of the housing shown in FIG. 26.

FIG. 30 is a sectional view along E-E in FIG. 29.

FIG. 31 is a schematic structural diagram of connecting the vent, the wearing state detector and the charging assembly shown in FIG. 25 through the flexible circuit board.

FIG. 32 is a schematic diagram of the vent being completely opened according to on embodiment of the present application.

FIG. 33 is a schematic diagram of the vent being partially opened according to one embodiment of the present application.

FIG. 34 is a schematic diagram of the vent being completely closed according to one embodiment of the present application.

FIG. 35 is a schematic structural diagram of the ear tissue of the human body.

FIG. 36 is a schematic structural diagram of an in-ear wearable device provided in an embodiment of the present application.

FIG. 37 is a schematic partial exploded view of the in-ear wearable device in FIG.

FIG. 38 is a schematic diagram of the partial structure in FIG. 37 from which a sound-generating unit has been removed.

FIG. 39 is a schematic partial sectional view of the partial structure in FIG. 38.

FIG. 40 is a schematic partial exploded view of the structure in FIG. 39.

FIG. 41 is a schematic sectional view of a damper in FIG. 40.

FIG. 42 is a schematic partial sectional view of another in-ear wearable device provided in an embodiment of the present application.

FIG. 43 is a perspective view of an in-ear wearable device in one embodiment of the present application.

FIG. 44 is a cross-sectional perspective view of an in-ear wearable device in one embodiment of the present application.

FIG. 45 is a cross-sectional perspective view of an in-ear wearable device in one embodiment of the present application at another angle of view.

FIG. 46 is a cross-sectional perspective view of an in-ear wearable device in another embodiment of the present application.

FIG. 47 is a perspective view of a second valve member in one embodiment of the present application.

FIG. 48 is a perspective view of line distribution inside an in-ear wearable device in one embodiment of the present application.

FIG. 49 is a perspective view of a flat cable provided with an electronic vent valve one embodiment of the present application.

### DETAILED DESCRIPTION OF THE EMBODIMENTS

Hereinafter, the embodiments of the disclosure are described with reference to the drawings. The following detailed description and drawings are used to illustrate the principles of the disclosure. The disclosure is not limited to the described preferred embodiments, and its scope is defined by the claims. The disclosure will now be described in detail with reference to the exemplary embodiments, some of which are illustrated in the drawings. The following description is made with reference to the drawings, wherein like reference numerals in different drawings represent the same or similar elements unless otherwise indicated. The solutions described in the following exemplary embodiments do not represent all the solutions of the disclosure. Rather, these solutions are merely examples of systems and methods of various aspects of the disclosure involved in the appended claims.

The disclosure provides an in-ear wearable device, which can provide a user with various functions, such as audio reproduction, sound reception, health monitoring, etc., by being inserted into the user's ear, especially an acoustic meatus of the user. The structure and the principle of the in-ear wearable device will be described in detail below by taking an in-ear wireless earphone as an example. But it shall be appreciated that the in-ear wearable device according to the disclosure is not limited to the in-ear wireless earphone. For example, in addition to the audio reproduction function, the in-ear wearable device may be additionally or alternatively implemented as having functions such as sound reception, temperature detection, blood pressure detection, heart rate detection, blood glucose detection, blood oxygen detection, etc. Furthermore, in some embodiments, the in-ear wearable device may not be implemented as an in-ear wireless earphone, that is, it only has other functions rather than the audio reproduction function.

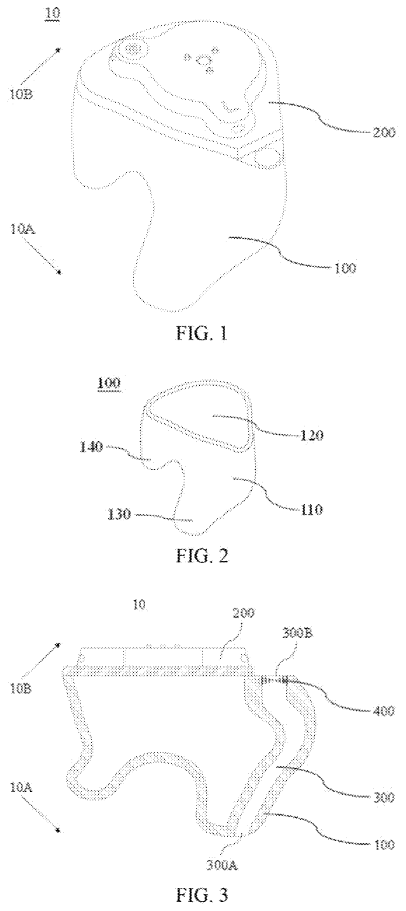

FIG. 1 shows a perspective view of an in-ear wireless earphone 10 according to some embodiments of the disclosure. Only one earphone (for example, a left earphone) is shown in FIG. 1, but those skilled in the art shall appreciate that a pair of earphones is usually composed of a left earphone and a right earphone with substantially symmetrical structures. Thus, for simplicity, only one earphone is shown in the drawing, and the following description is given only for one earphone. The in-ear wireless earphone 10 includes a first side 10A and a second side 10B. The first side 10A of the in-ear wireless earphone 10 represents a side in the acoustic meatus of the user when the user wears the in-ear wireless earphone 10, and the second side 10B of the in-ear wireless earphone 10 represents a side exposed to an external environment when the user wears the in-ear wireless earphone 10. As shown in FIG. 1, the first side 10A of the in-ear wireless earphone 10 is located at its lower portion, and the second side 10B is located at its upper portion.

Referring to FIG. 1, the in-ear wireless earphone 10 according to some embodiments of the disclosure includes a customized housing 100 and a panel 200. FIG. 2 shows a perspective view of a customized housing of an in-ear wireless earphone according to some embodiments of the disclosure. Herein, the term ‘customized’ means that the housings are designed and manufactured individually, rather than uniformly, for different users' ears. The customized housing 100 for example may be manufactured using a manufacturing device based on an ear mold taken from a user's ear. The customized housing 100 may be manufactured by 3D printing or any other manufacturing method. The size of the customized housing 100 may be the same as that of the taken ear mold, or slightly smaller than that of the taken ear mold to improve the wearing comfort for some sensitive users.

In a case where the user wears a standard earphone, the size of the standard earphone is fixed and shall be as small as possible to adapt to the sizes of most users'ears (e.g., auricular concha cavities). But in order to ensure the stable wearing without falling off, it is necessary to provide some protrusions so that the earphone can be firmly stuck on the ear. In this case, when the standard earphone is worn, some parts of the acoustic meatuses or auricles of most users will be compressed, thereby resulting in discomfort caused by long-term wearing. For example, many users will feel uncomfortable with their ears after wearing the standard earphone for 30 minutes or even less. However, in the disclosure, since the customized housing 100 of the in-ear wireless earphone 10 is customized for the user and substantially does not compress the user's ear, the in-ear wireless earphone 10 of the disclosure improves the wearing comfort compared with the standard earphone, so that the user can wear the earphone for a longer time such as several hours or more. Further, since the user can wear the earphone for a longer time, it is more possible for the user to apply the earphone in various scenarios. For example, in addition to the conventional audio and video services, the earphone can also be used to make voice or video calls, play games, and carry out various virtual reality activities.

In an exemplary embodiment, the customized housing 100 has an integral structure or is integrally formed, i.e., formed at one time based on the ear mold of the user. In other embodiments, the customized housing 100 may also be composed of a plurality of parts. For example, the customized housing 100 may include an inner core portion that is the same for all or most users and may be assembled with the panel 200, and a customized adaption portion formed based on the ear mold of the user. In a case where the customized housing 100 includes the inner core portion and the customized adaption portion, the production efficiency can be improved since components other than the customized adaption portion are the same for most users.

According to some embodiments of the disclosure, the customized housing 100 includes a first portion for being inserted into an acoustic meatus of a user and matching with the shape of the acoustic meatus, and a second portion for being exposed to the external environment when the first portion is inserted into the acoustic meatus. By ‘customization’, when the user wears the in-ear wireless earphone 10, the customized housing 100 at least partially fits the acoustic meatus of the user. Thus, the first portion of the customized housing 100 serves as a portion that fits the acoustic meatus of the user, i.e., a portion isolated from the external environment, so as to provide a sealed listening environment in the acoustic meatus when the user wears the in-ear wireless earphone 10. In addition, the second portion of the customized housing 100 serves as a portion exposed to the external environment when the user wears the in-ear wireless earphone 10. In some embodiments, the second portion of the customized housing 100 includes an open end located on a side of the second portion away from the first portion. In some embodiments, the panel 200 is mounted to the customized housing 100 at the open end of the second portion of the customized housing 100. For example, other components of the in-ear wireless earphone 10 may be arranged in the customized housing 100 through the open end, and then the panel 200 may be mounted to the open end.

According to some embodiments of the disclosure, the customized housing 100 includes a housing wall 110 and an inner cavity 120 surrounded by the housing wall 110. In some embodiments, the in-ear wireless earphone 10 may further include components such as a mainboard, a manipulation device, a charging device, a battery, an antenna device, a magnet, a sound pickup device, a speaker assembly and a wireless communication module. The components may be assembled together by means of bolts, welding, gluing, clamping, or the like. These components may be disposed in a space enclosed by the customized housing 100 and the panel 200. Specifically, these components may be mainly located in the inner cavity 120 of the customized housing 100, and the panel 200 may be used to enclose the inner cavity 120. The panel 200 may be a flat cover plate or any rugged or uneven cover plate as long as other components can work normally. In an exemplary embodiment, the panel 200 is mounted to the customized housing 100 on the second side 10B of the in-ear wireless earphone 10.

In some embodiments, as shown in FIG. 2, the customized housing 100 may include a first protruding portion 130 and a second protruding portion 140. When the user wears the in-ear wireless earphone 10, the first protruding portion 130 may be located in an auricular concha cavity of the user or both the auricular concha cavity and the external acoustic meatus of the user, and the second protruding portion 140 may be located in a cymba conchae of the user. The first protruding portion 130 may include an opening, and the speaker assembly is located in the first protruding portion 130 close to the opening. Thus, the sound output by a sound output device of the speaker assembly enters the acoustic meatus of the user through the opening.

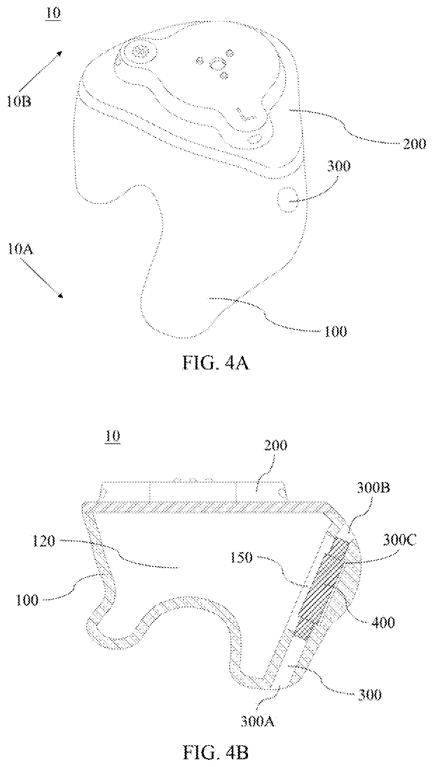

FIG. 3 shows a cross-sectional view of an in-ear wireless earphone according to some embodiments of the disclosure. According to some embodiments of the disclosure, the in-ear wireless earphone includes a ventilation hole 300 and a ventilation rate adjusting device 400. The ventilation hole 300 is at least partially disposed in the customized housing 100, i.e., at least partially formed by the customized housing 100. In some embodiments, a section of the ventilation hole 300 disposed in the customized housing 100 is formed in the housing wall 110. For example, the section of the ventilation hole 300 disposed in the customized housing 100 may be formed along with the manufacturing of the customized housing 100, or may be additionally formed in the housing wall 110 after the customized housing 100 is manufactured. According to some embodiments of the disclosure, as shown in FIG. 3, the ventilation hole 300 is completely disposed in the customized housing 100. In an exemplary embodiment, the ventilation hole 300 is completely disposed in the housing wall 110 of the customized housing 100. The ventilation hole 300 includes a first orifice 300A for being exposed to the acoustic meatus of the user and a second orifice 300B for being exposed to the external environment when the user wears the in-ear wireless earphone 10. Thus, the first orifice 300A is located on the first side 10A of the in-ear wireless earphone 10, and the second orifice 300B is located on the second side 10B of the in-ear wireless earphone 10. In some embodiments, the ventilation hole 300 is a straight-through ventilation hole. In some embodiments, ventilation hole 300 is a bent ventilation hole. Compared with the straight-through ventilation hole, the bent ventilation hole can provide a longer ventilation hole length in a relatively small volume, thereby being more suitable for the in-ear wireless earphone 10 or the customized housing 100 with a small volume.

According to some embodiments of the disclosure, the ventilation rate adjusting device 400 is mounted in the ventilation hole 300. The ventilation hole 300 and the ventilation rate adjusting device 400 constitute at least a part of a ventilation channel which is isolated from the inner cavity 120 of the customized housing 100. The term ‘isolated’ means that when the user wears the in-ear wireless earphone 10 (i.e., when the first portion of the customized housing 100 is inserted into the acoustic meatus of the user), the ventilation channel is not in fluid communication with the inner cavity 120 of the customized housing 100. The ventilation channel is configured to fluidly connect the acoustic meatus of the user to the external environment when the user wears the in-ear wireless earphone 10. Thus, the ventilation channel is configured to fluidly connect the first side 10A and the second side 10B of the in-ear wireless earphone. By isolating the ventilation channel from the inner cavity 120 of the customized housing 100, the influence of a ventilation airflow on the internal components and the sound quality of the in-ear wireless earphone can be avoided or reduced in a ventilation process of the ventilation channel, and the applicability and stability of the in-ear wireless earphone in different modes can be improved.

In some embodiments, the ventilation rate adjusting device 400 is disposed at the second orifice 300B of the ventilation hole 300, i.e., at an end of the ventilation hole 300 on the second side 10B. In some embodiments, the ventilation rate adjusting device 400 is disposed in the ventilation hole 300 at a position spaced apart from both the first orifice 300A and the second orifice 300B, i.e., at a middle position of the ventilation hole 300.

According to some embodiments of the disclosure, the ventilation channel is at least partially disposed in the customized housing 100. In some embodiments, the ventilation channel is completely disposed in the customized housing 100. In some embodiments, the ventilation channel is a straight-through channel. In some embodiments, the ventilation channel is a bent channel. The bent channel is suitable to be arranged in a smaller housing and in-ear wireless earphone to achieve a ventilation channel of the same length or longer than the pass-through channel.

According to some embodiments of the disclosure, the ventilation rate adjusting device 400 is configured to be electrically operated to adjust a ventilation rate of the ventilation channel. Specifically, the ventilation rate adjusting device 400 may be electrically operated to open and close the ventilation hole 300, thereby opening and closing the ventilation channel. Therefore, the ventilation channel may perform a ventilation when being opened by the ventilation rate adjusting device 400, and may provide a better listening effect when being closed by the ventilation rate adjusting device 400.

When the user wears the in-ear wireless earphone with the customized housing, the acoustic meatus is sealed by the customized housing in a case where the ventilation hole is closed, so that the user can have, such as, a better music listening effect. However, in a case where the ventilation hole is closed, the acoustic meatus is sealed by the customized housing, resulting in different air pressures inside and outside the acoustic meatus due to the ear occlusion effect, which causes uncomfortable long-term wearing or unnatural listening for the user. By opening or closing the ventilation hole 300 through the ventilation rate adjusting device 400, it is possible to switch between different use modes to overcome the ear occlusion effect, improve the wearing comfort for the user, and adapt to different use scenarios.

According to some embodiments of the disclosure, the ventilation rate adjusting device 400 may be electrically operated to be switched between a fully open state for fully opening (100%) the ventilation channel and a fully closed state for fully closing (0%) the ventilation channel. In the fully open state, the ventilation channel is in a maximum open state, so that a maximum ventilation rate can be achieved. In the fully closed state, the ventilation channel is in the fully closed state, so that no ventilation can be achieved.

In some embodiments, in addition to the fully open state and the fully closed state described above, the ventilation rate adjusting device 400 may be electrically operated in one or more partially open states for partially opening the ventilation channel. Thus, the ventilation rate adjusting device 400 may have multiple levels of ventilation rates. For example, the ventilation rate adjusting device 400 may be electrically operated to be in a 25% open state, a 50% open state, a 75% open state, and the like.

In some embodiments, the ventilation rate adjusting device 400 may also be electrically operated to continuously adjust a ventilation rate of the ventilation channel. Therefore, the ventilation rate adjusting device 400 can be in a stepless adjustment.

In some embodiments, the ventilation rate adjusting device 400 is configured to adjust the ventilation rate of the ventilation channel so as to adjust audio characteristics of the in-ear wireless earphone 10. Thus, the ventilation rate adjusting device 400 can adjust the ventilation rate of the ventilation channel, i.e., an opening degree of the ventilation hole. When the ventilation channel of the in-ear wireless earphone 10 is fully closed, the in-ear wireless earphone 10 can have better noise reduction effect and audio listening experience. When the ventilation rate adjusting device 400 is electrically operated to open the ventilation channel of the in-ear wireless earphone 10, the ventilation channel can achieve a ventilation, so that the user can receive the sound of the external environment more clearly, which avoids the sound occlusion effect, and improve the wearing comfort. In addition, when the ventilation rate adjusting device 400 is electrically operated to make the ventilation channel have different ventilation rates, the in-ear wireless earphone 10 will have different audio characteristics, so that the user can conveniently adjust his/her listening experience to meet different requirements.

According to some embodiments of the disclosure, the ventilation rate adjusting device 400 may be controlled in a wired or wireless manner to electrically adjust the ventilation rate of the ventilation channel. In some embodiments, the ventilation rate adjusting device 400 may be communicatively connected to a wired or wireless terminal device such as a computer, a mobile phone, a tablet computer, an audio reproducing device, a video processing device, a game console, a navigation device and the like, and receive a control signal from the wired or wireless terminal device. According to the corresponding control signal, the ventilation rate adjusting device 400 can electrically adjust the ventilation rate of the ventilation channel. For example, the user may send an instruction to adjust the ventilation rate of the ventilation channel through an application software (APP) on a mobile phone, so that the ventilation rate adjusting device 400 can adjust the ventilation rate of the ventilation channel through the electric operation according to the instruction.

In some embodiments, the mounting position of the ventilation rate adjusting device 400 may be set at the first orifice 300A or the second orifice 300B of the ventilation hole 300. In some embodiments, the mounting position of the ventilation rate adjusting device 400 is set at a position in the ventilation hole 300 spaced apart from both the first orifice 300A and the second orifice 300B, i.e., at a middle position of the ventilation hole 300. By mounting the ventilation rate adjusting device 400 at different positions in the ventilation hole, different in-ear wireless earphones 10 can have different audio cavities, so that different audio effects can be defined to meet personalized requirements.

According to some embodiments of the disclosure, the ventilation rate adjusting device 400 is disposed so as not to be exposed from an outer surface of the customized housing 100. Thus, except for the first orifice 300A and the second orifice 300B of the ventilation hole 300, the ventilation rate adjusting device 400 is wrapped by the customized housing 100 and cannot be observed or touched from the outside. By preventing the ventilation rate adjusting device 400 from being exposed from the outer surface of the customized housing 100, the components of the ventilation rate adjusting device 400 will not be in contact with the user's ear during the electric adjustment, which improves the user's experience and the accuracy of the adjustment of the ventilation rate. In addition, by wrapping the ventilation rate adjusting device 400 with the customized housing 100, it is possible to avoid or reduce the invasion of external foreign matters or contaminants into the ventilation rate adjusting device 400, which improves the stabilities of the ventilation rate adjusting device 400 and the in-ear wireless earphone 10.

According to some embodiments of the disclosure, the ventilation rate adjusting device 400 includes a movable portion, a fixed portion and an electric actuator, wherein the electric actuator may drive the movable portion to move relative to the fixed portion to adjust the ventilation rate of the ventilation channel. Hereinafter, a ventilation rate adjusting device according to some embodiments of the disclosure will be described in detail with reference to the drawings.

### Electromagnetic Valve Structure

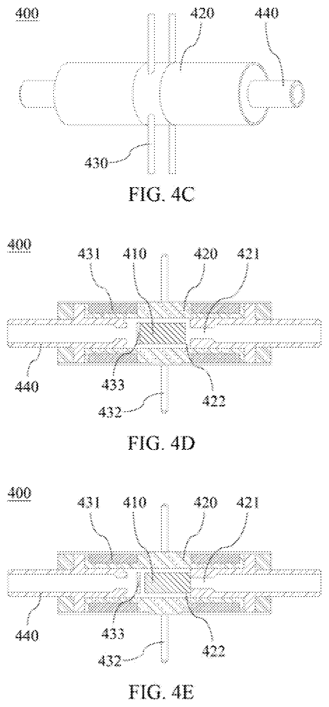

According to some embodiments of the disclosure, the ventilation rate adjusting device may adopt an electromagnetic valve structure. FIG. 4A shows a perspective view of an in-ear wireless earphone according to some embodiments of the disclosure. FIG. 4B shows a cross-sectional view of an in-ear wireless earphone according to some embodiments of the disclosure. FIG. 4C shows a schematic view of a ventilation rate adjusting device of an in-ear wireless earphone according to some embodiments of the disclosure. FIG. 4D shows a cross-sectional view of a ventilation rate adjusting device in an open state according to some embodiments of the disclosure. FIG. 4E shows a cross-sectional view of a ventilation rate adjusting device in a closed state according to some embodiments of the disclosure.

As shown in FIG. 4A, the in-ear wireless earphone 10 includes a customized housing 100, a panel 200 and a ventilation hole 300. As shown in FIG. 4B, the ventilation hole 300 of the in-ear wireless earphone 10 is disposed in the customized housing 100 and includes a mounting position 300C for mounting the ventilation rate adjusting device 400. In an exemplary embodiment, as shown in FIG. 4B, the mounting position 300C is set in the ventilation hole 300 at a position spaced apart from both a first orifice 300A and a second orifice 300B, i.e., at a middle position of the ventilation hole 300. In some embodiments, the mounting position 300C may be set at the first orifice 300A or the second orifice 300B of the ventilation hole 300. Please refer to the foregoing descriptions for other components and structures of the in-ear wireless earphone 10, which will not be repeated here.

In some embodiments, an extending direction of the ventilation hole 300 at the mounting position 300C is substantially straight. For example, the ventilation hole 300 is a straight-through ventilation hole, or the ventilation hole 300 has a straight-through section at the mounting position 300C although it is a bent ventilation hole as a whole.

According to some embodiments of the disclosure, as shown in FIGS. 4C to 4E, the ventilation rate adjusting device 400 includes a piston 410 (not shown in FIG. 4C) as the movable portion, an outer shell 420 as the fixed portion, and an electromagnetic unit 430 as the electric actuator. The outer shell 420 includes an opening 421 communicated with the ventilation hole 300. The piston 410 is disposed inside the outer shell 420. The piston 410 is movable relative to the outer shell 420 under the action of the electromagnetic unit 430. In some embodiments, as shown in FIGS. 4D and 4E, the outer shell 420 includes an internal chamber 422 in which the piston 410 is movable. In an exemplary embodiment, a moving direction of the piston 410 is substantially parallel to the extending direction of the ventilation hole 300 at the ventilation rate adjusting device 400. Herein ‘the extending direction of the ventilation hole 300 at the ventilation rate adjusting device 400’ means an extending direction of the ventilation hole 300 at the mounting position 300C, i.e., a center line of the ventilation hole 300 at the mounting position 300C.

In some embodiments, as shown in FIGS. 4D and 4E, the electromagnetic unit 430 includes an electromagnetic coil 431, and the piston 410 includes a magnet. The electromagnetic coil 431 generates an electromagnetic field when being energized. In some embodiments, the electromagnetic coil 431 is disposed to radially surround the piston 410 as viewed in the moving direction of the piston 410. The electromagnetic coil 431 may be fixed onto or inside the outer shell 420.

In some embodiments, the electromagnetic unit 430 may further include a power line 432 for supplying driving current to the coil 431. In some embodiments, the power line 432 is electrically connected to a battery (not shown) of the in-ear wireless earphone 10. In some embodiments, as shown in FIG. 4B, the customized housing 110 includes a window 150 facing the inner cavity 120, so that the power line 432 of the electromagnetic unit 430 can be electrically connected to the battery of the in-ear wireless earphone 10 through the window 150.

According to some embodiments of the disclosure, the ventilation rate adjusting device 400 may adjust the ventilation rate of the ventilation channel by using the electromagnetic unit 430 to drive the piston 410 to move relative to the outer shell 420. Specifically, when the electromagnetic coil 431 is energized, an electromagnetic field is generated therein, so that the piston 410 is affected by the electromagnetic field to open or close the opening 421 of the outer shell 420, thereby opening or closing the ventilation channel or adjusting the opening degree thereof. When the electromagnetic coil 431 is de-energized, the electromagnetic coil 431 will no longer generate the electromagnetic field, so that the piston 410 returns to the position for closing or opening the opening 421 of the outer shell 420, thereby closing or opening the ventilation channel. In an exemplary embodiment, the piston 410 of the ventilation rate adjusting device 400 is in a state of closing the opening 421 of the outer shell 420 when the electromagnetic coil 431 is not energized.

According to some embodiments of the disclosure, the outer shell 420 includes two openings 421 communicated with the ventilation hole 300 and respectively located on two sides of the piston 410. In some embodiments, as shown in FIGS. 4D and 4E, the electromagnetic unit 430 further includes a stopper 433. When the piston 410 moves relative to the outer shell 420 under the action of the electromagnetic coil 431 to open one opening 421 of the outer shell 420, the stopper 433 may restrict a moving range of the piston 410 to prevent the piston 410 from moving to a position for closing the other opening 421 of the outer shell 420.

In some embodiments, the ventilation rate adjusting device 400 further includes a connecting tube 440 which is in fluid communication with the opening 421 of the outer shell 420. The ventilation rate adjusting device 400 is connected to the ventilation hole 300 of the in-ear wireless earphone 10 through the connecting tube 440. The connecting tube 440 connects the outer shell 420 of the ventilation rate adjusting device 400 to the ventilation hole 300. In some embodiments, the connecting tube 440 is a flexible connecting tube. Through the connecting tube 440, the ventilation rate adjusting device 400 can more advantageously isolate the ventilation channel of the in-ear wireless earphone 10 from the inner cavity 120. However, in the disclosure, the manner for isolating the ventilation channel from the inner cavity is not limited thereto.

In some embodiments, the outer shell 420 is independent from the customized housing 100. However, the disclosure is not limited thereto. In some embodiments, the outer shell 420 may be formed by the customized housing 100, i.e., the outer shell 420 may be integrally formed with the customized housing 100.

The ventilation rate adjusting device 400 with an electromagnetic valve structure is described above with reference to FIGS. 4A to 4E. However, the disclosure is not limited thereto. Hereinafter, other ventilation rate adjusting devices 400 with an electromagnetic valve structure will be described with reference to the drawings.

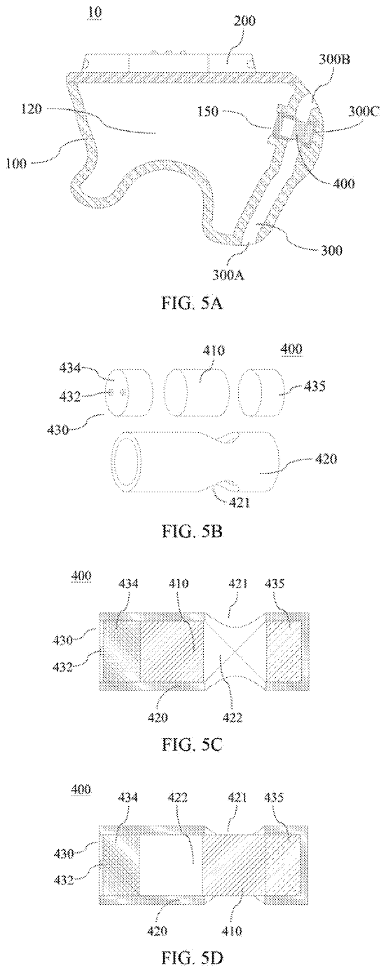

FIG. 5A shows a cross-sectional view of an in-ear wireless earphone according to some embodiments of the disclosure. FIG. 5B shows an exploded view of a ventilation rate adjusting device of an in-ear wireless earphone according to some embodiments of the disclosure. FIG. 5C shows a cross-sectional view of a ventilation rate adjusting device in an open state according to some embodiments of the disclosure. FIG. 5D shows a cross-sectional view of a ventilation rate adjusting device in a closed state according to some embodiments of the disclosure.

As shown in FIG. 5A, the in-ear wireless earphone 10 includes a customized housing 100, a panel 200 and a ventilation hole 300. The ventilation hole 300 of the in-ear wireless earphone 10 is disposed in the customized housing 100 and includes a mounting position 300C for mounting the ventilation rate adjusting device 400. In an exemplary embodiment, as shown in FIG. 5A, the mounting position 300C is set in the ventilation hole 300 at a position spaced apart from both a first orifice 300A and a second orifice 300B, i.e., at a middle position of the ventilation hole 300. In some embodiments, the mounting position 300C may be set at the first orifice 300A or the second orifice 300B of the ventilation hole 300. Please refer to the foregoing descriptions for other components and structures of the in-ear wireless earphone 10, which will not be repeated here.

According to some embodiments of the disclosure, as shown in FIGS. 5B to 5D, the ventilation rate adjusting device 400 includes a piston 410 as the movable portion, a outer shell 420 as the fixed portion, and an electromagnetic unit 430 as the electric actuator. The outer shell 420 includes an opening 421 communicated with the ventilation hole 300. The piston 410 is disposed inside the outer shell 420. The piston 410 is movable relative to the outer shell 420 under the action of the electromagnetic unit 430. In some embodiments, as shown in FIGS. 5C and 5D, the outer shell 420 includes an internal chamber 422 in which the piston 410 is movable. In an exemplary embodiment, a moving direction of the piston 410 is intersected with, e.g., substantially perpendicular to, the extending direction of the ventilation hole 300 at the ventilation rate adjusting device 400.

In some embodiments, the electromagnetic unit 430 includes an electromagnet 434, and the piston 410 includes a magnet. The electromagnet 434 is magnetic when being energized. In some embodiments, the electromagnet 434 is disposed to at least partially overlap the piston 410 as viewed in the moving direction of the piston 410. The electromagnet 434 may be fixed onto or inside the outer shell 420.

In some embodiments, the electromagnetic unit 430 may further include a power line 432 for supplying driving current to the electromagnet 434. In some embodiments, the power line 432 is electrically connected to a battery (not shown) of the in-ear wireless earphone 10. In some embodiments, as shown in FIG. 5A, the customized housing 110 includes a window 150 facing the inner cavity 120, so that the power line 432 of the electromagnetic unit 430 can be electrically connected to the battery of the in-ear wireless earphone 10 through the window 150.

According to some embodiments of the disclosure, the ventilation rate adjusting device 400 may adjust the ventilation rate of the ventilation channel by using the electromagnet 434 to drive the piston 410 to move relative to the outer shell 420. Specifically, when the electromagnet 434 is energized, the electromagnet 434 generates magnetism to attract or repel the piston 410 to open or close the opening 421 of the outer shell 420, thereby opening or closing the ventilation channel or adjusting the opening degree thereof. When the electromagnet 434 is de-energized, the magnetism of the electromagnet 434 disappears, so that the piston 410 returns to the position for closing or opening the opening 421 of the outer shell 420, thereby closing or opening the ventilation channel. In an exemplary embodiment, the piston 410 of the ventilation rate adjusting device 400 is in a state of closing the opening 421 of the outer shell 420 when the electromagnet 434 is not energized.

In some embodiments, as shown in FIGS. 5C and 5D, the electromagnetic unit 430 further includes a magnetic restricting portion 435 which may be a magnet or an electromagnet. For example, when the electromagnet 434 is de-energized, the piston 410 may be attracted or repelled by the magnetic restricting portion 435 to return to the position for closing or opening the opening 421 of the outer shell 420. In some embodiments, the magnetic restricting portion 435 may also restrict the moving range of the piston 410, as described above with reference to the stopper 433.

In the embodiments shown in FIGS. 5A to 5D, please refer to the foregoing descriptions for other structures of the ventilation rate adjusting device 400, which will not be repeated here.

### Butterfly Valve Structure

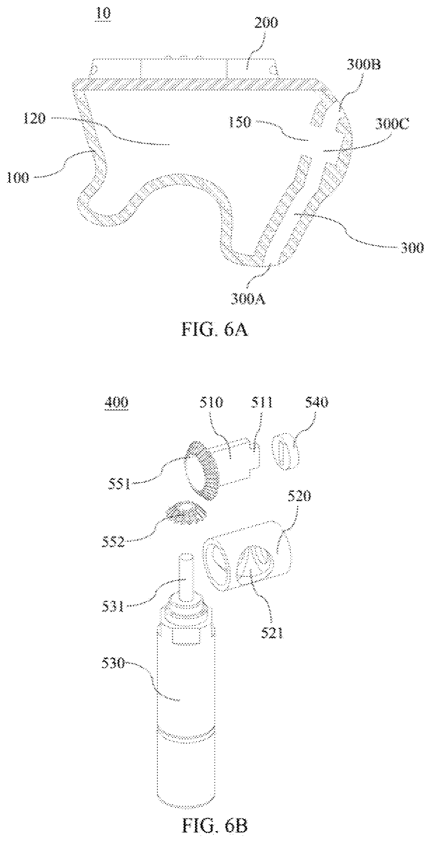

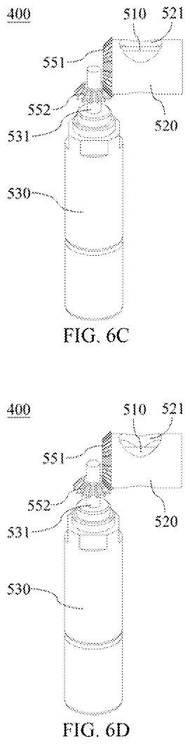

According to some embodiments of the disclosure, the ventilation rate adjusting device may adopt a butterfly valve structure. FIG. 6A shows a cross-sectional view of an in-ear wireless earphone according to some embodiments of the disclosure. FIG. 6B shows an exploded view of a ventilation rate adjusting device of an in-ear wireless earphone according to some embodiments of the disclosure. FIG. 6C shows a cross-sectional view of a ventilation rate adjusting device in an open state according to some embodiments of the disclosure. FIG. 6D shows a cross-sectional view of a ventilation rate adjusting device in a closed state according to some embodiments of the disclosure.

As shown in FIG. 6A, the in-ear wireless earphone 10 includes a customized housing 100, a panel 200 and a ventilation hole 300. The ventilation hole 300 of the in-ear wireless earphone 10 is disposed in the customized housing 100, and includes a mounting position 300C for mounting the ventilation rate adjusting device 400 (not shown in FIG. 6A). In an exemplary embodiment, as shown in FIG. 6A, the mounting position 300C is set in the ventilation hole 300 at a position spaced apart from both a first orifice 300A and a second orifice 300B, i.e., at a middle position of the ventilation hole 300. In some embodiments, the mounting position 300C may be set at the second orifice 300B of the ventilation hole 300. In the embodiments shown in FIGS. 6A to 6D, please refer to the foregoing descriptions for other components and structures of the in-ear wireless earphone 10, which will not be repeated here.

According to some embodiments of the disclosure, as shown in FIGS. 6B to 6D, the ventilation regulating device 400 includes a valve plate 510 as the movable portion, a valve body 520 as the fixed portion, and a motor 530 as the electric actuator. The valve body 520 includes an opening 521 communicated with the ventilation hole 300. The valve plate 510 is disposed inside the valve body 520. The valve plate 510 is rotatable relative to the valve body 520, i.e., rotatable within the valve body 520. In some embodiments, the motor 530 is a stepping motor. In an exemplary embodiment, a rotation axis of the valve plate 510 is intersected with, e.g., substantially perpendicular to, the extending direction of the ventilation hole 300 at the ventilation rate adjusting device 400.

In an exemplary embodiment, the ventilation rate adjusting device 400 further includes a valve plate fixing member 540 disposed outside the valve body 520, and the valve plate 510 includes an extending portion 511 which passes through a wall of the valve body 520 to be fixedly connected to the valve plate fixing member 540. In some embodiments, the extending portion 511 of the valve plate 510 is fixed to the valve plate fixing member 540 by an adhesive or the like.

According to some embodiments of the disclosure, the ventilation rate adjusting device 400 further includes a first engagement portion 551 which is connected with the valve plate 510 in a non-rotatable way and a second engagement portion 552 which is connected with an output shaft 531 of the motor 530 in a non-rotatable way. The first engagement portion 551 and the second engagement portion 552 are connected with each other in a transmission way. In an exemplary embodiment, as shown in FIGS. 6B to 6D, the first engagement portion 551 and the second engagement portion 552 are toothed engagement portions, respectively, wherein the first engagement portion 551 and the second engagement portion 552 are meshed with each other. Herein ‘toothed engagement portions’ mean components for gear transmission, including but not limited to gears, racks, worm wheels, worms, and the like. In an exemplary embodiment, the first engagement portion 551 and the second engagement portion 552 are both straight bevel gears. However, the disclosure is not limited thereto. In other embodiments, the first engagement portion 551 and the second engagement portion 552 may be other types of toothed engagement portions as long as they can be meshed with each other to drive the valve plate 510 to rotate.

In some embodiments, the first engagement portion 551 is integrally formed with the valve plate 510. However, the disclosure is not limited thereto. In some embodiments, the valve plate 510 and the first engagement portion 551 may be formed separately and connected together. For example, the valve plate 510 and the first engagement portion 551 may be connected to each other by an adhesive, threads, or the like.

In some embodiments, as shown in FIG. 6A, the customized housing 110 includes a window 150 facing the inner cavity 120, and a power line (not shown) of the motor 530 may be electrically connected to a battery (not shown) of the in-ear wireless earphone 10 through the window 150. In some embodiments, the motor 530 of the ventilation rate adjusting device 400 may be arranged in the inner cavity 120 of the housing wall 110 through the window 150.

According to some embodiments of the disclosure, the ventilation rate adjusting device 400 may adjust the ventilation rate of the ventilation channel by using the motor 530 to drive the valve plate 510 to rotate. Specifically, when the motor 530 is energized, the output shaft 531 of the motor 530 and the second engagement portion 552 rotate, so as to drive the first engagement portion 551 and the valve plate 510 to rotate relative to the valve body 520, thereby opening or closing the ventilation channel or adjusting the opening degree thereof.

As described above, the valve plate 510 and the valve plate fixing member 540 are connected by an adhesive. However, the disclosure is not limited thereto. Other manners of connecting the valve plate 510 and the valve plate fixing member 540 of the ventilation rate adjusting device will be described below. In some embodiments, the valve plate fixing member 540 includes an internal threaded hole, and the extending portion 511 of the valve plate 510 includes external threads, and the extending portion 511 passes through the wall of the valve body 520 to be threadedly engaged with the internal threaded hole of the valve plate fixing member 540. In some embodiments, the valve plate fixing member of the ventilation rate adjusting device 400 is a bolt pin, the extending portion 511 of the valve plate 510 includes a hole, the extending portion 511 may pass through the wall of the valve body 520, and the valve plate fixing member serving as the bolt pin may be inserted into the hole of the extending portion 511 to fix and restrain the valve plate 510. In some embodiments, the bolt pin may also be fixed into the hole of the extending portion 511 by an adhesive or the like.

In the embodiments shown in FIGS. 6A to 6D, please refer to the foregoing descriptions for other structures of the ventilation rate adjusting device 400, which will not be repeated here.

### Rotary-Cover-With-Opening Structure

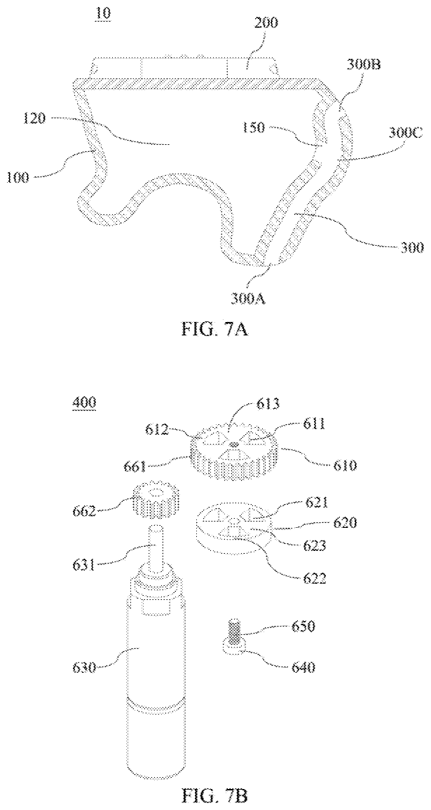

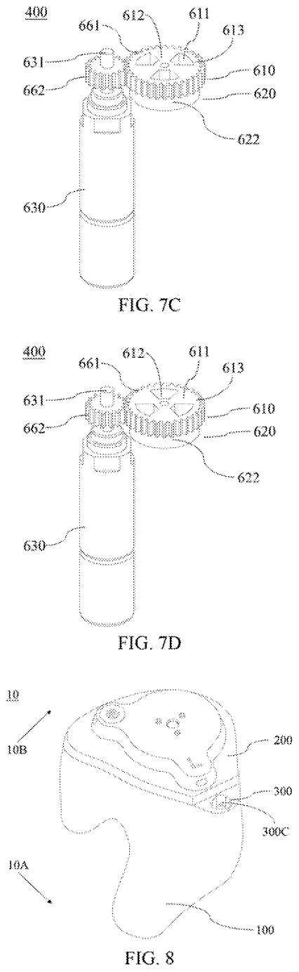

According to some embodiments of the disclosure, the ventilation rate adjusting device may adopt a rotary-cover-with-opening structure. FIG. 7A shows a cross-sectional view of an in-ear wireless earphone according to some embodiments of the disclosure. FIG. 7B shows an exploded view of a ventilation rate adjusting device of an in-ear wireless earphone according to some embodiments of the disclosure. FIG. 7C shows a schematic view of a ventilation rate adjusting device in an open state according to some embodiments of the disclosure. FIG. 7D shows a schematic view of a ventilation rate adjusting device in a closed state according to some embodiments of the disclosure.

As shown in FIG. 7A, the in-ear wireless earphone 10 includes a customized housing 100, a panel 200 and a ventilation hole 300. The ventilation hole 300 of the in-ear wireless earphone 10 is disposed in the customized housing 100, and includes a mounting position 300C for mounting a ventilation rate adjusting device 400 (not shown in FIG. 7A). In an exemplary embodiment, as shown in FIG. 7A, the mounting position 300C is set in the ventilation hole 300 at a position spaced apart from both a first orifice 300A and a second orifice 300B, i.e., at a middle position of the ventilation hole 300. In some embodiments, the mounting position 300C may be set at the second orifice 300B of the ventilation hole 300. In the embodiments shown in FIGS. 7A to 7D, please refer to the foregoing descriptions for other components and structures of the in-ear wireless earphone 10, which will not be repeated here.

According to some embodiments of the disclosure, as shown in FIGS. 7B to 7D, the ventilation rate adjusting device 400 includes a rotary cover 610 as the movable portion, a base 620 as the fixed portion, and a motor 630 as the electric actuator. The rotary cover 610 includes an opening 611, and the base 620 includes an opening 621. The rotary cover 610 is rotatable relative to the base 620. By the rotation of the rotary cover 610 relative to the base 620, the opening 611 of the rotary cover 610 and the opening 621 of the base 620 can be communicated with each other and with the ventilation hole 300, thereby achieving the ventilation of the ventilation channel.

In some embodiments, as shown in FIGS. 7B to 7D, the rotary cover 610 is disposed to at least partially overlap the base 620 along a rotation axis of the rotary cover 610. In some embodiments, the rotary cover 610 is disposed closer to the second orifice 300B of the ventilation hole 300 relative the base 620, i.e., the rotary cover 610 is closer to the external environment when the user wears the in-ear wireless earphone 10. However, the disclosure is not limited thereto. In other embodiments, the rotary cover 610 is disposed farther away from the second orifice 300B of the ventilation hole 300 relative to the base 620, i.e., the rotary cover 610 is closer to the acoustic meatus of the user when the user wears the in-ear wireless earphone 10.

In an exemplary embodiment, the rotation axis of the rotary cover 610 is substantially parallel to an extending direction of the ventilation hole 300 at the ventilation rate adjusting device 400. However, the disclosure is not limited thereto. In some embodiments, the rotation axis of the rotary cover 610 is intersected with, e.g., substantially perpendicular to, the extending direction of the ventilation hole 300 at the ventilation rate adjusting device 400.

In some embodiments, as shown in FIGS. 7B to 7D, the rotary cover 610 includes an annular portion 612 and connecting portions 613 arranged in the annular portion 612. The opening 611 of the rotary cover 610 is formed by being surrounded by the annular portion 612 and the connecting portions 613. In addition, the base 620 includes an annular portion 622 and connecting portions 623 arranged in the annular portion 622. The opening 621 of the base 620 is formed by being surrounded by the annular portion 622 and the connecting portions 623. The rotary cover 610 and the base 620 are disposed in the ventilation hole 300 through the annular portions 612 and 622, respectively. It shall be appreciated that the numbers of the openings and the connecting portions of the rotary cover and the base are not particularly limited in the disclosure.

In some embodiments, as shown in FIG. 7B, the ventilation rate adjusting device 400 further includes a rotary cover fixing member 640 and a pin 650 disposed at an end of the base 620 away from the rotary cover 610. The base 620 includes a through-hole. The pin 650 passes through the base 620 to connect the rotary cover 610 and the rotary cover fixing member 640, so as to fix and restrain the rotary cover 610. In an exemplary embodiment, the pin 650 is fixedly connected to the rotary cover fixing member 640. In some embodiments, the pin 650 includes external threads (as shown in FIG. 7B), the rotary cover 610 includes an internal threaded hole (not shown), and the pin 650 passes through the base 620 to be threadedly engaged with the internal threaded hole of the rotary cover 610, thereby connecting the rotary cover 610 and the rotary cover fixing member 640 to each other.

According to some embodiments of the disclosure, the pin 650 and the rotary cover fixing member 640 are connected with each other in a non-rotatable way. In some embodiments, as shown in FIG. 7B, the pin 650 is integrally formed with the rotary cover fixing member 640. In some embodiments, the pin 650 and the rotary cover fixing member 640 may be formed separately and connected together. For example, the pin 650 and the rotary cover fixing member 640 may be connected to each other by an adhesive, threads, or the like.

According to some embodiments of the disclosure, the ventilation rate adjusting device 400 further includes a first engagement portion 661 which is connected with the rotary cover 610 in a non-rotatable way and a second engagement portion 662 which is connected with an output shaft 631 of the motor 630 in a non-rotatable way. The first engagement portion 661 and the second engagement portion 662 are connected with each other in a transmission way. In an exemplary embodiment, as shown in FIGS. 7B to 7D, the first engagement portion 661 and the second engagement portion 662 are toothed engagement portions, respectively, wherein the first engagement portion 661 and the second engagement portion 662 are meshed with each other. In an exemplary embodiment, the first engagement portion 661 and the second engagement portion 662 are both straight spur gears. However, the disclosure is not limited thereto. In other embodiments, the first engagement portion 661 and the second engagement portion 662 may be other types of toothed engagement portions as long as they can be meshed with each other to drive the rotary cover 610 to rotate.

In some embodiments, the first engagement portion 661 is integrally formed with the rotary cover 610. However, the disclosure is not limited thereto. In some embodiments, the rotary cover 610 and the first engagement portion 661 may be formed separately and connected together. For example, the rotary cover 610 and the first engagement portion 661 may be connected to each other by an adhesive, threads, or the like.

In some embodiments, as shown in FIG. 7A, the customized housing 110 includes a window 150 facing the inner cavity 120, and a power line (not shown) of the motor 630 may be electrically connected to a battery (not shown) of the in-ear wireless earphone 10 through the window 150. In some embodiments, the motor 630 of the ventilation rate adjusting device 400 may be arranged in the inner cavity 120 of the housing wall 110 through the window 150.

According to some embodiments of the disclosure, the ventilation rate adjusting device 400 may adjust the ventilation rate of the ventilation channel by using the motor 630 to drive the rotary cover 610 to rotate relative to the base 620. Specifically, when the motor 630 is energized, the output shaft 631 of the motor 630 and the second engagement portion 662 rotate, so as to drive the first engagement portion 661 and the rotary cover 610 to rotate relative to the base 620, thereby opening or closing the ventilation channel or adjusting the opening degree thereof.

The ventilation rate adjusting device 400 with a rotary-cover-with-opening structure according to some embodiments of the disclosure has been described above with reference to FIGS. 7A to 7D. However, those skilled in the art will appreciate that the rotary-cover-with-opening structure of the disclosure is not limited thereto. Hereinafter, a ventilation rate adjusting device with a rotary-cover-with-opening structure according to some embodiments of the disclosure will be described.

In some embodiments, unlike the embodiments shown in FIGS. 7A to 7D, the base 620 may not have an annular portion. Thus, the opening 621 of the base 620 is formed by being surrounded by the adjacent connecting portions 623 and the inner wall of the ventilation hole 300. FIG. 8 shows a perspective view of an in-ear wireless earphone according to some embodiments of the disclosure. In some embodiments, as shown in FIG. 8, the ventilation hole 300 includes a clamping slot for receiving the connecting portion 623 (not shown in FIG. 8) of the base 620. When the base 620 of the ventilation rate adjusting device 400 is disposed in the ventilation hole 300, the connecting portion 623 of the base 620 is at least partially located in the corresponding clamping slot. Thus, the base 620 can be more stably disposed in the ventilation hole 300, which prevents the base 620 from rotating, and facilitates the rotation of the electrically operated rotary cover 610 relative to the base 620.

As described above, the pin 650 is fixedly connected to (e.g., integrally formed with) the rotary cover fixing member 640, and then connected to the rotary cover 610. However, the disclosure is not limited thereto. In some embodiments, the pin 650 may be fixedly connected to (e.g., integrally formed with) the rotary cover 610 before being connected to the rotary cover fixing member 640. For example, the pin 650 and the rotary cover 610 may be connected to each other by an adhesive, threads, or the like or integrally formed.

### One-Way Valve Structure

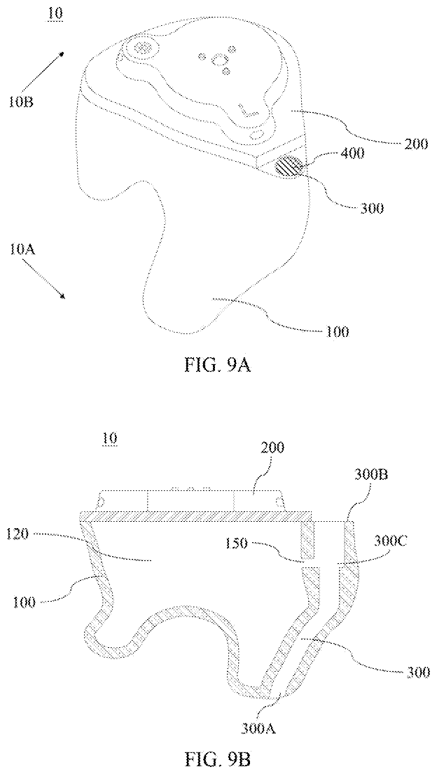

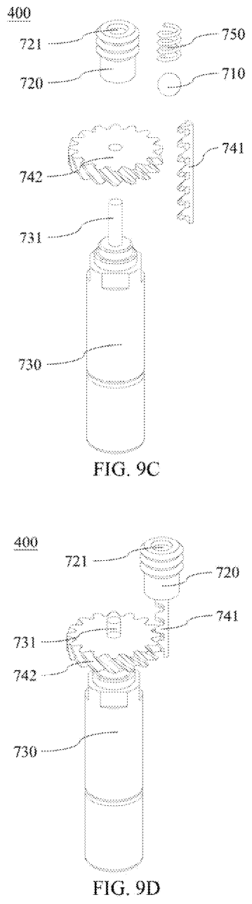

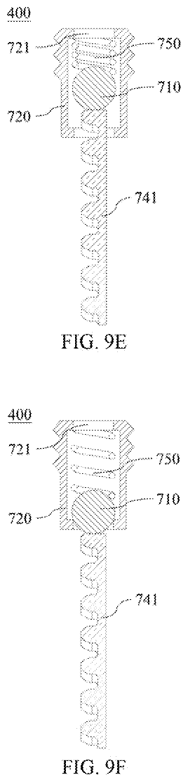

According to some embodiments of the disclosure, the ventilation rate adjusting device may adopt a one-way valve structure. FIG. 9A shows a perspective view of an in-ear wireless earphone according to some embodiments of the disclosure. FIG. 9B shows a cross-sectional view of an in-ear wireless earphone according to some embodiments of the disclosure. FIG. 9C shows an exploded view of a ventilation rate adjusting device of an in-ear wireless earphone according to some embodiments of the disclosure. FIG. 9D shows a schematic view of a ventilation rate adjusting device according to some embodiments of the disclosure. FIG. 9E shows a partial cross-sectional view of a ventilation rate adjusting device in an open state according to some embodiments of the disclosure. FIG. 9F shows a partial cross-sectional view of a ventilation rate adjusting device in a closed state according to some embodiments of the disclosure.

As shown in FIG. 9A, the in-ear wireless earphone 10 includes a customized housing 100, a panel 200 and a ventilation hole 300. As shown in FIG. 9B, the ventilation hole 300 of the in-ear wireless earphone 10 is disposed in the customized housing 100, and includes a mounting position 300C for mounting a ventilation rate adjusting device 400 (not shown in FIG. 9B). In an exemplary embodiment, as shown in FIG. 9B, the mounting position 300C is set at a second orifice 300B of the ventilation hole 300. In some embodiments, the mounting position 300C is set in the ventilation hole 300 at a position spaced apart from both a first orifice 300A and the second orifice 300B, i.e., at a middle position of the ventilation hole 300. In the embodiments shown in FIGS. 9A to 9F, please refer to the foregoing descriptions for other components and structures of the in-ear wireless earphone 10, which will not be repeated here.

According to some embodiments of the disclosure, as shown in FIGS. 9C to 9F, the ventilation rate adjusting device 400 includes a valve core 710 as the movable portion, a valve seat 720 as the fixed portion, and a motor 730 as the electric actuator. The valve seat 720 includes a fluid channel 721 communicated with the ventilation hole. The valve core 710 is movable relative to the valve seat 720 to open and close the fluid channel 721 or adjust the opening degree of the ventilation channel.

According to some embodiments of the disclosure, the ventilation rate adjusting device 400 further includes a first engagement portion 741 engaged with the valve core 710 and a second engagement portion 742 which is connected with an output shaft 731 of the motor 730 in a non-rotatable way. The first engagement portion 741 and the second engagement portion 742 are connected with each other in a transmission way. In some embodiments, as shown in FIGS. 9C and 9D, the first engagement portion 741 and the second engagement portion 742 are toothed engagement portions, respectively, wherein the first engagement portion 741 and the second engagement portion 742 are meshed with each other. In an exemplary embodiment, the first engagement portion 741 is a helical rack and the second engagement portion 742 is a helical spur gear. However, the disclosure is not limited thereto. In other embodiments, the first engagement portion 741 and the second engagement portion 742 may be other types of toothed engagement portions as long as they can be meshed with each other to drive the valve core 710 to move.

In some embodiments, the first engagement portion 741 and the valve core 710 are independent components. However, the disclosure is not limited thereto. In some embodiments, the first engagement portion 741 and the valve core 710 may be fixedly connected to each other. For example, the first engagement portion 741 and the valve core 710 may be connected to each other by an adhesive, threads, or the like. In some embodiments, the first engagement portion 741 and the valve core 710 may be integrally formed.

In some embodiments, as shown in FIGS. 9C, 9E and 9F, the ventilation rate adjusting device 400 further includes a spring 750. The spring 750 is disposed to apply an elastic force to the valve core 710. When the motor 730 applies a pressure to the valve core 710, the pressure can resist the elastic force of the spring 750, so that the valve core 710 approaches or moves away from the valve seat 720, thereby closing or opening the fluid channel 721.

In some embodiments, as shown in FIGS. 9C to 9F, a moving direction of the valve core 710 is substantially parallel to an extending direction of the ventilation hole 300 at the ventilation rate adjusting device 400. However, the disclosure is not limited thereto. In some embodiments, the moving direction of the valve core 710 is intersected with, e.g., substantially perpendicular to, the extending direction of the ventilation hole 300 at the ventilation rate adjusting device 400.

In some embodiments, as shown in FIG. 9B, the customized housing 110 includes a window 150 facing the inner cavity 120, and a power line (not shown) of the motor 730 may be electrically connected to a battery (not shown) of the in-ear wireless earphone 10 through the window 150. In some embodiments, the motor 730 of the ventilation rate adjusting device 400 may be arranged in the inner cavity 120 of the housing wall 110 through the window 150.

According to some embodiments of the disclosure, the ventilation rate adjusting device 400 may adjust the ventilation rate of the ventilation channel by using the motor 730 to drive the valve core 710 to move relative to the valve seat 720. Specifically, when the motor 730 is energized, the output shaft 731 of the motor 730 and the second engagement portion part 742 rotate to drive the first engagement portion part 741 and the valve core 710 to move relative to the valve seat 720, so that the valve core 710 approaches or moves away from the valve seat 720, thereby opening or closing the ventilation channel or adjusting the opening degree thereof.

### Aperture Structure

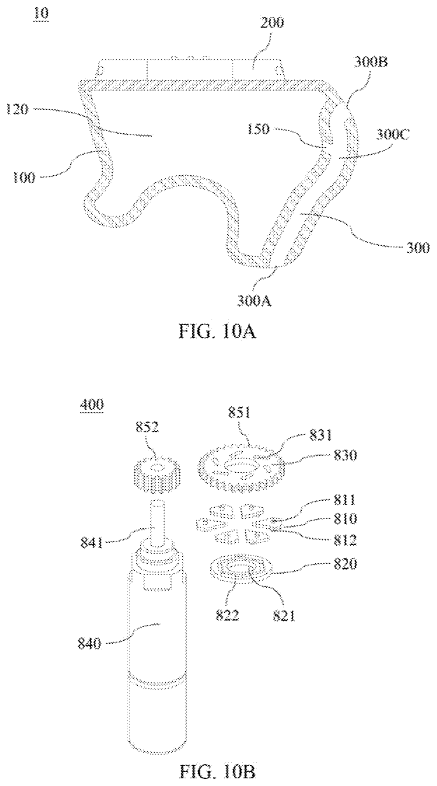

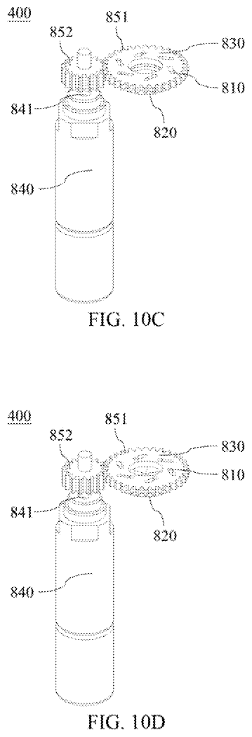

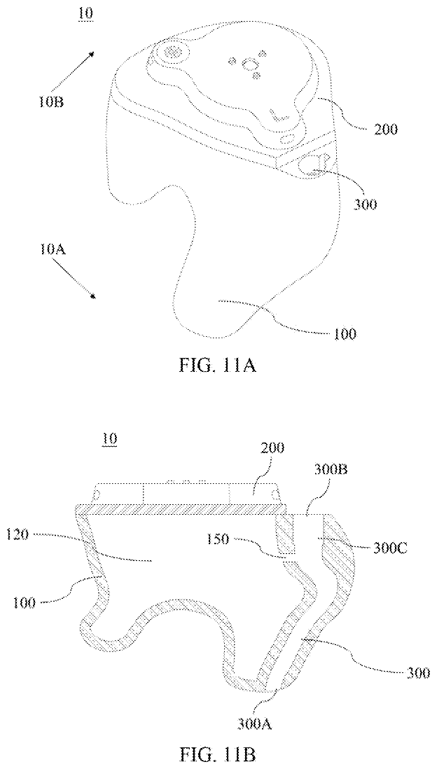

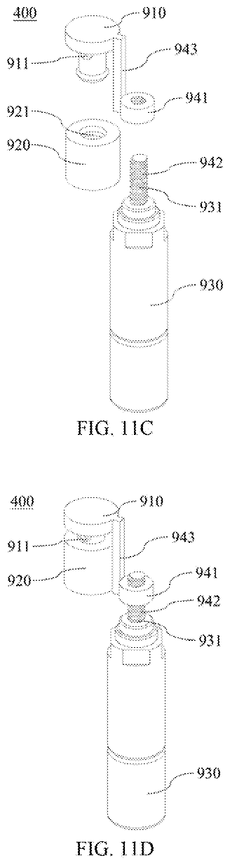

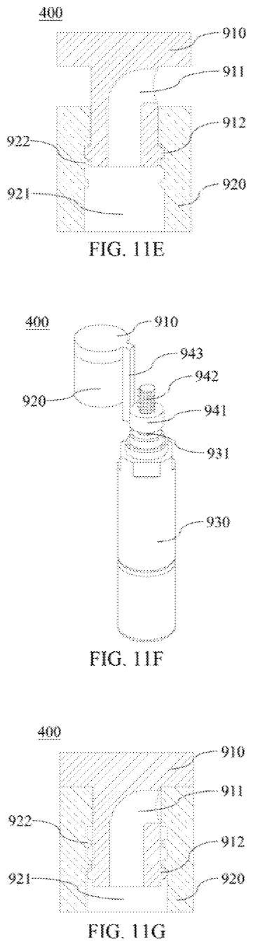

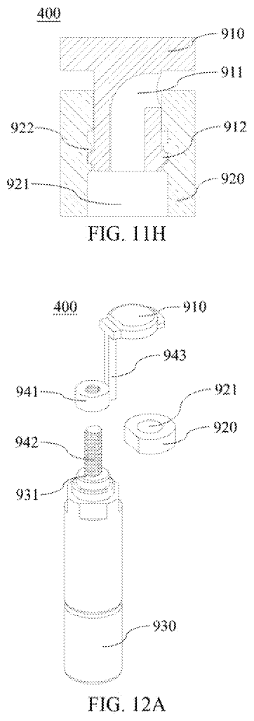

According to some embodiments of the disclosure, the ventilation rate adjusting device may adopt an aperture structure. FIG. 10A shows a cross-sectional view of an in-ear wireless earphone according to some embodiments of the disclosure. FIG. 10B shows an exploded view of a ventilation rate adjusting device of an in-ear wireless earphone according to some embodiments of the disclosure. FIG. 10C shows a schematic view of a ventilation rate adjusting device in an open state according to some embodiments of the disclosure. FIG. 10D shows a schematic view of a ventilation rate adjusting device in a closed state according to some embodiments of the disclosure.

As shown in FIG. 10A, the in-ear wireless earphone 10 includes a customized housing 100, a panel 200 and a ventilation hole 300. The ventilation hole 300 of the in-ear wireless earphone 10 is disposed in the customized housing 100, and includes a mounting position 300C for mounting a ventilation rate adjusting device 400 (not shown in FIG. 10A). In an exemplary embodiment, as shown in FIG. 10A, the mounting position 300C is set in the ventilation hole 300 at a position spaced apart from both a first orifice 300A and a second orifice 300B, i.e., at a middle position of the ventilation hole 300. In some embodiments, the mounting position 300C may be set at the second orifice 300B of the ventilation hole 300. In the embodiments shown in FIGS. 10A to 10D, please refer to the foregoing descriptions for other components and structures of the in-ear wireless earphone 10, which will not be repeated here.

According to some embodiments of the disclosure, as shown in FIGS. 10B to 10D, the ventilation rate adjusting device 400 includes a plurality of blades 810 as the movable portion, a fixed seat 820 as the fixed portion, a rotary ring 830 and a motor 840 as the electric actuator. The fixed seat 820 includes a fluid channel 821 communicated with the ventilation hole 300. The rotary ring 830 is rotatable relative to the fixed seat 820. The motor 840 may drive the rotary ring 830 to rotate, thereby driving the blade 810 to move relative to the fixed seat 820. By the rotation of the rotary ring 830 relative to the fixed seat 820, the blades 810 may be spliced with each other to close, or separated from each other to open, the fluid channel 821 of the fixed seat 820, thereby adjusting the ventilation rate of the ventilation channel.

In an exemplary embodiment, as shown in FIG. 10B, the blade 810 includes a first protrusion 811 protruding from one surface and a second protrusion 812 protruding from the other surface, the rotary ring 830 includes a driving groove 831 for matching with the first protrusion 811, and the fixed seat 820 includes a sliding groove 822 for matching with the second protrusion 812. When the rotary ring 830 rotates relative to the fixed seat 820, the first protrusion 811 of the blade 810 moves in the driving groove 831, and the second protrusion 812 moves in the sliding groove 822.

According to some embodiments of the disclosure, the ventilation rate adjusting device 400 further includes a first engagement portion 851 which is connected with the rotary ring 830 in a non-rotatable way and a second engagement portion 852 which is connected with an output shaft 841 of the motor 840 in a non-rotatable way. The first engagement portion 851 and the second engagement portion 852 are connected with each other in a transmission way. In an exemplary embodiment, as shown in FIGS. 10B to 10D, the first engagement portion 851 and the second engagement portion 852 are toothed engagement portions, respectively. In some embodiments, the first engagement portion 851 and the second engagement portion 852 are both straight spur gears. However, the disclosure is not limited thereto. In other embodiments, the first engagement portion 851 and the second engagement portion 852 may be other types of toothed engagement portions as long as they can be meshed with each other to drive the rotary ring 830 to rotate.

In some embodiments, as shown in FIG. 10B, the first engagement portion 851 is integrally formed with the rotary ring 830. However, the disclosure is not limited thereto. In some embodiments, the first engagement portion 851 and the rotary ring 830 may be formed separately and connected together. For example, the first engagement portion 851 and the rotary ring 830 may be connected to each other by an adhesive, threads, or the like.

In an exemplary embodiment, a rotation axis of the rotary ring 830 is substantially parallel to an extending direction of the ventilation hole 300 at the ventilation rate adjusting device 400. However, the disclosure is not limited thereto. In some embodiments, the rotation axis of the rotary ring 830 is intersected with, e.g., substantially perpendicular to, the extending direction of the ventilation hole 300 at the ventilation rate adjusting device 400.

In some embodiments, as shown in FIG. 10A, the customized housing 110 includes a window 150 facing the inner cavity 120, and a power line (not shown) of the motor 840 may be electrically connected to a battery (not shown) of the in-ear wireless earphone 10 through the window 150. In some embodiments, the motor 840 of the ventilation rate adjusting device 400 may be arranged in the inner cavity 120 of the housing wall 110 through the window 150.

According to some embodiments of the disclosure, the ventilation rate adjusting device 400 may adjust the ventilation rate of the ventilation channel by using the motor 840 to drive and rotate the rotary ring 830 relative to the fixed seat 820 so as to move the blades 810 relative to the fixed seat 820. Specifically, when the motor 840 is energized, the output shaft 841 of the motor 840 and the second engagement portion 852 rotate to drive the first engagement portion 851 and the rotary ring 830 to rotate, so that the blades 810 move relative to the fixed seat 820, thereby opening or closing the ventilation channel or adjusting the opening degree thereof.

### Plug Structure

According to some embodiments of the disclosure, the ventilation rate adjusting device may adopt a plug structure. FIG. 11A shows a perspective view of an in-ear wireless earphone according to some embodiments of the disclosure. FIG. 11B shows a cross-sectional view of an in-ear wireless earphone according to some embodiments of the disclosure. FIG. 11C shows an exploded view of a ventilation rate adjusting device of an in-ear wireless earphone according to some embodiments of the disclosure. FIG. 11D shows a schematic view of a ventilation rate adjusting device in an open state according to some embodiments of the disclosure. FIG. 11E shows a partial cross-sectional view of a ventilation rate adjusting device in an open state according to some embodiments of the disclosure. FIG. 11F shows a schematic view of a ventilation rate adjusting device in a closed state according to some embodiments of the disclosure. FIG. 11G shows a partial cross-sectional view of a ventilation rate adjusting device in a closed state according to some embodiments of the disclosure. FIG. 11H shows a partial cross-sectional view of a ventilation rate adjusting device in a partially open state according to some embodiments of the disclosure.

As shown in FIG. 11A, the in-ear wireless earphone 10 includes a customized housing 100, a panel 200 and a ventilation hole 300. As shown in FIG. 11B, the ventilation hole 300 of the in-ear wireless earphone 10 is disposed in the customized housing 100, and includes a mounting position 300C for mounting a ventilation rate adjusting device 400 (not shown in FIG. 11B). In an exemplary embodiment, as shown in FIG. 11B, the mounting position 300C is set at a second orifice 300B of the ventilation hole 300. In some embodiments, the ventilation rate adjusting device 400 may be mounted in the ventilation hole 300 at a position spaced apart from both a first orifice 300A and the second orifice 300B, i.e., at a middle position of the ventilation hole 300. In the embodiments shown in FIGS. 11A to 11H, please refer to the foregoing descriptions for other components and structures of the in-ear wireless earphone 10, which will not be repeated here.

According to some embodiments of the disclosure, as shown in FIGS. 11C to 11H, the ventilation rate adjusting device 400 includes a plug member 910 as the movable portion, a plug seat 920 as the fixed portion, and a motor 930 as the electric actuator. The plug seat 920 includes a fluid channel 921 communicated with the ventilation hole 300. The plug seat 920 is fixed in the ventilation hole 300 of the in-ear wireless earphone 10. In an exemplary embodiment, the plug seat 920 is an independent mounting seat, i.e., formed separately from the customized housing 100. The plug member 910 may move relative to the plug seat 920 to close or open the fluid channel 921 of the plug seat 920, thereby opening or closing the ventilation channel or adjusting the ventilation rate thereof.

According to some embodiments of the disclosure, the plug member 910 may move linearly relative to the plug seat 920. In an exemplary embodiment, a moving direction of the plug member 910 is substantially parallel to an extending direction of the ventilation hole 300 at the ventilation rate adjusting device 400. In an exemplary embodiment, as shown in FIGS. 11C to 11H, the plug member 910 may be inserted into or pulled out of the plug seat 920.

In some embodiments, as shown in FIGS. 11C to 11H, the plug member 910 includes a fluid channel 911. The fluid channel 911 of the plug member 910 may be configured to communicate the fluid channel 921 of the plug seat 920 with the external environment. When the plug member 910 is inserted into the plug seat 920, the fluid channel 911 of the plug member 910 is in fluid communication with the fluid channel 921 of the plug seat 920.

According to some embodiments of the disclosure, the ventilation rate adjusting device 400 further includes a first engagement portion 941 engaged with the plug member 910 and a second engagement portion 942 which is connected with an output shaft 931 of the motor 930 in a non-rotatable way. The first engagement portion 941 and the second engagement portion 942 are connected with each other in a transmission way. In an exemplary embodiment, as shown in FIG. 11C, the first engagement portion 941 includes internal threads, the second engagement portion 942 includes external threads, and the first engagement portion 941 and the second engagement portion 942 are threadedly engaged with each other. However, the disclosure is not limited thereto. In other embodiments, the first engagement portion 941 and the second engagement portion 942 may be other types of engagement portions, such as toothed engagement portions as long as they can be connected with each other in a transmission way to drive the plug member 910 to move.

In some embodiments, as shown in FIG. 11C, the first engagement portion 941 is fixedly connected to the plug member 910, for example, through a connecting member 943. However, the disclosure is not limited thereto. In some embodiments, the first engagement portion 941 and the plug member 910 are components independent from each other. For example, the plug member 910 may be movably supported by the first engagement portion 941 (e.g., through the connecting member 943) and move along with the movement of the first engagement portion 941.

In some embodiments, as shown in FIG. 11C, the second engagement portion 942 is integrally formed with the output shaft 931 of the motor 930, i.e., the second engagement portion 942 serves as external threads formed on the output shaft 931. However, the disclosure is not limited thereto. In some embodiments, the second engagement portion 942 and the output shaft 931 may be formed separately and fixedly connected together. For example, the second engagement portion 942 and the output shaft 931 may be connected to each other by an adhesive, threads, or the like.

In some embodiments, as shown in FIG. 11B, the customized housing 110 includes a window 150 facing the inner cavity 120, and a power line (not shown) of the motor 930 may be electrically connected to a battery (not shown) of the in-ear wireless earphone 10 through the window 150. In some embodiments, the motor 930 of the ventilation rate adjusting device 400 may be arranged in the inner cavity 120 of the housing wall 110 through the window 150.

According to some embodiments of the disclosure, the ventilation rate adjusting device 400 may adjust the ventilation rate of the ventilation channel by using the motor 930 to drive the plug member 910 to move relative to the plug seat 920. Specifically, when the motor 930 is energized, the output shaft 931 of the motor 930 and the second engagement portion 942 rotate to drive the first engagement portion 941 and the plug member 910 to move relative to the plug seat 920, so that the plug member 910 is inserted into or pulled out of the plug seat 920, thereby opening or closing the ventilation channel or adjusting the opening degree thereof.

In some embodiments, as shown in FIG. 11H, when the ventilation of the ventilation channel is achieved, the plug member 910 may be driven by the motor 930 to be partially, rather than completely, pulled out of the plug seat 920. Thus, in a process of gradually pulling out the plug member 910 from the plug seat 920, the plug member 910 can be kept at different positions relative to the plug seat 920, so as to achieve different degrees of ventilations. In some embodiments, as shown in FIGS. 11E, 11G and 11H, the plug member 910 includes a limiting portion 912, and the plug seat 920 includes a corresponding limiting portion 922. Thus, through a cooperation of the limiting portions 912 and 922, the plug member 910 can be limited at different levels relative to the plug seat 920, so as to achieve different degrees of ventilations more easily.

As described above, the ventilation adjust device 400 with a plug structure according to some embodiment of the disclosure includes an independent plug seat 920. However, the disclosure is not limited thereto. In some embodiments, the plug seat may be formed by the customized housing 100. In an exemplary embodiment, the plug seat is integrally formed with the customized housing 100. The plug member 910 may be inserted into or pulled out of the plug seat formed by the customized housing 100.

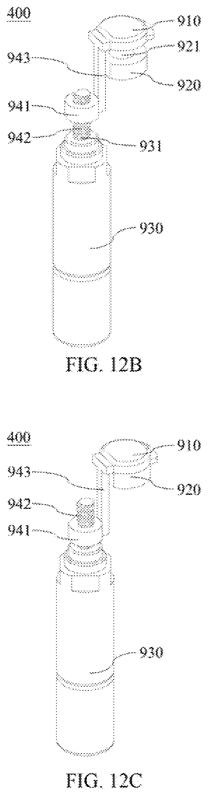

As described above, the plug member 910 of the ventilation rate adjusting device 400 according to some embodiments of the disclosure is disposed to be inserted into or pulled out of the plug seat 920. However, the disclosure is not limited thereto. FIG. 12A shows an exploded view of a ventilation rate adjusting device of an in-ear wireless earphone according to some embodiments of the disclosure. FIG. 12B shows a schematic view of a ventilation rate adjusting device in an open state according to some embodiments of the disclosure. FIG. 12C shows a schematic view of a ventilation rate adjusting device in a closed state according to some embodiments of the disclosure. As shown in FIGS. 12A to 12C, the plug member 910 is disposed in the form of a cover, which may be moved to cover the plug seat 920 or removed therefrom, without being inserted into or pulled out of the plug seat 920. When the motor 930 is energized, the output shaft 931 of the motor 930 and the second engagement portion 942 rotate to drive the first engagement portion 941 and the plug member 910 to move relative to the plug seat 920, so that the plug member 910 moves away from or approaches the plug seat 920, thereby opening or closing the ventilation channel or adjusting the opening degree thereof.

As described above, the moving direction of the plug member 910 is substantially parallel to the extending direction of the ventilation hole 300 at the ventilation rate adjust device 400. However, the disclosure is not limited thereto. Hereinafter, a ventilation rate adjusting device with a plug structure according to some embodiments of the disclosure will be described in detail with reference to the drawings.

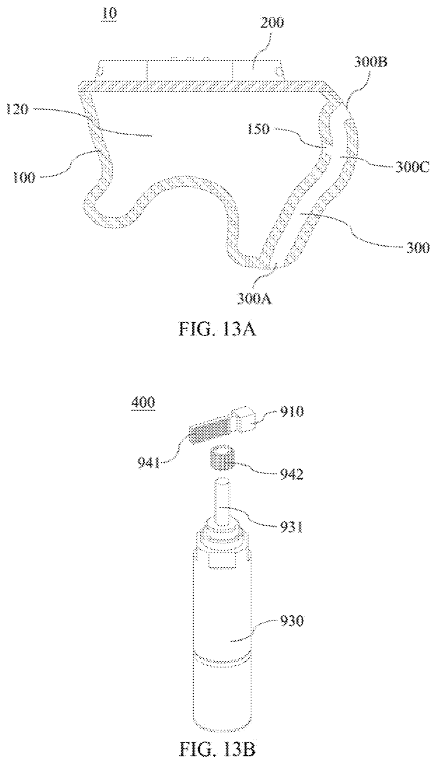

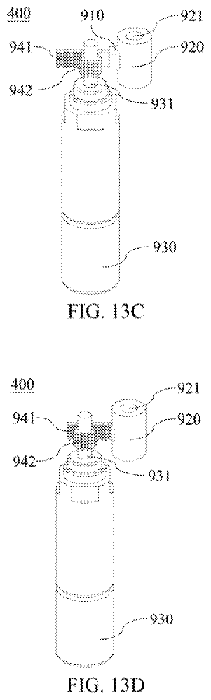

FIG. 13A shows a cross-sectional view of an in-ear wireless earphone according to some embodiments of the disclosure. FIG. 13B shows an exploded view of a ventilation rate adjusting device of an in-ear wireless earphone according to some embodiments of the disclosure. FIG. 13C shows a schematic view of a ventilation rate adjusting device in an open state according to some embodiments of the disclosure. FIG. 13D shows a schematic view of a ventilation rate adjusting device in a closed state according to some embodiments of the disclosure.

As shown in FIG. 13A, the in-ear wireless earphone 10 includes a customized housing 100, a panel 200 and a ventilation hole 300. The ventilation hole 300 of the in-ear wireless earphone 10 is disposed in the customized housing 100, and includes a mounting position 300C for mounting a ventilation rate adjusting device 400 (not shown in FIG. 13A). In an exemplary embodiment, as shown in FIG. 13A, the ventilation rate adjusting device 400 may be mounted in the ventilation hole 300 at a position spaced apart from both a first orifice 300A and a second orifice 300B, i.e., at a middle position of the ventilation hole 300. In some embodiments, the mounting position 300C is disposed at the second orifice 300B of the ventilation hole 300. In the embodiments shown in FIGS. 13A to 13D, please refer to the foregoing descriptions for other components and structures of the in-ear wireless earphone 10, which will not be repeated here.

According to some embodiments of the disclosure, as shown in FIGS. 13B to 13D, the ventilation rate adjusting device 400 includes a plug member 910 as the movable portion, a plug seat 920 as the fixed portion, and a motor 930 as the electric actuator. The plug seat 920 includes a fluid channel 921 communicated with the ventilation hole 300. The plug seat 920 is fixed in the ventilation hole 300 of the in-ear wireless earphone 10. In an exemplary embodiment, the plug seat 920 is an independent mounting seat, i.e., formed separately from the customized housing 100. The plug member 910 may move relative to the plug seat 920 to close or open the fluid channel 921 of the plug seat 920, thereby opening or closing the ventilation channel or adjusting the ventilation rate thereof.

According to some embodiments of the disclosure, the plug member 910 may move linearly relative to the plug seat 920. In an exemplary embodiment, the moving direction of the plug member 910 is intersected with, e.g., substantially perpendicular to, the extending direction of the ventilation hole 300 at the ventilation rate adjusting device 400. In an exemplary embodiment, as shown in FIGS. 13C and 13D, the plug member 910 may be inserted into or removed out of the plug seat 920.

According to some embodiments of the disclosure, the ventilation rate adjusting device 400 further includes a first engagement portion 941 engaged with the plug member 910 and a second engagement portion 942 which is connected with the output shaft 931 of the motor 930 in a non-rotatable way. The first engagement portion 941 and the second engagement portion 942 are connected with each other in a transmission way. In some embodiments, as shown in FIG. 13B, the first engagement portion 941 is fixedly connected to, e.g., integrally formed with the plug member 910. In an exemplary embodiment, as shown in FIGS. 13B to 13D, the first engagement portion 941 is a rack, second engagement portion 942 is a gear, and the first engagement portion 941 and the second engagement portion 942 are meshed with each other. However, the disclosure is not limited thereto. In other embodiments, the first engagement portion 941 and the second engagement portion 942 may be other types of engagement portions as long as they can be connected with each other in a transmission way to drive the plug member 910 to move.

According to some embodiments of the disclosure, the ventilation rate adjusting device 400 may adjust the ventilation rate of the ventilation channel by using the motor 930 to drive the plug member 910 to move relative to the plug seat 920. Specifically, when the motor 930 is energized, the output shaft 931 of the motor 930 and the second engagement portion 942 rotate to drive the first engagement portion 941 and the plug member 910 to move relative to the plug seat 920, so that the plug member 910 is inserted into or pulled out of the plug seat 920, thereby opening or closing the ventilation channel or adjusting the opening degree thereof.

In the embodiments shown in FIGS. 13A to 13D, please refer to the foregoing descriptions for other structures of the ventilation rate adjusting device 400, which will not be repeated here.

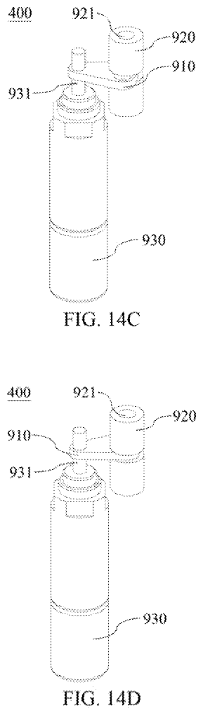

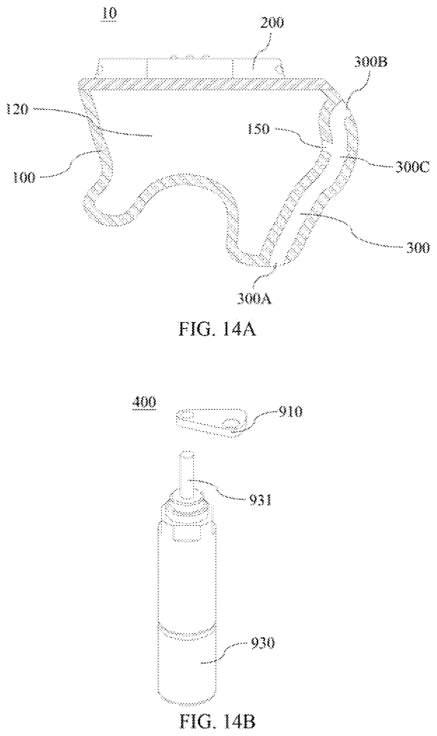

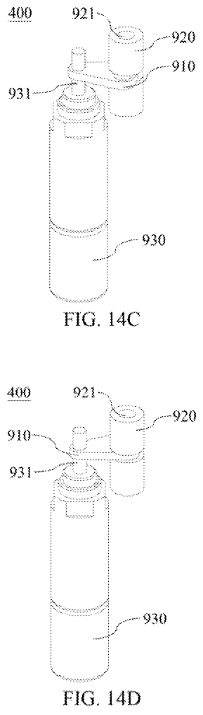

FIG. 14A shows a cross-sectional view of an in-ear wireless earphone according to some embodiments of the disclosure. FIG. 14B shows an exploded view of a ventilation rate adjusting device of an in-ear wireless earphone according to some embodiments of the disclosure. FIG. 14C shows a schematic view of a ventilation rate adjusting device in an open state according to some embodiments of the disclosure. FIG. 14D shows a schematic view of a ventilation rate adjusting device in a closed state according to some embodiments of the disclosure.

As shown in FIG. 14A, the in-ear wireless earphone 10 includes a customized housing 100, a panel 200 and a ventilation hole 300. The ventilation hole 300 of the in-ear wireless earphone 10 is disposed in the customized housing 100, and includes a mounting position 300C for mounting a ventilation rate adjusting device 400 (not shown in FIG. 14A). In an exemplary embodiment, as shown in FIG. 14A, the ventilation rate adjusting device 400 may be mounted in the ventilation hole 300 at a position spaced apart from both a first orifice 300A and a second orifice 300B, i.e., at a middle position of the ventilation hole 300. In some embodiments, the mounting position 300C is disposed at the second orifice 300B of the ventilation hole 300. In the embodiments shown in FIGS. 14A to 14D, please refer to the foregoing descriptions for other components and structures of the in-ear wireless earphone 10, which will not be repeated here.

According to some embodiments of the disclosure, as shown in FIGS. 14B to 14D, the ventilation rate adjusting device 400 includes a plug member 910 as the movable portion, a plug seat 920 as the fixed portion, and a motor 930 as the electric actuator. The plug seat 920 includes a fluid channel 921 communicated with the ventilation hole 300. The plug seat 920 is fixed in the ventilation hole 300 of the in-ear wireless earphone 10. In an exemplary embodiment, the plug seat 920 is an individual mounting seat, i.e., formed separately from the customized housing 100. The plug member 910 may move relative to the plug seat 920 to close or open the fluid channel 921 of the plug seat 920, thereby opening or closing the ventilation channel or adjusting the ventilation rate thereof.

As described above, the plug member 910 moves linearly relative to the plug seat 920. However, the disclosure is not limited thereto. In some embodiments, unlike the embodiments shown in FIGS. 11A to 13D, the plug member 910 may rotate relative to the plug seat 920 as shown in FIGS. 14B to 14D. In an exemplary embodiment, a rotation plane of the plug member 910 is intersected with, e.g., substantially perpendicular to, the extending direction of the ventilation hole 300 at the ventilation rate adjusting device 400. In an exemplary embodiment, as shown in FIGS. 14C and 14D, the plug member 910 may be rotatably inserted into the plug seat 920 or rotatably removed out of the plug seat 920.

According to some embodiments of the disclosure, the plug member 910 is connected with an output shaft 931 of the motor 930 in a transmission way. In an exemplary embodiment, as shown in FIGS. 14B to 14D, the plug member 910 is connected with the output shaft 931 of the motor 930 in a non-rotatable way. However, the disclosure is not limited thereto. In other embodiments, the plug member 910 and the output shaft 931 of the motor 930 may also be connected in a transmission way by other means, such as through an intermediate transmission gear, as long as they can be connected with each other in a transmission way to drive the plug member 910 to rotate relative to the plug seat 920.

According to some embodiments of the disclosure, the ventilation rate adjusting device 400 may adjust the ventilation rate of the ventilation channel by using the motor 930 to drive the plug member 910 to move relative to the plug seat 920. Specifically, when the motor 930 is energized, the output shaft 931 of the motor 930 rotates to drive the plug member 910 to rotate relative to the plug seat 920, so that the plug member 910 is inserted into or pulled out of the plug seat 920, thereby opening or closing the ventilation channel or adjusting the opening degree thereof.

In the embodiment shown in FIGS. 14A to 14D, please refer to the foregoing descriptions for other structures of the ventilation rate adjusting device 400, which will not be repeated here.

As described above, the ventilation hole 300 is completely disposed in the customized housing 100. However, the disclosure is not limited thereto. In some embodiments, the ventilation hole 300 of the in-ear wireless earphone 10 may include a first hole section located in the customized housing 100 and a second hole section located in the panel 200, wherein the ventilation channel includes a first section disposed in the customized housing 100 and a second section disposed in the panel 200. In this case, the ventilation rate adjusting device 400 according to the embodiment of the disclosure may be disposed in the second hole section of the ventilation hole 300 located in the panel 200.

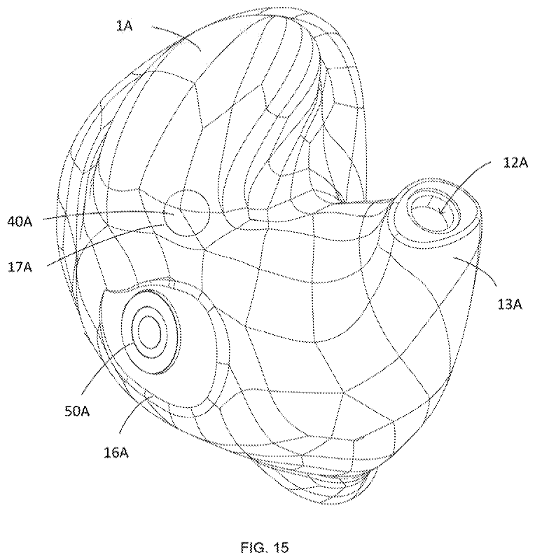

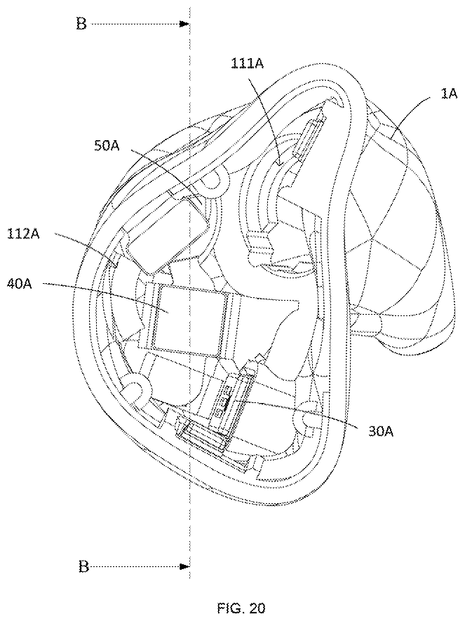

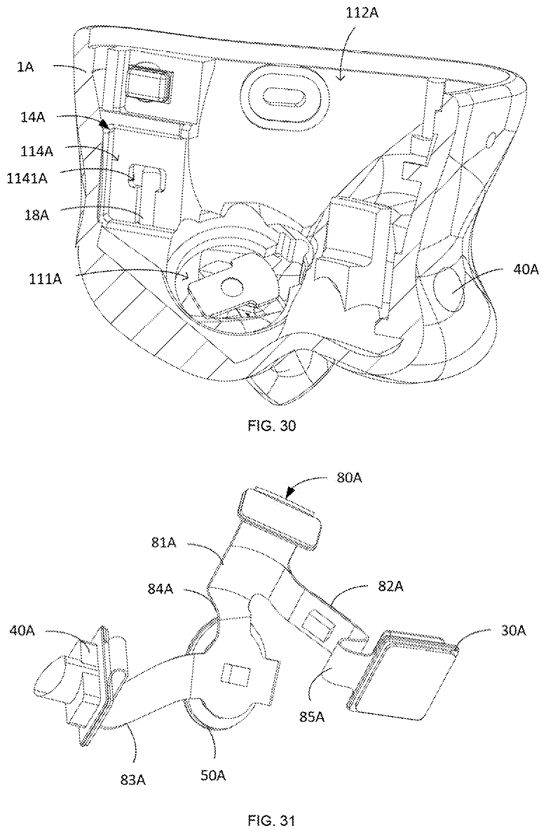

Another aspect of the disclosure will be described in detail below referring to FIGS. 15-35.

Referring to FIG. 17, the in-ear wearable device includes a housing 1A and a first speaker 20A, and the first speaker 20A is disposed in the housing 1A.

Specifically, the first speaker 20A is a moving coil unit. The moving coil unit includes vibrating diaphragm, a voice coil, a magnetic circuit system, a basket, etc. When an audio signal passes through the voice coil, the voice coil is moved in a magnetic field to drive the vibrating diaphragm to vibrate, thereby pushing air to generate sound.

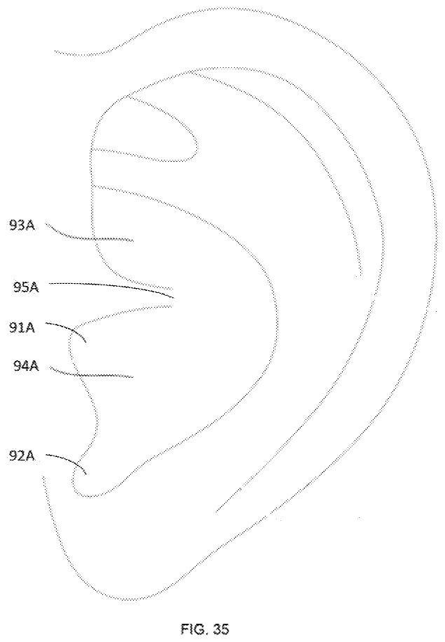

In one embodiment, referring to FIG. 15, FIG. 17 and FIG. 35, the housing 1A is provided with an accommodating cavity 11A and a sound output opening 12A in communication with the accommodating cavity 11A, and the first speaker 20A is disposed in the accommodating cavity 11A. When a user is wearing the in-ear wearable device, the sound output opening 12A is in communication with an ear canal of the user, and the sound emitted from the first speaker 20A may be transmitted to the ear canal via the sound output opening 12A, so that the user can hear the sound.

Further, referring to FIG. 15 and FIG. 35, the housing 1A includes a first mounting portion 13A. When the user is wearing the in-ear wearable device, the first mounting portion 13A is disposed corresponding to an ear canal opening 91A of the user. The sound output opening 12A is disposed on the first mounting portion 13A, and the first speaker 20A is close to the first mounting portion 13A. When the user uses the in-ear wearable device, the first speaker 20A is disposed at the ear canal opening 91A or at a position close to the ear canal opening 91A, so that the sound quality of the in-ear wearable device can be ensured.

Optionally, the first mounting portion 13A has a curved surface. Of course, in other embodiments, the first mounting portion 13A may also has a flat surface or the like, which is not limited thereto.

However, when the user uses the in-ear wearable device, the ear canal opening 91A the user is partially or completely blocked, and the speaking voice of the user may be transmitted into the ear canal by the skull, and due to a small volume of the ear canal, the reflection of low-frequency sound is enhanced, causing the use to perceive “echoey” or “hollow” sounds. Thus, when having worn the in-ear wearable device for a long time, the user may feel discomfort, thereby affecting the user experience. Therefore, in the present embodiment, the in-ear wearable device further includes a vent 30A. The vent 30A is disposed in the accommodating cavity 11A, and the vent 30A is configured to permit or restrict communication between the ear canal and the external environment.

When the vent 30A is opened, the ear canal is in communication with the external environment. In this way, air pressure balance between the ear canal and the external environment can be dynamically regulated to reduce the discomfort caused by closing of the ear canal, thereby improving the comfort of the user when wearing the in-ear wearable device.

Optionally, the vent 30A is an electronic vent. Of course, in other embodiments, the vent 30A may also be of other types, which is not limited thereto.

In one embodiment, the housing 1A is provided with a touch portion. In use, the user may control opening or closing of the vent 30A by touching the touch portion by hand, thereby permitting or restricting communication between the ear canal and the external environment.

Of course, in other embodiments, the vent 30A may also be controlled by an APP to be opened or closed. Or, the user controls opening or closing of the vent 30A through body movement, for example, nodding.

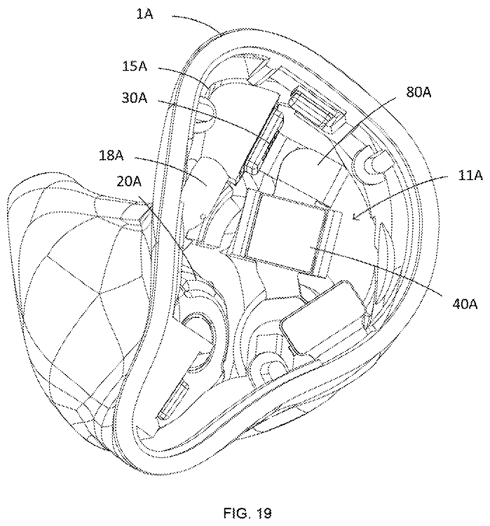

In one embodiment, referring to FIG. 15, FIG. 19 and FIG. 26, the housing 1A includes a second mounting portion 14A, a third mounting portion 15A and a fourth mounting portion 16A. When the user is wearing the in-ear wearable device, the second mounting portion 14A is disposed corresponding to an intertragic notch 92A of the user, the third mounting portion 15A is disposed corresponding to a cymba conchae 93A of the user, and the fourth mounting portion 16A is disposed corresponding to a cavum conchae 94A of the user.

It should be noted that the second mounting portion 14A being disposed corresponding to the intertragic notch 92A of the user means that at least a part of the second mounting portion 14A is in contact with the intertragic notch 92A of the user, or at least a part of projection of the second mounting portion 14A on the ear of the user is disposed within the intertragic notch 92A.

It should be noted that the third mounting portion 15A being disposed corresponding the cymba conchae 93A of the user means that at least a part of the third mounting portion 15A is in contact with the cymba conchae 93A of the user, or at least a part of a projection of the third mounting portion 15A on the ear of the user is disposed within the cymba conchae 93A.

It should be noted that the fourth mounting portion 16A being disposed corresponding to the cavum conchae 94A of the user means that at least a part of the fourth mounting portion 16A is in contact with the cavum conchae 94A of the user, or at least a part of a projection of the fourth mounting portion 16A on the ear of the user is disposed within the cavum conchae 94A.

Optionally, each of the second mounting portion 14A, the third mounting portion 15A and the fourth mounting portion 16A has a curved surface. Of course, in other embodiments, each of the second mounting portion 14A, the third mounting portion 15A and the fourth mounting portion 16A may also has a flat surface or the like, which is not limited thereto.

Further, referring to FIG. 15 and FIG. 35, the vent 30A is disposed on one of the second mounting portion 14A, the third mounting portion 15A and the fourth mounting portion 16A. When the user uses the in-ear wearable device, the first speaker 20A is disposed at the ear canal opening 91A of the user or at a position close to the ear canal opening 91A, and the vent 30A is disposed at one of the intertragic notch 92A, the cymba conchae 93A and the cavum conchae 94A of the user. Thus, by reasonably arranging the first speaker 20A and the vent 30A, the accommodating cavity 11A having a confined space can accommodate both the first speaker 20A and the vent 30A, thereby solving the problem of the occlusion effect, improving the comfort of the user when wearing the in-ear wearable device, and also improving the sound quality.

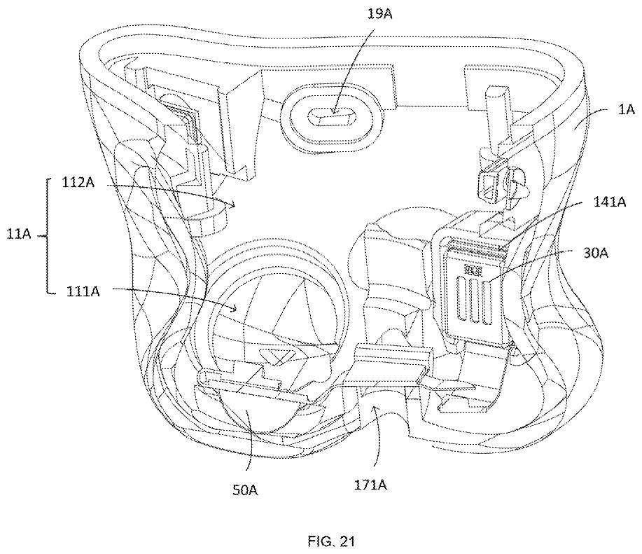

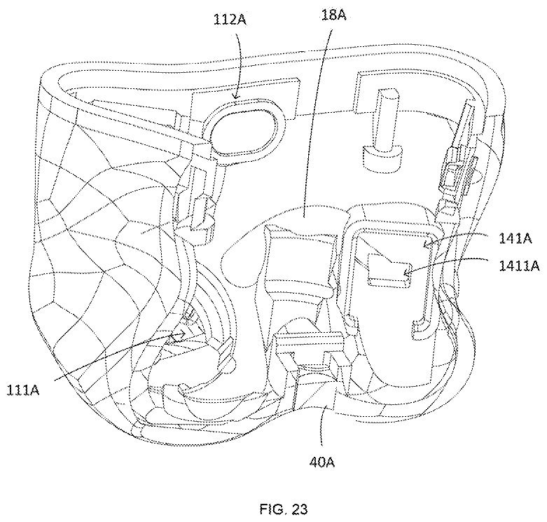

In one embodiment, referring to FIG. 21 and FIG. 23, one of the second mounting portion 14A, the third mounting portion 15A and the fourth mounting portion 16A is provided with an accommodating recess 141A, and at least a part of the vent 30A is disposed in the accommodating recess 141A. In this way, space can be saved, so that the in-ear wearable device is more compact, which facilitates miniaturization of the in-ear wearable device. Furthermore, a wall of the accommodating recess 141A may provide a stable support for the vent 30A, thereby preventing the vent 30A from displacing or loosening, and thus being beneficial to improving the reliability of mounting of the vent 30A.

It should be noted that the shape and the size of the accommodating recess 141A are adapt to those of the vent 30A. Optionally, the vent 30A is a square body, and the accommodating recess 141A is a square recess.

In one embodiment, referring to FIG. 17, the first speaker 20A divides the accommodating cavity 11A into a front cavity 111A and a rear cavity 112A, and the sound output opening 12A is in communication with the front cavity 111A. Specifically, the sound output opening 12A is disposed on a wall of the front cavity 111A.

Further, referring to FIG. 17 and FIG. 21, the housing 1A is provided with an air release hole 19A, and the air release hole 19A is in communication with the rear cavity 112A and the external environment. Specifically, the air release hole 19A is disposed on a wall of the rear cavity 112A. The vent 30A is configured to permit or restrict communication between the front cavity 111A and the rear cavity 112A. When the vent 30A is closed, the front cavity 111A is not in communication with the rear cavity 112A, the ear canal is in communication with the front cavity 111A through the sound output opening 12A, and the rear cavity 112A is in communication with the external environment through the air release hole 19A. When the vent 30A is opened, the ear canal is in communication with the external environment through the front cavity 111A, the vent 30A, the rear cavity 112A and the air release hole 19A. In this way, air pressure balance between the inside and outside of the ear canal can be dynamically regulated, thereby reducing the discomfort caused by closing of the ear canal.

In one embodiment, referring to FIG. 17 and FIG. 19, the in-ear wearable device further includes a ventilation channel 18A, and the vent 30A is configured to permit or restrict communication between the front cavity 111A and the rear cavity 112A through the ventilation channel 18A. By providing the ventilation channel 18A, the ventilation channel 18A is used for allowing communication between the front cavity 111A and the rear cavity 112A, so that the air pressure balance inside and outside the ear canal can be easily dynamically controlled, thereby reducing the discomfort caused by the closing of the ear canal.

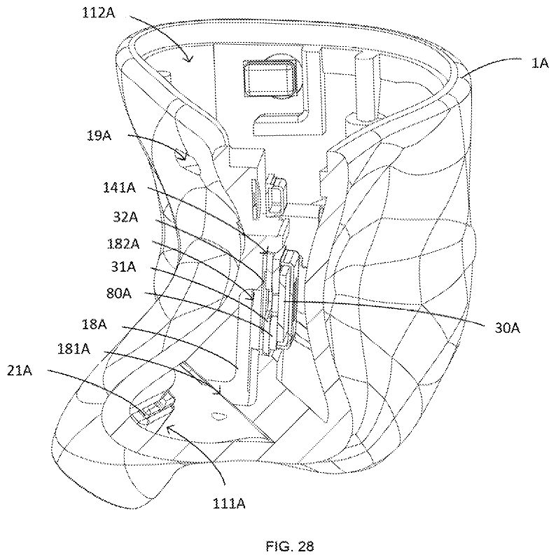

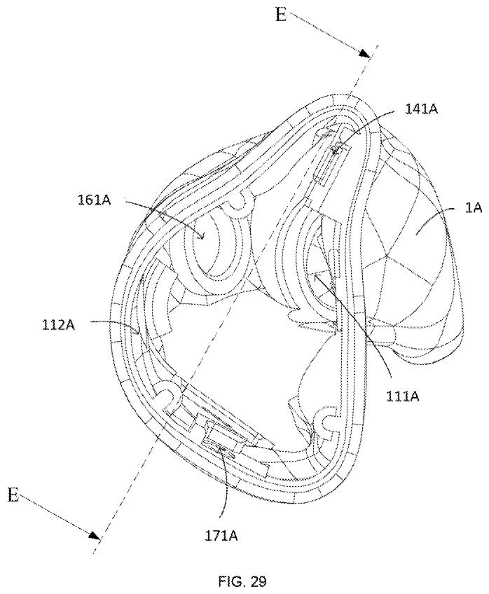

Optionally, referring to FIG. 28, the ventilation channel 18A is formed in a side wall of the housing 1A. Thus, by hiding the ventilation channel 18A in the side wall of the housing 1A, there is no need to additionally occupy the space of the accommodating cavity 11A, so that a sufficient space is provided for other components in the accommodating cavity 11A, and impact and compression of the ventilation channel 18A by the components in the accommodating cavity 11A can be resisted, thereby reducing the risk of failure of the vent function caused by physical damage incurred during use of the in-ear wearable device. In addition, the ventilation channel 18A and the housing 1A may be integrally formed, thereby reducing processing steps.

Optionally, referring to FIG. 19 and FIG. 23, the ventilation channel 18A and the housing 1A are independent of each other. Thus, the shape, the size and the position of the ventilation channel 18A can be optimized according to actual requirements without being constrained by the shape and the structure of the housing 1A.

In one embodiment, referring to FIG. 23, the accommodating recess 141A is disposed on a wall of the rear cavity 112A, and a wall of the accommodating recess 141A is provided with a communication hole 1411A.

Further, referring to FIG. 28, the ventilation channel 18A has a first end and a second end, the first end is disposed in the front cavity 111A, and the second end is disposed in the rear cavity 112A. The first end is provided with a first ventilation hole 181A, and the first ventilation hole 181A is in communication with the front cavity 111A. The second end is provided with a second ventilation hole 182A, and the second ventilation hole 182A is in communication with the communication hole 1411A. It should be noted that the side wall of the ventilation channel 18A is not in communication with the front cavity 111A and the rear cavity 112A, that is, the side wall of the ventilation channel 18A is isolated from both the front cavity 111A and the rear cavity 112A. When the vent 30A is opened, the first ventilation hole 181A guides airflow in the front cavity 111A to enter the ventilation channel 18A, and the second ventilation hole 182A guides airflow in the ventilation channel 18A to enter the rear cavity 112A, so that the ear canal is in communication with the external environment, thereby reducing the occlusion effect, and improving the wearing comfort.

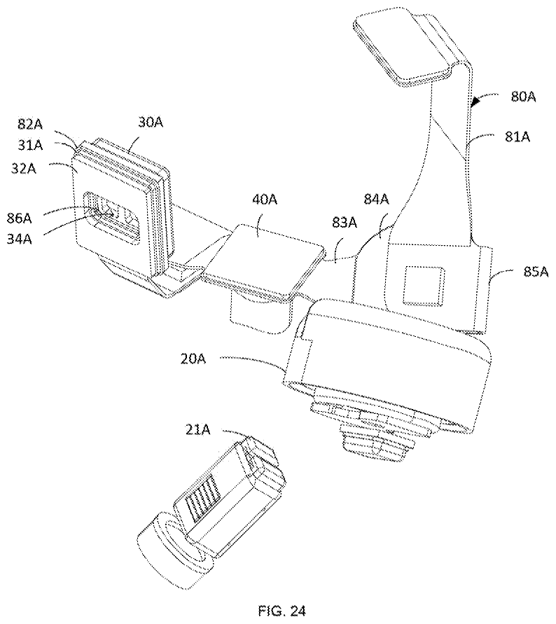

In one embodiment, referring to FIG. 23, FIG. 24 and FIG. 28, the vent 30A is provided with an air outlet hole 34A, and the air outlet hole 34A is in communication with the second ventilation hole 182A through the communication hole 1411A. In this way, air in the ventilation channel 18A can easily enter the vent 30A through the second ventilation hole 182A and the communication hole 1411A.

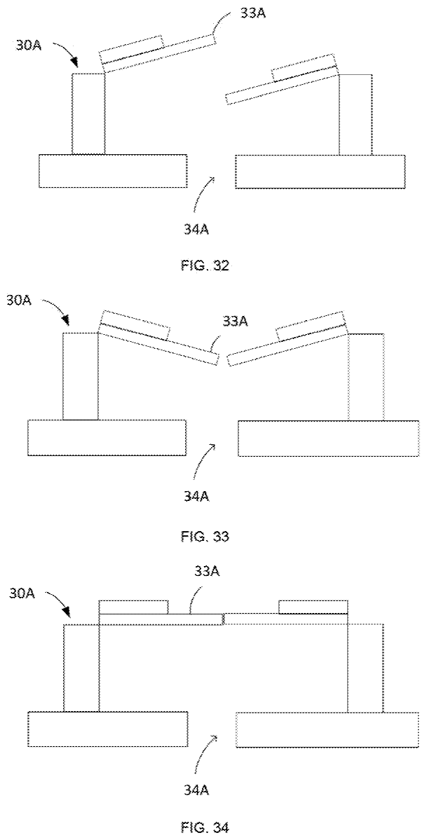

In one embodiment, referring to FIG. 23, FIG. 24 and FIG. 32, the vent 30A is provided with a valve 33A and an air outlet hole 34A. The air outlet hole 34A is in communication with the front cavity 111A through the ventilation channel 18A, and the valve 33A may be opened, so that the air outlet hole 34A is in communication with the external environment through the air release hole 19A. It should be noted that, referring to FIG. 32, FIG. 33 and FIG. 34, the valve 33A may be completely opened, completely closed or partially opened. The valve 33A may also be subjected to stepless adjustment, that is, the opening degree of the valve 33A is adjusted as needed. The ear canal is in communication with the front cavity 111A, and the front cavity 111A is in communication with the air outlet hole 34A of the vent 30A through the ventilation channel 18A, so that the ear canal is in communication with the vent 30A. When the valve 33A is opened, airflow is in communication with the external environment through the ear canal, the ventilation channel 18A, the air outlet hole 34A, the valve 33A and the air release hole 19A. When the valve 33A is closed, the vent 30A restricts communication between the front cavity 111A and the rear cavity 112A, thereby restricting communication between the ear canal of the user and the external environment.

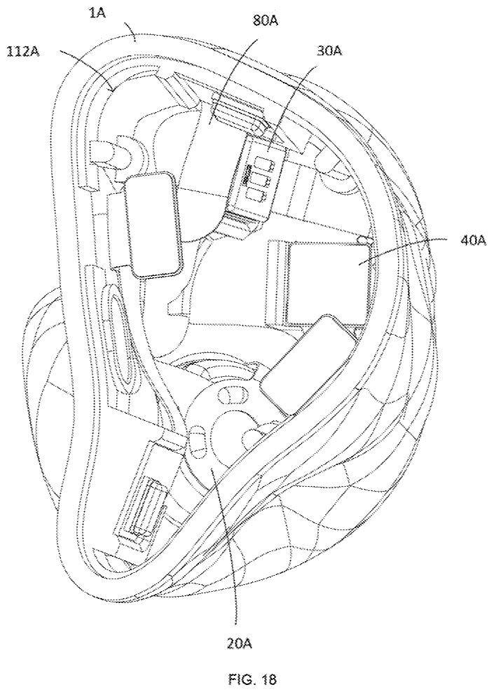

In one embodiment, referring to FIG. 17 and FIG. 18, the in-ear wearable device further includes a main board 60A and a flexible circuit board 80A, and both the main board 60A and the flexible circuit board 80A are disposed in the accommodating cavity 11A. Optionally, both the main board 60A and the flexible circuit board 80A are disposed in the rear cavity 112A. The vent 30A is electrically connected with the main board 60A through the flexible circuit board 80A. Thus, the main board 60A can control the opening and closing states of the vent 30A through a circuit signal, so as to accurately regulate air pressure balance between the inside and outside of the ear canal, thereby reducing the discomfort caused by closing of the ear canal. In addition, the flexible circuit board 80A may be bent or folded so as to be flexibly arranged in the accommodating cavity 11A, thereby connecting with components in the accommodating cavity 11A, and facilitating miniaturization of the in-ear wearable device.

Further, referring to FIG. 23 and FIG. 24, the flexible circuit board 80A is provided with a through hole 86A, and the through hole 86A is in communication with the air outlet hole 34A and the ventilation channel 18A. In this way, blocking of the air outlet hole 34A of the vent 30A by the flexible circuit board 80A can be avoided, ensuring that the front cavity 111A can communicate with the vent 30A through the ventilation channel 18A.

Specifically, at least a part of the flexible circuit board 80A is disposed between the wall of the accommodating recess 141A and the vent 30A, and the air outlet hole 34A is in communication with the ventilation channel 18A via the through hole 86A and the communication hole 1411A. In this way, the flexible circuit board 80A is relatively fixed between the wall of the accommodating recess 141A and the vent 30A, thereby reducing the shake and displacement of the flexible circuit board 80A, enhancing the stability of circuit connection, and reducing the risk of the in-ear wearable device failing to operate normally due to a circuit failure.

It should be noted that the air outlet hole 34A is in communication with the first ventilation hole 181A and the second ventilation hole 182A of the ventilation channel 18A via the through hole 86A and the communication hole 1411A. When the valve 33A is opened, airflow is in communication with the external environment through the ear canal, the first ventilation hole 181A and the second ventilation hole 182A of the ventilation channel 18A, the communication hole 1411A, the through hole 86A, the air outlet hole 34A, the valve 33A and the air release hole 19A, so as to dynamically regulate air pressure balance between the ear canal and the external environment, and to reduce the discomfort caused by closing of the ear canal, thereby improving the comfort of the user when wearing the in-ear wearable device. The provision of the through hole 86A and the communication hole 1411A ensures the communication between the vent 30A and the ventilation channel 18A.

In one embodiment, referring to FIG. 17 and FIG. 18, an extension direction of the vent 30A intersects with an extension direction of the main board 60A. Taking FIG. 17 and FIG. 18 as an example, the main board 60A extends in the horizontal direction, and the vent 30A extends in a direction intersecting with the horizontal direction. In this way, the vent 30A is disposed adjacent to an inner side wall of the housing 1A, and has an extension direction approximately perpendicular to the extension direction of the main board 60A, so that the vent 30A can be compactly arranged in the accommodating cavity 11A, thereby facilitating miniaturization of the in-ear wearable device.

In one embodiment, the in-ear wearable device further includes a protective member, and the protective member is disposed on the vent 30A. By providing the protective member, the protective member can effectively block impurities such as moisture and dust from entering the vent 30A from the rear cavity 112A, thereby protecting the vent 30A, and thus being beneficial to prolonging the service life of the vent 30A.

Optionally, the protective member is waterproof mesh cloth, and the waterproof mesh cloth is disposed in the accommodating recess 141A and covers the communication hole 1411A. In one embodiment, referring to FIG. 17 and FIG. 24, the in-ear wearable device further includes a second speaker 21A, and the second speaker 21A is disposed in the accommodating cavity 11A. Specifically, the second speaker 21A is disposed in the front cavity 111A.

Specifically, the second speaker 21A is a moving iron unit. The moving iron unit includes a vibrating diaphragm, an armature, a coil, a magnet, etc. When an audio signal passes through the coil, the armature vibrates in a magnetic field and drives the vibrating diaphragm to vibrate, thereby generating sound. Thus, the cooperation between the moving coil unit and the moving iron unit enables a more balanced sound quality performance.

In one embodiment, referring to FIG. 24 and FIG. 28, one side of the vent 30A is provided with a reinforcing plate 31A, and the reinforcing plate 31A is connected to a wall of the accommodating recess 141A. Thus, with the effect of the reinforcing plate 31A, the structural strength of the vent 30A can be improved, and the mounting firmness of the vent 30A can also be improved.

Optionally, one side of the reinforcing plate 31A is bonded to the vent 30A by an adhesive backing 32A, and the other side of the reinforcing plate 31A is bonded to the wall of the accommodating recess 141A by an adhesive backing 32A.

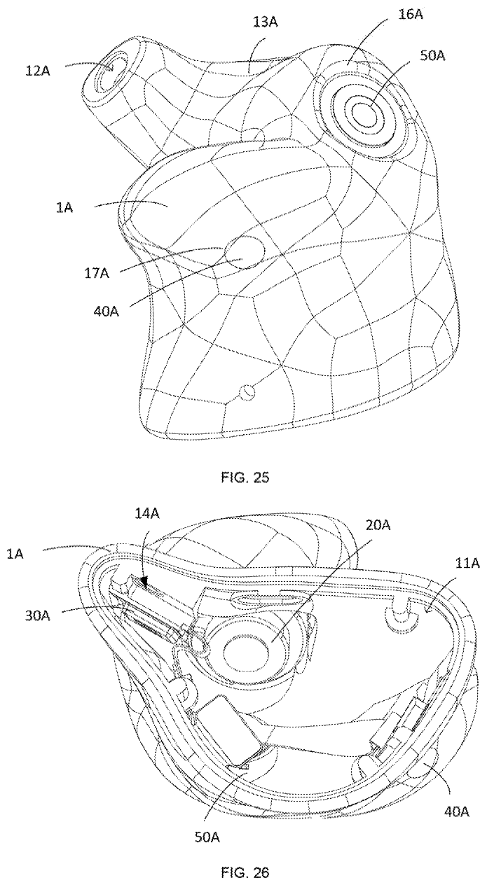

In one embodiment, referring to FIG. 15, FIG. 18 and FIG. 25, the in-ear wearable device further includes a wearing state detector 40A. The wearing state detector 40A is disposed in the accommodating cavity 11A. Specifically, the wearing state detector 40A is disposed in the rear cavity 112A. The wearing state detector 40A is electrically connected to the main board 60A through the flexible circuit board 80A, and the wearing state detector 40A is used for detecting whether the in-ear wearable device is worn on the ear of the user.

Optionally, the wearing state detector 40A may be an optical sensor, a skin detection sensor, an air pressure sensor or a photoelectric sensor.

The wearing state detector 40A is an important sensor, and mainly functions to detect whether the user is wearing the in-ear wearable device. When the user places the in-ear wearable device in the ear, the in-ear wearable device may automatically play music; and when the user takes off the in-ear wearable device, music playback is automatically paused, thereby improving the user experience, and reducing unnecessary power consumption when the in-ear wearable device is not in use. If the user takes off the in-ear wearable device and does not put it back into a charging box for a prolonged period, the wearing state detector 40A may trigger the in-ear wearable device to enter a sleep or shutdown state, thereby reducing power consumption.

In one embodiment, referring to FIG. 15 and FIG. 35, the housing 1A further includes a fifth mounting portion 17A. When the user is wearing the in-ear wearable device, the fifth mounting portion 17A is disposed corresponding to a crus of helix 95A of the user.

Optionally, the fifth mounting portion 17A has a curved surface. Of course, in other embodiments, the fifth mounting portion 17A may also have a flat surface, which is not limited thereto.

Optionally, referring to FIG. 25 and FIG. 35, the vent 30A is disposed on the second mounting portion 14A, and the wearing state detector 40A is disposed on one of the third mounting portion 15A, the fourth mounting portion 16A and the fifth mounting portion 17A. When the user uses the in-ear wearable device, the vent 30A is disposed corresponding to the intertragic notch 92A of the user, and since the intertragic notch 92A is very close to the ear canal, such configuration enables the rear cavity 112A to be in communication with the front cavity 111A through the short ventilation channel 18A, thereby reducing the ventilation resistance. Furthermore, the wearing state detector 40A is disposed corresponding to the crus of helix 95A, the cavum conchae 94A or the cymba conchae 93A of the user, thus interference between the vent 30A and the wearing state detector 40A during mounting can be avoided.

Optionally, referring to FIG. 15, FIG. 19 and FIG. 35, the vent 30A is disposed on the third mounting portion 15A, and the wearing state detector 40A is disposed on one of the second mounting portion 14A, the fourth mounting portion 16A and the fifth mounting portion 17A. When the user uses the in-ear wearable device, the vent 30A is disposed corresponding to the cymba conchae 93A of the user. Since the cymba conchae 93A region is open, the vent 30A can be assembled and sealed easily. Furthermore, the wearing state detector 40A is disposed corresponding to the intertragic notch 92A, the cavum conchae 94A or the crus of helix 95A of the user, thus interference between the vent 30A and the wearing state detector 40A during mounting can be avoided.

Optionally, the vent 30A is disposed on the fourth mounting portion 16A, and the wearing state detector 40A is provided on one of the second mounting portion 14A, the third mounting portion 15A and the fifth mounting portion 17A. When the user uses the in-ear wearable device, the vent 30A is disposed corresponding to the cavum conchae 94A of the user, and the wearing state detector 40A is disposed corresponding to the intertragic notch 92A, the cymba conchae 93A or the crus of helix 95A of the user, thus interference between the vent 30A and the wearing state detector 40A during mounting can be avoided.

In one embodiment, referring to FIG. 21 and FIG. 23, one of the second mounting portion 14A, the third mounting portion 15A, the fourth mounting portion 16A and the fifth mounting portion 17A is provided with an opening 171A, and a part of the wearing state detector 40A is disposed in the opening 171A. Optionally, the wearing state detector 40A is an optical detector. During detection, the wearing state detector 40A is in contact with the skin of the user. Furthermore, the wearing state detector 40A needs to be arranged in a dark place.

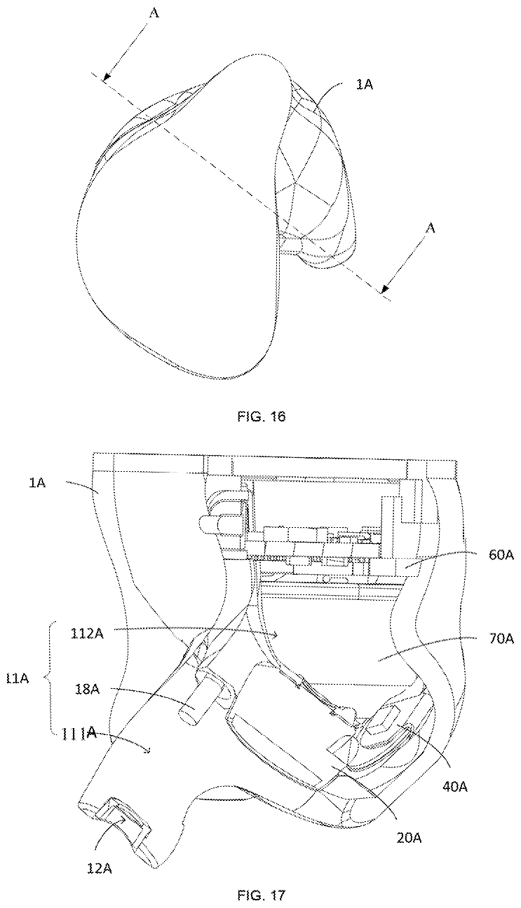

In one embodiment, referring to FIG. 16 and FIG. 17, the in-ear wearable device further includes a main board 60A and a battery 70A, and both the main board 60A and the battery 70A are disposed in the accommodating cavity 11A. Specifically, both the main board 60A and the battery 70A are disposed in the rear cavity 112A. The battery 70A is electrically connected to the main board 60A through a wiring terminal. Thus, the battery 70A can supply power to functional components in the in-ear wearable device, so as to ensure that the functional components can operate reliably.

Further, referring to FIG. 17, the battery 70A is disposed between the main board 60A and the first speaker 20A. Thus, the space of the rear cavity 112A can be fully utilized, thereby increasing the space utilization rate.

In one embodiment, referring to FIG. 17 and FIG. 19, the in-ear wearable device further includes a charging assembly 50A, the charging assembly 50A is disposed in the accommodating cavity 11A, and the charging assembly 50A is electrically connected to the main board 60A through the flexible circuit board 80A. Specifically, the charging assembly 50A is disposed in the rear cavity 112A and is electrically connected to the main board 60A. By providing the charging assembly 50A, the charging assembly 50A can convert the electrical energy of an external power source into electrical energy required by the battery 70A, and store the electrical energy in the battery 70A, so as to replenish energy consumed by the battery 70A in use.

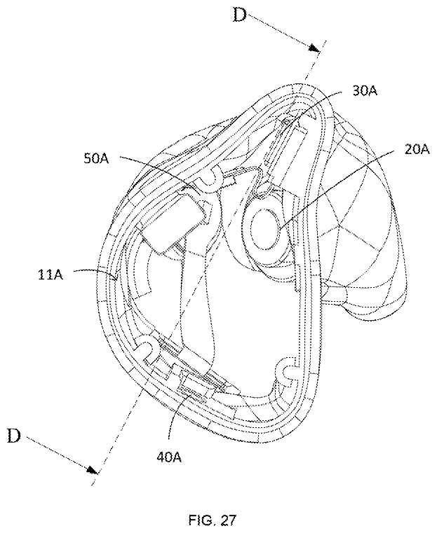

In one embodiment, referring to FIG. 19, FIG. 26, FIG. 27 and FIG. 35, the vent 30A is disposed on one of the second mounting portion 14A and the third mounting portion 15A, and the charging assembly 50A is disposed on the fourth mounting portion 16A. When the user uses the in-ear wearable device, the vent 30A is disposed corresponding to the cymba conchae 93A or the intertragic notch 92A of the user, and the charging assembly 50A is disposed corresponding to the cavum conchae 94A of the user. Thus, mutual interference between the vent 30A and the charging assembly 50A during mounting can be avoided.

It should be noted that, if the vent 30A is disposed on the fourth mounting portion 16A, the charging assembly 50A is disposed at other positions of the housing, or the in-ear wearable device does not include the charging assembly 50A.

Optionally, the vent 30A is disposed on the third mounting portion 15A, the charging assembly 50A is disposed on the fourth mounting portion 16A, and the wearing state detector 40A is disposed on the fifth mounting portion 17A. When the user uses the in-ear wearable device, the vent 30A is disposed corresponding to the cymba conchae 93A of the user. Since the cymba conchae 93A region is open, the vent 30A can be assembled and sealed easily. Since the cavum conchae 94A has a large, smooth, and regular surface relative to the surfaces of other parts of the human ear, such configuration allows the mounting of the charging assembly 50A onto the housing 1A to be less affected by the housing 1A, thereby being beneficial to ensuring the convenience and reliability of mounting of the charging assembly 50A onto the housing 1A, and effectively ensuring the comfort of wearing the in-ear wearable device. The wearing state detector 40A is disposed on the crus of helix 95A, thereby avoiding interference between the wearing state detector 40A, the vent 30A and the charging assembly 50A, and avoiding the wearing state detector 40A being affected by light, which could otherwise affect the detection result.

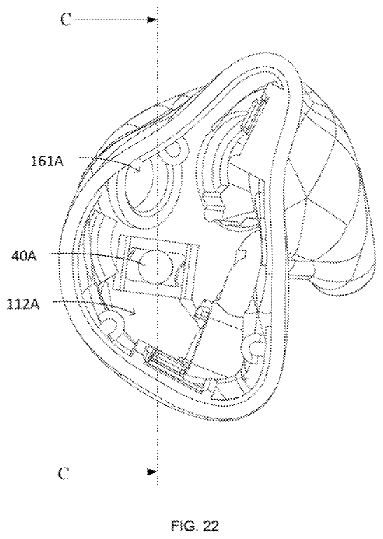

Further, referring to FIG. 19, FIG. 22 and FIG. 29, the fourth mounting portion 16A is provided with a charging port 161A, and at least a part of the charging assembly 50A is disposed in the charging port 161A. By providing the charging port 161A, the charging assembly 50A can be electrically connected to a power supply device outside the in-ear wearable device.

In one embodiment, referring to FIG. 24 and FIG. 31, the vent 30A, the wearing state detector 40A and the charging assembly 50A are all electrically connected to the main board 60A through the flexible circuit board 80A. It can be understood that the vent 30A, the wearing state detector 40A and the charging assembly 50A constitute a combined module through the flexible circuit board 80A, which is beneficial to reducing the number of connectors on the main board 60A, thereby reducing the space required for connecting the main board 60A with the three components, so that such structure can be better assembled with the in-ear wearable device with a small size.

In one embodiment, referring to FIG. 24 and FIG. 31, the flexible circuit board 80A includes a main body section 81A, a first branch section 82A, a second branch section 83A and a third branch section 84A. The main body section 81A is electrically connected to the main board 60A, and the first branch section 82A, the second branch section 83A and the third branch section 84A are all electrically connected to the main body section 81A. The vent 30A is electrically connected to the first branch section 82A, the wearing state detector 40A is electrically connected to the second branch section 83A, and the charging assembly 50A is electrically connected to the third branch section 84A. In this way, the vent 30A, the wearing state detector 40A and the charging assembly 50A can be reliably connected to the main board 60A through the flexible circuit board 80A.

Further, referring to FIG. 24 and FIG. 31, at least one of the main body section 81A, the first branch section 82A, the second branch section 83A and the third branch section 84A is provided with a bendable portion 85A. In this way, during the process of assembling the in-ear wearable device, the positions of the vent 30A, the wearing state detector 40A and the charging assembly 50A can be adjusted by bending or recovering the bendable portion 85A, so that the vent 30A, the wearing state detector 40A and the charging assembly 50A can be reliably mounted at specific positions in the accommodating cavity 11A, thereby ensuring that the vent 30A, the wearing state detector 40A and the charging assembly 50A can be quickly mounted on in-ear wearable devices of different sizes.

In one embodiment, when the flexible circuit board 80A is unfolded, the vent 30A, the wearing state detector 40A, and the charging assembly 50A are disposed on the same side of the flexible circuit board 80A. Since the flexible circuit board 80A has the characteristics of being light, thin and bendable, the configuration in which the vent 30A, the wearing state detector 40A and the charging assembly 50A are disposed on the same side of the flexible circuit board 80A can better utilize a confined space, so that the in-ear wearable device is more compact. Moreover, the assembly time can also be shortened, and the assembly efficiency is thus improved.

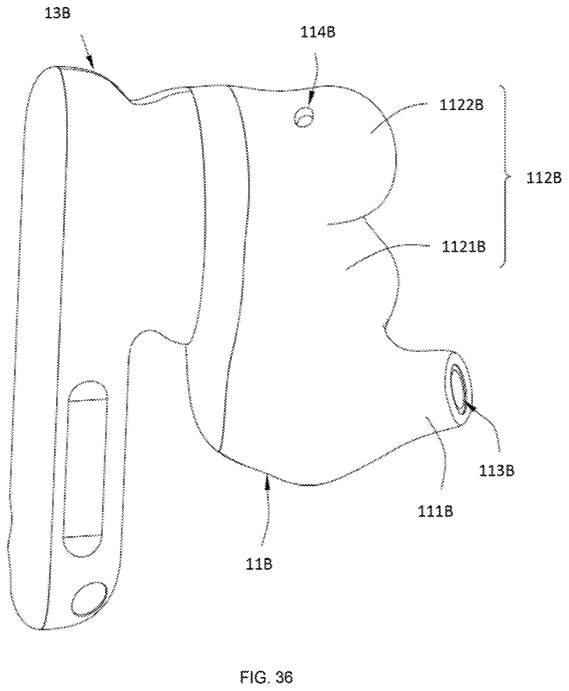

Another aspect of the disclosure will be described in detail below referring to FIGS. 36-42.

An embodiment of the present application provides an in-ear wearable device. The in-ear wearable device includes a housing and a vent. The housing is provided with an output hole and an air outlet hole, and is internally provided with a first channel and a second channel, wherein the first channel is in communication with the output hole, the second channel is in communication with the air outlet hole, at least part of the housing is configured to be inserted into an ear canal, the output hole is configured to communicate with the ear canal, and the air outlet hole is configured to communicate with an external environment. The vent is disposed inside the housing and is connected to the first channel and the second channel, and the vent is switchable between an open state and a closed state; when the vent is in the open state, the first channel is in communication with the second channel, so that the ear canal is in communication with the external environment; and when the vent is in the closed state, the first channel is isolated from the second channel, so that the ear canal is isolated from the external environment.

When the in-ear wearable device is worn, in cases where the vent is in the closed state, the first channel is isolated from the second channel, so that the effect of isolating noise in the external environment can be achieved; and when the vent is switched to the open state, the air outlet hole may communicate with the interior of the ear canal through the second channel, the vent, the first channel and the output hole in sequence. The vent is in communication with the external environment through the second channel, so that the ventilation efficiency is high, and the “occlusion effect” during wearing can be weakened or eliminated, thereby improving the comfort of wearing the in-ear wearable device for a long time.

Some embodiments of the present application are described in detail below in combination with the drawings. The following embodiments and features in the embodiments may be combined with each other without conflict.

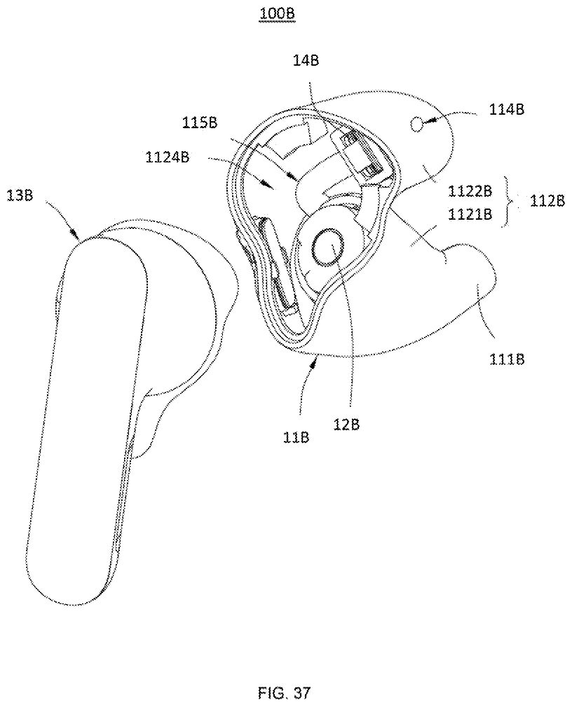

Referring to FIG. 36 and FIG. 37, an embodiment of the present application provides an in-ear wearable device 100B. The in-ear wearable device 100B includes a housing 11B and a sound-generating unit 12B.

In some embodiments, the housing 11B includes an in-ear portion 111B and a main body portion 112B, the main body portion 112B including a cavum conchae fitting portion 1121B and a cymba conchae fitting portion 1122B connected to the cavum conchae fitting portion 1121B, and at least part of the in-ear portion 111B being configured to be inserted into the ear canal, wherein at least part of the cavum conchae fitting portion 1121B is configured to be inserted into a cavum conchae, and at least part of the cymba conchae fitting portion 1122B is configured to be inserted into a cymba conchae. Optionally, the in-ear portion 111B may be customized according to the shape of the ear canal of a user, and the cavum conchae fitting portion 1121B may be customized according to the shape of the cavum conchae of the user, and the cymba conchae fitting portion 1122B may be customized according to the shape of the cymba conchae of the user. Exemplarily, the housing 11B may be made by 3D printing. In some embodiments, the in-ear portion 111B is connected to the cavum conchae fitting portion 1121B.

By providing the cymba conchae fitting portion 1122B and inserting at least part the cymba conchae fitting portion 1122B into the cymba conchae, the position and state of the in-ear portion 111B in the ear canal can be determined, so that the in-ear portion 111B is fully attached to an inner wall of the ear canal, and the cavum conchae fitting portion 1121B is fully attached to an inner wall of the cavum conchae, so that the wearing comfort can be improved, and the sealing effect of the in-ear portion 111B for the ear canal can be improved. Moreover, the cymba conchae fitting portion 1122B is inserted into the cymba conchae, so that the cymba conchae fitting portion 1122B is connected to the cymba conchae, and thus the risk of the in-ear wearable device 100B falling off can be reduced.

In some embodiments, the in-ear wearable device 100B further includes a rear cover 13B, the rear cover 13B is hollow inside, and the rear cover 13B is connected to the main body portion 112B. In some embodiments, the rear cover 13B may be stem-shaped, and exemplarily, the in-ear wearable device 100B is a stem earbud. In some other embodiments, the rear cover 13B may be plate-shaped, and exemplarily, the in-ear wearable device 100B is a bean-shaped earbud.

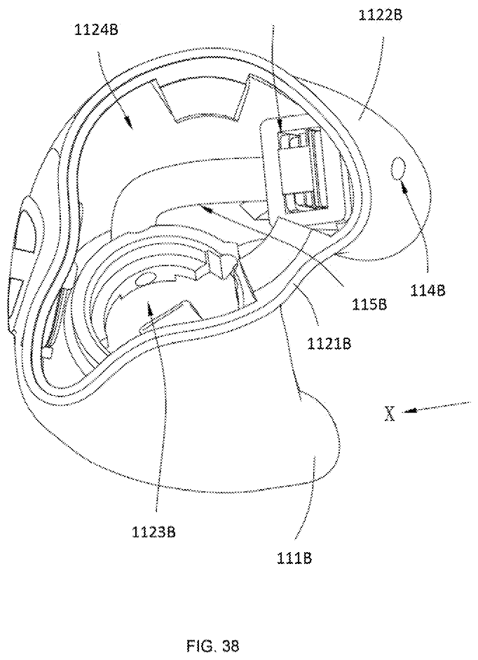

Referring to FIG. 37 and FIG. 38, exemplarily, the sound-generating unit 12B is disposed in the main body portion 112B and divides the main body portion 112B into a front cavity 1123B and a rear cavity 1124B; and optionally, the sound-generating unit 12B is a dynamic driver. In some other embodiments, the sound generating unit 12B may be a balanced armature driver, and the balanced armature driver may be disposed in the in-ear portion 111B, so that sound emitted from the balanced armature driver is transmitted into the ear canal by the in-ear portion 111B.

In some embodiments, the in-ear wearable device 100B further includes a battery (not shown) and a main circuit board (not shown); wherein one end of the battery is inserted into the main body portion 112B, the other end of the battery is inserted into the rear cover 13B, and the main circuit board is disposed in the rear cover 13B. Exemplarily, the main circuit board is electrically connected to the battery through a conductive wire or a flexible circuit board, and the sound-generating unit 12B may be electrically connected to the main circuit board through a conductive wire or a flexible circuit board, so that the battery can supply power to the sound-generating unit 12B. Optionally, the battery is a rechargeable lithium battery. Exemplarily, the in-ear wearable device 100B may be a wireless earphone or a hearing aid. In some other embodiments, the battery may be omitted, the in-ear wearable device 100B may be connected to a sound output device through a conductive wire; and exemplarily, the in-ear wearable device 100B may be a wired earphone.

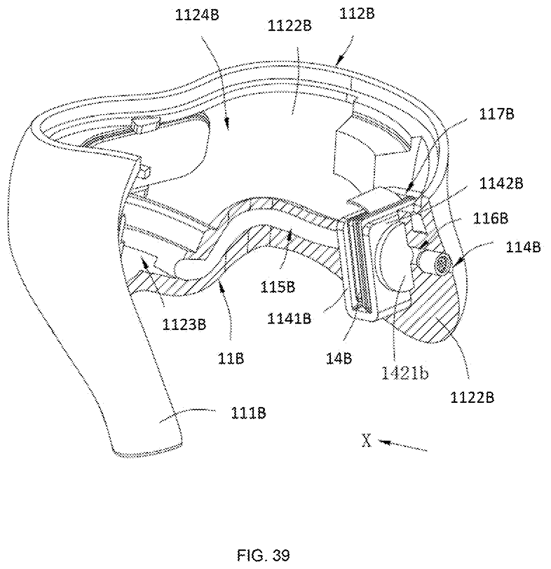

Referring to FIG. 38 and FIG. 39, in some embodiments, the housing 11B is provided with an output hole 113B (as shown in FIG. 36) and an air outlet hole 114B, and is internally provided with a first channel 115B and a second channel 116B, wherein the first channel 115B is in communication with the output hole 113B, and the second channel 116B is in communication with the air outlet hole 114B. Exemplarily, the in-ear portion 111B is provided with the output hole 113B, and the output hole 113B is in communication with the front cavity 1123B; and the first channel 115B is disposed inside the main body portion 112B and is in communication with the front cavity 1123B, so that the first channel 115B is in communication with the output hole 113B through the front cavity 1123B. An outer wall of the main body portion 112B (e.g., the cymba conchae fitting portion 1122B) is provided with the air outlet hole 114B along a first direction X, and the second channel 116B is disposed inside the main body portion 112B and is in communication with the air outlet hole 114B, so that the second channel 116B is in communication with the external environment.

The in-ear wearable device 100B further includes a vent 14B; the vent 14B is disposed inside the housing 11B and is connected to the first channel 115B and the second channel 116B. The vent 14B is switchable between an open state and a closed state; when the vent 14B is in the open state, the first channel 115B is in communication with the second channel 116B, so that the ear canal is in communication with the external environment; and when the vent 14B is in the closed state, the first channel 115B is isolated from the second channel 116B, so that the ear canal is isolated from the external environment. Exemplarily, the vent 14B is disposed inside the cymba conchae fitting portion 1122B. By using an internal space of the cymba conchae fitting portion 1122B to accommodate the vent 14B, the utilization of an internal space of the housing 11B can be increased, and the possibility of the vent 14B interfering with the mounting of other components in the housing 11B can be reduced.

When the in-ear wearable device 100B is worn, in cases where the vent 14B is in the closed state, the first channel 115B is isolated from the second channel 116B, so that the effect of isolating noise in the external environment can be achieved; and when the vent 14B is switched to the open state, the external environment may communicate with the interior of the ear canal through the air outlet hole 114B, the second channel 116B, the vent 14B, the first channel 115B and the output hole 113B in sequence. Compared with conventional technical solutions in which the vent 14B is in communication with the external environment through the rear cavity 1124B, the vent 14B is in communication with the external environment through the second channel 116B and the air outlet hole 114B in sequence, so that energy loss in an air flowing process is smaller, the air flow is smoother, the ventilation efficiency is higher, and the “occlusion effect” during wearing can be weakened or eliminated, thereby improving the comfort of wearing the in-ear wearable device 100B for a long time. In addition, when the vent 14B is in the open state, moisture and heat in the ear canal may be discharged to the external environment, thereby reducing the risk of bacteria growth in the ear canal, and further improving the comfort of wearing the in-ear wearable device 100B for a long time.

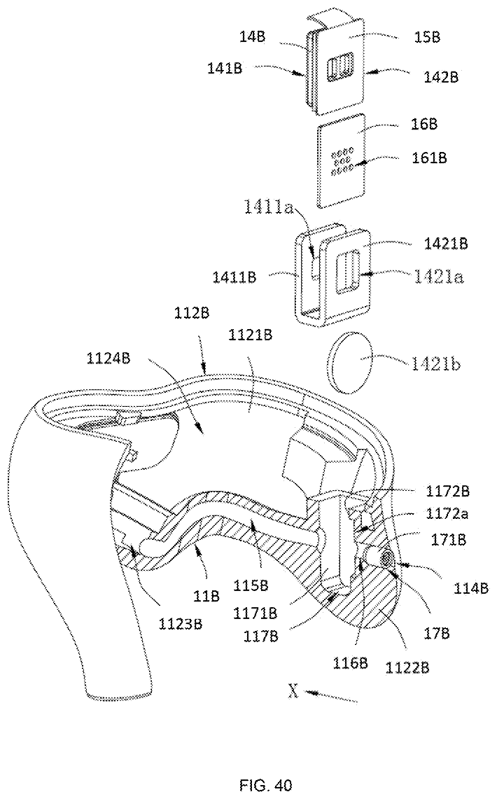

Referring to FIG. 40, in some embodiments, the vent 14B includes a first end 141B and a second end 142B, the first end 141B being disposed toward the first channel 115B, and the second end 142B being disposed toward the second channel 116B; wherein one of the first end 141B and the second end 142B is provided with a control valve (not shown), and the other of the first end 141B and the second end 142B is provided with a ventilation hole (not shown). The control valve has an open state and a closed state; when the control valve is in the open state, the first channel 115B is in communication with the second channel 116B, so that the ear canal is in communication with the external environment; and when the control valve is in the closed state, the first channel 115B is isolated from the second channel 116B, so that the ear canal is isolated from the external environment. Exemplarily, the first end 141B is provided with the ventilation hole, and the second end 142B is provided with the control valve.

In some embodiments, the in-ear wearable device 100B further includes a first flexible circuit board 15B and a reinforcement plate 16B; the vent 14B is connected to the main circuit board through the first flexible circuit board 15B, the reinforcement plate 16B is disposed on the side of the first flexible circuit board 15B facing away from the vent 14B, and the reinforcement plate 16B is provided with several vent apertures 161B allowing the airflow to flow through. It can be understood that the control valve is electrically connected to the main circuit board through the first flexible circuit board 15B. The reinforcement plate 16B covers the first flexible circuit board 15B and the ventilation hole, and the reinforcement plate 16B has a reinforcement effect on the first flexible circuit board 15B; and the vent apertures 161B of the reinforcement plate 16B can both allow the airflow to flow through, and block foreign matter, thereby reducing the risk of the vent 14B being damaged by the foreign matter.

In some embodiments, the housing 11B is internally provided with a fixing groove 117B, an inner wall of the fixing groove 117B including a first wall 1171B and a second wall 1172B, the first channel 115B extending through the first wall 1171B, and the second channel 116B extending through the second wall 1172B; wherein the vent 14B is disposed in the fixing groove 117B, the first end 141B faces the first wall 1171B, and the second end 142B faces the second wall 1172B. Exemplarily, the fixing groove 117B is disposed in the cymba conchae fitting portion 1122B.

In some embodiments, the first end 141B and the second end 142B are respectively disposed on two opposite sides of the vent 14B, and the first wall 1171B and the second wall 1172B are respectively two oppositely disposed inner walls of the fixing groove 117B. In some other embodiments, the first end 141B and the second end 142B may be disposed on two adjacent sides of the vent 14B, and correspondingly, the first wall 1171B and the second wall 1172B are respectively two adjacent inner walls of the fixing groove 117B. The fixing groove 117B has a constraint effect on the vent 14B, and thus can improve the stability of fixing the vent 14B.

Referring to FIG. 39 and FIG. 40, in some embodiments, a first sealing member 1411B is disposed between the first end 141B and the first wall 1171B, and a second sealing member 1421B is disposed between the second end 142B and the second wall 1172B. The first sealing member 1411B is configured to seal a gap between the first end 141B and the first wall 1171B, and the second sealing member 1421B is configured to seal a gap between the second end 142B and the second wall 1172B, so that the air tightness of connection between the first channel 115B and the first end 141B and connection between the second channel 116B and the second end 142B can be improved.

In some embodiments, the first sealing member 1411B and the second sealing member 1421B are both made of sealing foam, and the sealing foam has elasticity. Optionally, the first sealing member 1411B and the second sealing member 1421B are connected to each other and are in a “U” shape, so as to facilitate the mounting of the vent 14B. Exemplarily, when the vent 14B is mounted, the vent 14B is disposed between the first sealing member 1411B and the second sealing member 1421B, and then the vent 14B is pressed into the fixing groove 117B, so that both the first sealing member 1411B and the second sealing member 1421B generate elastic deformation, and thus both the first sealing member 1411B and the second sealing member 1421B elastically abut against the vent 14B, thus the vent 14B can be kept fixed relative to the inner wall of the fixing groove 117B, so as to improve the stability of keeping the vent 14B fixed, thereby reducing the risk of the vent 14B being disengaged from the fixing groove 117B. In some other embodiments, the first sealing member 1411B and/or the second sealing member 1421B may be made of a rubber material or a silica gel material.

In some embodiments, the first sealing member 1411B is provided with a first through hole 1411a, the first through hole 1411a being in communication with the first channel 115B; the second sealing member 1421B is provided with a second through hole 1421a, the second through hole 1421a being in communication with the second channel 116B; wherein when the vent 14B is in the open state, the first through hole 1411a is in communication with the second through hole 1421a; and when the vent 14B is in the closed state, the first through hole 1411 a is isolated from the second through hole 1421a. By providing the first through hole 1411a and the second through hole 1421a, the obstruction to the airflow by the first sealing member 1411B or the second sealing member 1421B can be reduced, so as not to affect the ventilation efficiency between the ear canal and the external environment.

In some embodiments, the housing 11B is provided with a fixing member (not shown), the fixing member being connected to the vent 14B and the housing 11B. Exemplarily, the fixing member is a hot melt adhesive, the hot melt adhesive blocking the opening of the fixing groove 117B and bonding and fixing the vent 14B to the housing 11B. The fixing member may further improve the stability of keeping the vent 14B fixed, so as to further reduce the risk of the vent 14B being disengaged from the fixing groove 117B. In some other embodiments, the fixing member may be a screw or other structural members capable of fixing the vent 14B.

In some embodiments, a protective mesh 1421b is disposed between the first end 141B and the first channel 115B and/or between the second end 142B and the second channel 116B. The protective mesh 1421b disposed between the first end 141B and the first channel 115B may block impurities such as dust from entering the first channel 115B, thereby reducing the risk of the impurities such as dust entering the ear canal and polluting the ear canal; and the protective mesh 1421b disposed between the second end 142B and the second channel 116B can block dust, sweat and the like from entering the second end 142B, thereby reducing the risk of the vent 14B being damaged by the impurities such as dust and sweat. Exemplarily, the protective mesh 1421b may be disposed between the first end 141B and the first wall 1171B, and/or, the protective mesh 1421b may be disposed between the second end 142B and the second wall 1172B.

In some embodiments, the first wall 1171B or the second wall 1172B is provided with an embedding groove 1172a, the protective mesh 1421b being embedded into the embedding groove 1172a. The embedding groove 1172a may locate and constrain the position of the protective mesh 1421b, so that the protective mesh 1421b is kept aligned with the corresponding first end 141B or the second end 142B, thereby improving the protective effect of the protective mesh 1421b.

Take the protective mesh 1421b disposed between the second end 142B and the second channel 116B as an example, the second wall 1172B is recessed to form the embedding groove 1172a, and the embedding groove 1172a is in communication with the second channel 116B; and the protective mesh 1421b is embedded into the embedding groove 1172a and blocks the second channel 116B. Optionally, the second sealing member 1421B abuts against the side of the protective mesh 1421b facing away from the second channel 116B, so as to fix the protective mesh 1421b in the embedding groove 1172a.

In some other embodiments, the fixing groove 117B may be omitted, the vent 14B may be fixed in the main body portion 112B by glue or in other methods, as long as the first end 141B of the vent 14B can be connected to the first channel 115B, and the second end 142B of the vent 14B can be connected to the second channel 116B.

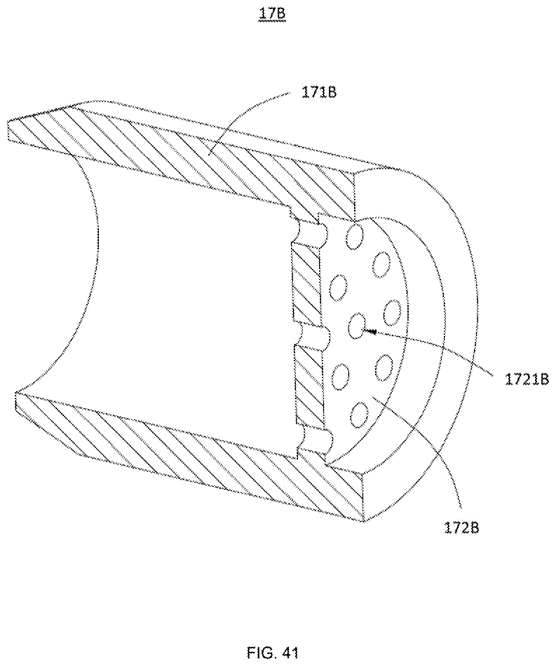

Referring to FIG. 40 and FIG. 41, in some embodiments, the second channel 116B is in the shape of a through hole extending along the first direction X. The extension direction of the second channel 116B is the same as the extension direction of the air outlet hole 114B, so that the smoothness of the air flowing in the second channel 116B and the air outlet hole 114B can be improved, thereby increasing the ventilation efficiency between the vent 14B and the external environment, so as to achieve the effect of weakening the “occlusion effect”.

In some embodiments, the in-ear wearable device 100B further includes a damper 17B, the damper 17B including a mounting portion 171B and a damping portion 172B connected to the mounting portion 171B, the damping portion 172B being provided with several vent holes 1721B; wherein the mounting portion 171B is at least partially inserted into the air outlet hole 14B, and the vent holes 1721B are in communication with both the air outlet hole 114B and the second channel 116B. By inserting at least part of the mounting portion 171B into the air outlet hole 114B, the damper 17B is detachably mounted in the housing 11B to adjust the ventilation volume of the second channel 116B; and the size or number of the vent holes 1721B corresponds to different damping coefficients, and different damping coefficients correspond to different ventilation volumes. The user may mount or replace dampers 17B of different damping coefficients as needed to adjust the ventilation volume of the second channel 116B, so as to adapt to different application scenarios.

It can be understood that in cases where the number of the vent holes 1721B is the same, the greater the cross-sectional areas of the vent holes 1721B are, the smaller the damping coefficient of the damper 17B is, and the greater the ventilation volume is; and in cases where the cross-sectional areas of the vent holes 1721B are the same, the greater the number of the vent holes 1721B is, the smaller the damping coefficient of the damper 17B is, and the smaller the ventilation volume is. In some embodiments, the material of the mounting portion 171B may be metal, which is not easily damaged. In some other embodiments, the material of the mounting portion 171B may also be one of rubber, silica gel and plastic, so that an outer wall of the mounting portion 171B abuts against an inner wall of the air outlet hole 114B through the elasticity of the mounting portion 171B itself, so as to improve the stability of fixing the mounting portion 171B.

Exemplarily, the mounting portion 171B is tubular, the damping portion 172B is plate-shaped, and the damping portion 172B is disposed at one end of the mounting portion 171B. When the damper 17B is mounted, the mounting portion 171B may be inserted into the air outlet hole 114B from the outside of the end of the air outlet hole 114B away from the second channel 116B, so that an outer peripheral wall of the mounting portion 171B is attached to an inner peripheral wall of the air outlet hole 114B, and thus the mounting portion 171B is connected to the housing 11B, thereby achieving a simple structure and convenient operation.

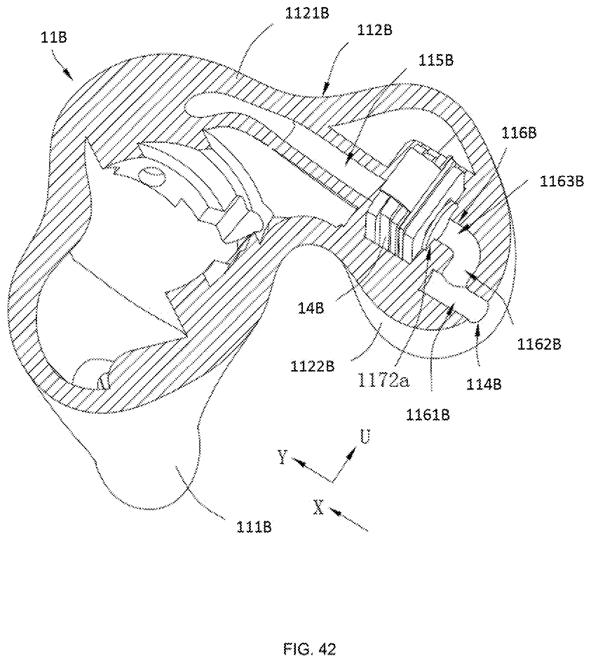

Referring to FIG. 42, in some embodiments, the second channel 116B includes a first extension portion 1161B extending along a second direction Y and a second extension portion 1162B extending along a third direction U, the second direction Y intersecting with the third direction U. The first extension portion 1161B is in communication with the second extension portion 1162B, the first extension portion 1161B is in communication with the air outlet hole 114B, and the second extension portion 1162B is connected to the vent 14B. Optionally, the second direction Y is parallel to the first direction X, so that the first extension portion 1161B is in communication with the external environment by the air outlet hole 114B along the second direction Y.

Since the second direction Y intersects with the third direction U, the first extension portion 1161B is inclined relative to the second extension portion 1162B. When foreign matter enters the first extension portion 1161B, a bottom wall of the first extension portion 1161B or an inner wall of the second extension portion 1162B may block the foreign matter, thereby reducing the risk of the vent 14B being damaged by contact between the foreign matter and the vent 14B. Optionally, the second direction Y is perpendicular to the third direction U.

In some embodiments, the second channel 116B further includes a third extension portion 1163B, the third extension portion 1163B extending along the second direction Y, wherein one end of the third extension portion 1163B is connected to the second extension portion 1162B, and the other end thereof is connected to the vent 14B. It can be understood that the second extension portion 1162B is connected to the vent 14B through the third extension portion 1163B. In some other embodiments, the third extension portion 1163B may be omitted, and the second extension portion 1162B may extend directly to the embedding groove 1172a to be connected to the vent 14B.

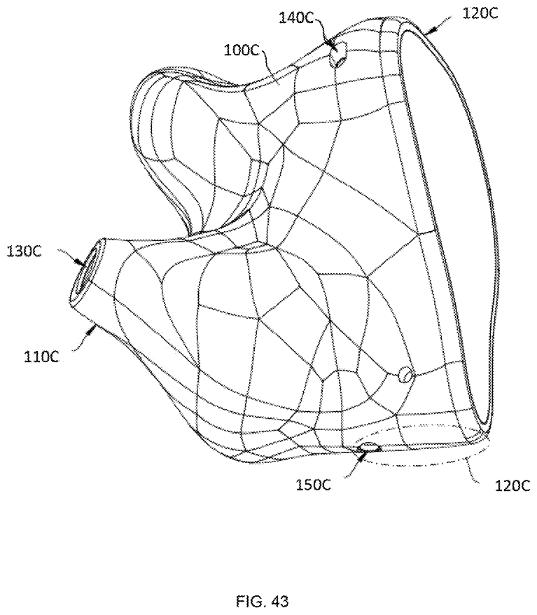

Another aspect of the disclosure will be described in detail below referring to FIGS. 43-49.

Referring to FIG. 43, an embodiment of the present application provides an in-ear wearable device 001C. The device may be worn on the ear of a user, and is especially suitable to be placed in the ear canal to realize various functions, for example, audio playback, sound acquisition, and health status monitoring. The ear canal in the present application may only include the external auditory meatus, and may also include both the external auditory meatus and at least a part of the internal auditory meatus.

For ease of description, a detailed description will be given below in combination with specific structures and working principles of an in-ear earphone. However, it should be understood that the in-ear wearable device 001C involved in the present application is not limited to an in-ear headphone, and may also be implemented as a hearing aid or other wearable devices having audio output functions, and the specific types are not limited.

In addition, in addition to an audio reproduction function, the device may additionally or alternatively integrates one or more functions such as sound reception, body temperature measurement, blood pressure monitoring, heart rate measurement, blood glucose measurement and blood oxygen measurement. In some other embodiments, the in-ear wearable device 001C may not have an audio reproduction function, and is configured only to execute sensing or monitoring tasks of other types.

In some embodiments of the present application, in order to simplify the illustration and description, only one headphone, for example, a left headphone, is exemplarily shown in the drawings. However, it should be understood by those skilled in the art that a complete headphone device generally includes a left headphone and a right headphone which are substantially bilaterally symmetrical in structure. Thus, the headphone on the other side, for example, a right headphone, which is not specifically shown in the drawings may be derived based on the structural symmetry of the described headphone. Although the following relevant description only aims at the illustrated earphone, the technical solutions thereof are also applicable to the earphone on the other side.

In some embodiments, the in-ear wearable device 001C includes a housing 100C including an in-ear portion 110C and a main body portion 120C, the in-ear portion 110C is configured to, when in use, be at least partially inserted into an ear canal, the main body portion 120C includes an intertragic notch fitting portion 121C, and the intertragic notch fitting portion 121C in a worn state is located in an intertragic notch of a user.

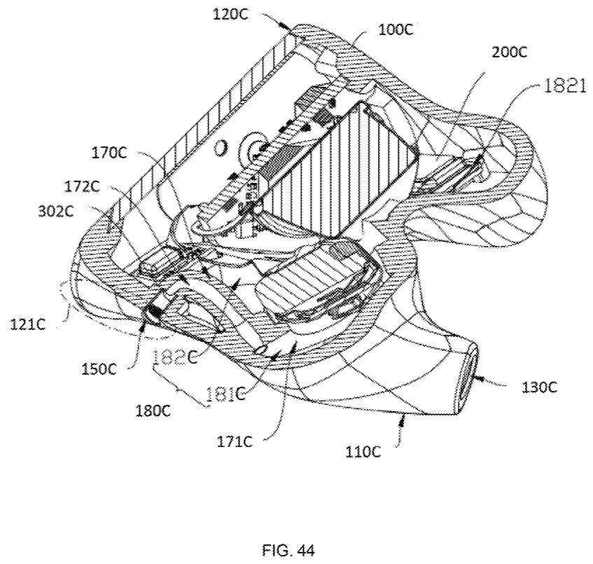

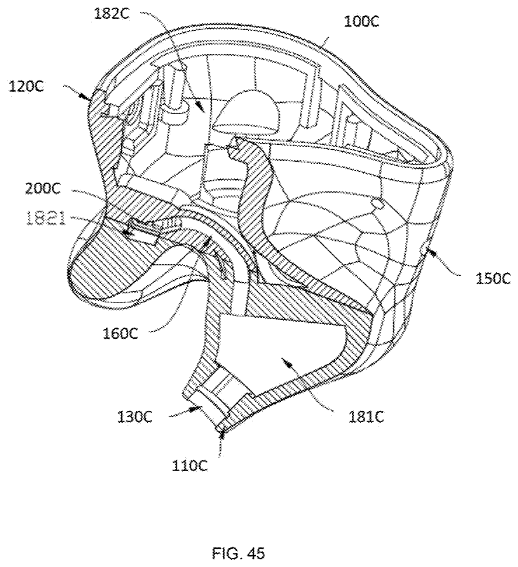

With reference to FIG. 44 and FIG. 45 and in combination with FIG. 43, in some embodiments, the in-ear wearable device 001C includes a first valve member 200C and a second valve member 302C, and both the first valve member 200C and the second valve member 302C are at least partially located in the housing 100C. The housing 100C is provided with a first air outlet hole 130C, a second air outlet hole (not shown), a first ventilation hole 140C and a second ventilation hole 150C, the first air outlet hole 130C and the second air outlet hole are both configured to communicate with the ear canal, and the first ventilation hole 140C and the second ventilation hole 150C are both configured to communicate with the external environment.

The housing 100C is internally provided with a first channel 160C and a second channel 170C, the first valve member 200C is connected to the first channel 160C, and the first valve member 200C is configured to adjust the ventilation state of the first channel 160C such that the first air outlet hole 130C communicates with or is isolated from the first ventilation hole 140C. The second valve member 302C is connected to the second channel 170C, and the second valve member 302C is configured to adjust the ventilation state of the second channel 170C such that the second air outlet hole communicates with or is isolated from the second ventilation hole 150C.

By providing the first channel 160C and the second channel 170C in the housing 100C and controlling opening or closing of the first channel 160C and the second channel 170C through the corresponding first valve member 200C and second valve member 302C, the ear canal can communicate with the external environment through the first channel 160C alone, and can also communicate with the external environment through the second channel 170C alone.

When the user requires a large ventilation volume, the first valve member 200C and the second valve member 302C permit the ear canal to communicate with the external environment through both the first channel 160C and the second channel 170C, thereby reducing or eliminating the occlusion effect and improving the ventilation performance within the confined space of the housing 100C.

When the user requires sound insulation or high-quality audio listening, the first valve member 200C and the second valve member 302C restrict communication between the ear canal and the external environment through both the first channel 160C and the second channel 170C, thereby reducing ambient sound interference or audio leakage.

In some embodiments, the first valve member 200C is configured as a manual vent valve.

In some embodiments, the first valve member 200C is configured as an electronic vent valve.

In some embodiments, the second valve member 302C is configured as a manual vent valve.

In some embodiments, the second valve member 302C is configured as an electronic vent valve.

The manual vent valve is a mechanical ventilation structure actively triggered by the user, and is opened or closed by a manual operation; and the electronic vent valve is an automatic ventilation structure controlled by an electric drive assembly, and is opened or closed by an electrical signal sent by a processor.

In some embodiments, the first channel 160C includes a first front ventilation section 161C and a first rear ventilation section 162C, the first front ventilation section 161C is in communication with the first air outlet hole 130C, and the first rear ventilation section 162C is in communication with the first ventilation hole 140C. When the first valve member 200C is in an open state, airflow in the ear canal flows to the external environment through the first air outlet hole 130C, the first front ventilation section 161C, the first rear ventilation section 162C and the first ventilation hole 140C, thereby reducing the occlusion effect and improving the wearing comfort.

In some embodiments, the second channel 170C includes a second front ventilation section 171C and a second rear ventilation section 172C, the second front ventilation section 171C is in communication with the second air outlet hole, the second rear ventilation section 172C is in communication with the second ventilation hole 150C. When the second valve member 302C is in an open state, airflow in the ear canal flows to the external environment through the second air outlet hole, the second front ventilation section 171C, the second rear ventilation section 172C and the second ventilation hole 150C, thereby reducing the occlusion effect and improving the wearing comfort.

Referring to FIG. 44 and FIG. 45, in some embodiments, an accommodating cavity 180C is formed in the housing 100C. It should be noted that the first channel 160C and the second channel 170C may be two independent channels disposed in the accommodating cavity 180C and may also be hole structures formed within a wall of the housing 100C; the hole structures may be integrally formed with the main body of the housing 100C by means of additive manufacturing technology (for example, 3D printing), that is, the holes are directly formed in the dense material of the housing 100C in a manufacturing process. The first channel 160C and the second channel 170C may each comprise a portion disposed in the accommodating cavity 180C and another portion disposed within the wall of the housing 100C; alternatively, the first channel 160C and the second channel 170C may be entirely disposed in the accommodating cavity 180C and at least partially overlap, for example, they are configured in a Y-shape or an inverted Y-shape, or share a front cavity or a rear cavity.

In some optional embodiments, the housing 100C, the first channel 160C, the second channel 170C, the first air outlet hole 130C, the second air outlet hole, the first ventilation hole 140C, and the second ventilation hole 150C are integrally manufactured using 3D printing technology, so that the production process can be simplified, and the manufacturing cost can be reduced.

In some embodiments, the housing 100C is a customized housing 100C. It should be noted herein that, “customization” in the present application refers to performing personalized design and manufacturing according to ear structures of different users, instead of using unified specifications for production.

Specifically, to mold the customized housing 100C, individualized ear mold data may be acquired by modelling or scanning the ear of the user, and molding of the housing 100C is completed using a special manufacturing device based on the data.

The dimension configuration of the customized housing 100C may be substantially consistent with the dimensions of the obtained ear mold and may also be slightly smaller than the dimensions of the ear mold, so as to improve the user experience of users who are more sensitive to wearing comfort. It should be understood that, in some other embodiments, the housing 100C may also be a non-customized structure, and the specific type of the housing 100C is not limited in the present application.

In some embodiments, the in-ear wearable device 001C may further integrate functional components such as a main board, a manipulation apparatus, a charging apparatus, a battery, an antenna apparatus, a magnetic attraction unit, a sound pickup apparatus, a speaker unit, a moving coil unit and a wireless communication module. The components may be integrated in structure in one or more assembly modes, such as bolted connection, welding, adhesive fixation or snap fit, and are rationally arranged in an accommodating space of the housing 100C, so as to take into account structural compactness and functional integrity.

In some embodiments, the accommodating cavity 180C is divided into a front cavity 181C and a rear cavity 182C by a moving coil unit.

In some embodiments, the front cavity 181C may be in communication with the ear canal by means of the first air outlet hole 130C, the front cavity 181C may also be in communication with the ear canal by means of the second air outlet hole, the rear cavity 182C may be in communication with the external environment by means of the first ventilation hole 140C, and the rear cavity 182C may also be in communication with the external environment by means of the second ventilation hole 150C.

In some embodiments, the first front ventilation section 161C and the front cavity 181C are two mutually independent spaces.

In some embodiments, the first front ventilation section 161C includes the front cavity 181C.

In some embodiments, the first rear ventilation section 162C and the rear cavity 182C are two mutually independent spaces.

In some embodiments, the first rear ventilation section 162C includes the rear cavity 182C.

In some embodiments, the second front ventilation section 171C and the front cavity 181C are two mutually independent spaces.

In some embodiments, the second front ventilation section 171C includes the front cavity 181C.

In some embodiments, the second rear ventilation section 172C and the rear cavity 182C are two mutually independent spaces.

In some embodiments, the second rear ventilation section 172C includes the rear cavity 182C.

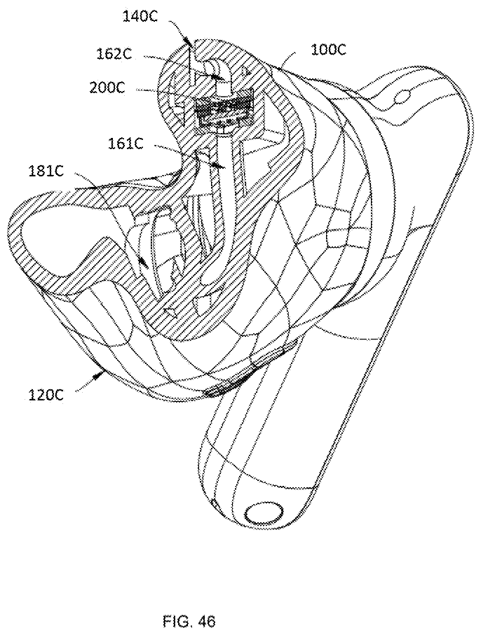

Referring to FIG. 45 and FIG. 46, the first front ventilation section 161C further includes the front cavity 181C, the second front ventilation section 171C also includes the front cavity 181C, the first air outlet hole 130C and the second air outlet hole are the same air outlet hole, the first front ventilation section 161C is in communication with the first air outlet hole 130C, and the second front ventilation section 171C is also in communication with the first air outlet hole 130C.

Referring to FIG. 45, the first rear ventilation section includes the rear cavity 182C, and the rear cavity 182C is in communication with the first ventilation hole 140C. Referring to FIG. 46, in some embodiments, an inner side wall of the rear cavity 182C is provided with a fixing groove 1821, the first front ventilation section 161C extends into the fixing groove 1821, and the first valve member 200C is disposed in the fixing groove 1821.

In some embodiments, an inner side wall of the rear cavity 182C is provided with a fixing groove 1821, the first rear ventilation section 162C extends into the fixing groove 1821, and the first valve member 200C is disposed in the fixing groove 1821.

In some embodiments, the first front ventilation section 161C and the second front ventilation section 171C are the same front ventilation section, and the first air outlet hole 130C and the second air outlet hole are the same air outlet hole. Exemplarily, the first channel 160C and the second channel 170C are configured in a Y-shape.

In some embodiments, the first rear ventilation section 162C and the second rear ventilation section 172C are the same rear ventilation section, and the first ventilation hole 140C and the second ventilation hole 150C are the same ventilation hole. Exemplarily, the first channel 160C and the second channel 170C are configured in an inverted Y-shape.

In some embodiments, the first ventilation hole 140 and the second ventilation hole 150C are the same ventilation hole.

In some embodiments, the first air outlet hole 130C and the second air outlet are the same air outlet hole.

In some embodiments, the first ventilation hole 140C and the second ventilation hole 150C are different ventilation holes.

In some embodiments, the first air outlet hole 130C and the second air outlet are different air outlet holes.

In some embodiments, the second valve member 302C is replaceable. The second valve member 302C may be categorized into a low-resistance damper, a medium-resistance damper and a high-resistance damper according to function. The low-resistance damper has a large ventilation volume and is suitable for usage scenarios involving prolonged wearing or high-frequency voice calls, thereby significantly alleviating the occlusion effect caused by closing of the ear canal. The high-resistance damper effectively restricts airflow while maintaining an appropriate degree of acoustic leakage, thereby enabling fine adjustment of low-frequency response of the headphone to meet personalized requirements of the user for timbre. The medium-resistance damper provides a balance between ventilation volume and airflow restriction, thereby providing a more balanced acoustic performance. According to actual usage scenarios or personal listening preferences, the user can selectively install second valve bodies 302C with different damping coefficients on the housing 100C, thereby enabling flexible adjustment of the acoustic characteristics.

In some embodiments, the second valve member 302C is replaceable. The opening or closing of the second channel 170C is achieved by changing the second valve member 130C.

In some embodiments, in a worn state, the second ventilation hole 150C is located in the intertragic notch. Owning to the physiological characteristics of this region, which is relatively concealed and less likely covered, communication between the second channel 170C and the external environment can be maintained, thereby mitigating degradation of the ventilation performance caused by covering by external objects.

In some embodiments, the second valve member 302C is at least partially disposed in the second ventilation hole 150C.

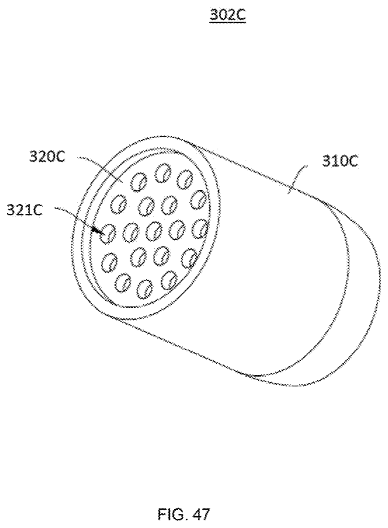

Referring to FIG. 44 and FIG. 47, in some embodiments, the second valve member 302C includes a tube body 310C and a protective member 320C, the tube body 310C is disposed at least in the second ventilation hole 150C, the protective member 320C is disposed at one end of the tube body 310C and is in communication with the second channel 170C, the protective member 320C is provided with a plurality of through holes 321C that are spaced apart from each other, and the through holes 321C provide communication between the second ventilation hole 150C and the second channel 170C.

In some embodiments, the tube body 310C is in interference fit with the second ventilation hole 150C to securely hold the second valve member 302C, thereby quickly installing and fixing the second valve member 302C without the need for additional fasteners, thus simplifying the assembly process, and being beneficial to ensuring the position stability of the damper at work.

In some embodiments, an outer peripheral wall of the tube body 310C is in threaded fit with an inner peripheral wall of the second ventilation hole 150C, thereby reliably fixing the second valve member 302C, and also enabling fine adjustment of the mounting depth of the second valve member 302C; moreover, a rotation operation itself may be used to adjust the alignment of the through holes 321C, thereby unifying adjustment and fixing.

In some embodiments, the diameter of the second ventilation hole 150C is greater than the width at a joint between the second channel 170C and the second ventilation hole 150C, so as to limit movement of the tube body 310C, thereby solving the problem of the tube body 310C being excessively pressed into the second ventilation hole 150C, ensuring that the through holes 321C are at predetermined adjustment positions, and ensuring the effectiveness of a ventilation function.

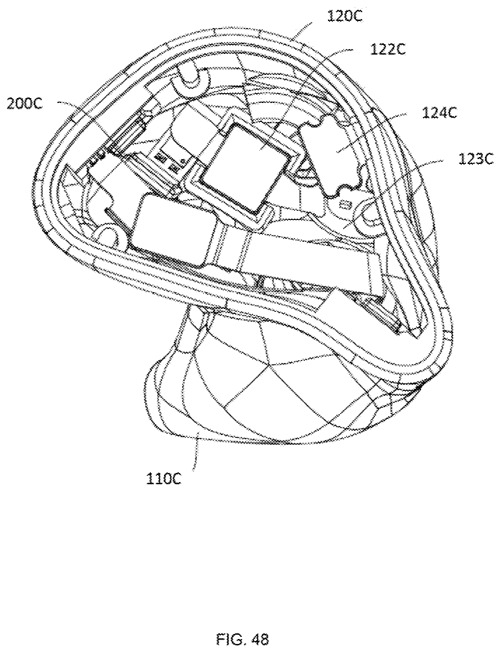

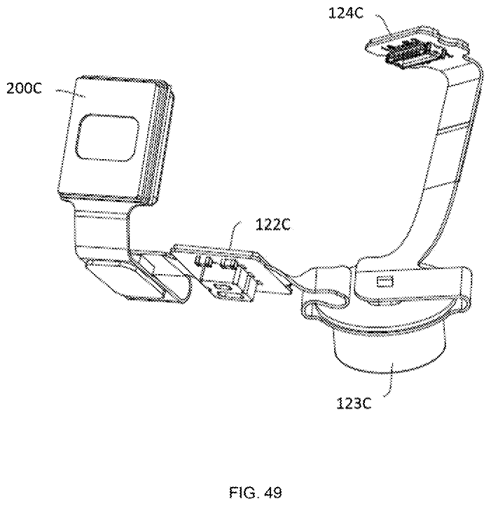

Referring to FIG. 48 and FIG. 49, in some embodiments, an optical wearing state detection unit 122C is disposed in the housing 100C, so that the in-ear wearable device 001C can sense the wearing state.

In some embodiments, a charging assembly 123C is disposed in the housing 100C, and the charging assembly 123C passes through the housing 100C and is used for docking with an adapted power supply assembly. In the present embodiment, the power supply assembly is a charging case, the charging case is provided with a receiving cavity, an inner wall of the receiving cavity is provided with charging contacts, and the charging contacts are used for docking with the charging assembly 123C when the in-ear wearable device 001C is accommodated, thereby charging the in-ear wearable device 001C.

In some embodiments, a connector 124C is disposed in the housing 100C, a flexible circuit board is connected to the main board of the in-ear wearable device 001C via a cable insertion end of the connector 124C, and the flexible circuit board is connected to the electronic vent valves, the optical wearing state detection unit 122C and the charging assembly 123C.

In the description of the present application, it should be understood that, if these terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential”, and the like appear, orientation or position relationships indicated by these terms are orientation or position relationships shown based on the drawings, and are only for the convenience of describing the present application and simplifying the description, rather than indicating or implying that apparatuses or elements referred to must have specific orientations or must be constructed and operated at specific orientations, and thus cannot be understood as limitations to the present application.

In addition, if these terms “first” and “second” appear, these terms are only used for descriptive purposes, and cannot be understood as indicating or implying relative importance or implicitly indicating the number of indicated technical features. Thus, features defined with “first” and “second” may explicitly or implicitly include at least one of the features. In the description of the present application, if the term “a plurality of” appears, “a plurality of” means at least two, for example, two, three, and the like, unless otherwise specifically defined.

In the present application, unless otherwise specifically specified and defined, if the terms “mounted”, “connected”, “connection”, “fixed” and the like appear, these terms should be understood in a broad sense. For example, the connection may be a fixed connection, and may also be a detachable connection, or an integral connection; may be a mechanical connection, and may also be an electrical connection; and may be a direct connection, may be an indirect connection through an intermediate medium, and may also be internal communication between two elements or an interaction relationship between two elements, unless otherwise explicitly defined. For those of ordinary skill in the art, the specific meanings of the terms hereinabove in the present application may be understood in specific situations.

In the present application, unless otherwise specifically specified and defined, if the description of a first feature being “above” or “below” a second feature appears, the meaning thereof may be that the first feature is in direct contact with the second feature, or the first feature is in indirect contact with the second feature through an intermediate medium. Moreover, the first feature being “over”, “above” and “on” the second feature may be that the first feature is directly above and obliquely above the second feature, or merely indicates that a horizontal height of the first feature is greater than that of the second feature. The first feature being “under”, “below” and “beneath” the second feature may be that the first feature is directly below and obliquely below the second feature, or merely indicates that the horizontal height of the first feature is less than that of the second feature.

It should be noted that if one element is referred to as being “fixed to” or “disposed on” another element, it may be directly on the other element or an intervening element may also be present. If one element is considered to be “connected” with another element, it may be directly connected to the other element or an intervening element may also be present. If there is an intervening element, the terms “vertical”, “horizontal”, “upper”, “lower”, “left”, “right” and similar expressions used in the present application are for illustrative purposes only and do not represent only implementations.

The technical features of the embodiments hereinabove may be combined arbitrarily. In order to make the description concise, not all possible combinations of the technical features in the embodiments hereinabove are described. However, as long as there is no contradiction in the combinations of these technical features, these combinations should be considered as the scope disclosed in the present description.

Although the disclosure has been described with reference to the exemplary embodiments, it shall be appreciated that the disclosure is not limited to the configurations and methods of the above embodiments. On the contrary, the disclosure is intended to cover various modifications and equivalent arrangements. In addition, although various elements and methodical steps of the disclosed invention are illustrated in various exemplary combinations and configurations, other combinations including more or less elements or methods shall also fall within the scope of the disclosure.

1. An in-ear wearable device, comprising:
a housing, the housing comprising a first mounting portion, a second mounting portion, a third mounting portion and a fourth mounting portion, wherein when a user is wearing the in-ear wearable device, the first mounting portion is disposed corresponding to an ear canal of the user, the second mounting portion is disposed corresponding to an intertragic notch of the user, the third mounting portion is disposed corresponding to a cymba conchae of the user, and the fourth mounting portion is disposed corresponding to a cavum conchae of the user, and the housing being provided with an accommodating cavity;
a first speaker disposed in the accommodating cavity, the first speaker being close to the first mounting portion; and
a vent disposed in the accommodating cavity, the vent being disposed on one of the second mounting portion, the third mounting portion and the fourth mounting portion, and being configured to permit or restrict communication between the ear canal of the user and the external environment.

2. The in-ear wearable device according to claim 1, wherein one of the second mounting portion, the third mounting portion and the fourth mounting portion is provided with an accommodating recess, and at least a part of the vent is disposed in the accommodating recess.

3. The in-ear wearable device according to claim 1, wherein the first speaker divides the accommodating cavity into a front cavity and a rear cavity; the in-ear wearable device further comprises a ventilation channel, and the vent is configured to permit or restrict communication between the front cavity and the rear cavity through the ventilation channel.

4. The in-ear wearable device according to claim 3, wherein the ventilation channel is formed in a side wall of the housing; or the ventilation channel and the housing are independent of each other.

5. The in-ear wearable device according to claim 3, wherein the vent is disposed in the rear cavity, a wall of the rear cavity is provided with an accommodating recess, and a wall of the accommodating recess is provided with a communication hole; and
the ventilation channel has a first end disposed in the front cavity and a second end disposed in the rear cavity, the first end is provided with a first ventilation hole, the first ventilation hole being in communication with the front cavity, and the second end is provided with a second ventilation hole, the second ventilation hole being in communication with the communication hole.

6. The in-ear wearable device according to claim 5, wherein the vent is provided with an air outlet hole that is in communication with the second ventilation hole through the communication hole.

7. The in-ear wearable device according to claim 3, wherein a wall of the rear cavity is provided with an air release hole, the vent is provided with a valve and an air outlet hole that is in communication with the front cavity through the ventilation channel, and the valve is configured to open to allow the air outlet hole to communicate with the external environment through the air release hole.

8. The in-ear wearable device according to claim 3, wherein the in-ear wearable device further comprises a main board and a flexible circuit board, both of which are disposed in the accommodating cavity, and the vent is electrically connected to the main board through the flexible circuit board.

9. The in-ear wearable device according to claim 8, wherein the vent is provided with an air outlet hole, and the flexible circuit board is provided with a through hole that is in communication with the air outlet hole and the ventilation channel.

10. The in-ear wearable device according to claim 9, wherein the housing is provided with an accommodating recess, at least a part of the vent is disposed in the accommodating recess, and a wall of the accommodating recess is provided with a communication hole; and
at least a part of the flexible circuit board is disposed between the wall of the accommodating recess and the vent, and the air outlet hole is in communication with the ventilation channel via the through hole and the communication hole.

11. The in-ear wearable device according to claim 3, wherein the in-ear wearable device further comprises a protective member which is disposed on the vent and configured to prevent impurities from entering the vent from the rear cavity.

12. The in-ear wearable device according to claim 1, wherein the in-ear wearable device further comprises a main board, the vent is electrically connected to the main board, and an extension direction of the vent intersects with an extension direction of the main board.

13. The in-ear wearable device according to claim 1, wherein the first speaker is a moving coil unit.

14. The in-ear wearable device according to claim 1, wherein the in-ear wearable device further comprises a wearing state detector for detecting whether the user is wearing the in-ear wearable device;
the housing further comprises a fifth mounting portion, wherein when the user is wearing the in-ear wearable device, the fifth mounting portion is disposed corresponding to a crus of helix of the user; and
the vent is disposed on the second mounting portion, and the wearing state detector is disposed on one of the third mounting portion, the fourth mounting portion and the fifth mounting portion; or the vent is disposed on the third mounting portion, and the wearing state detector is disposed on one of the second mounting portion, the fourth mounting portion and the fifth mounting portion; or the vent is disposed on the fourth mounting portion, and the wearing state detector is disposed on one of the second mounting portion, the third mounting portion and the fifth mounting portion.

15. The in-ear wearable device according to claim 1, wherein the in-ear wearable device further comprises a charging assembly that is disposed in the accommodating cavity; and
the vent is disposed on one of the second mounting portion and the third mounting portion, and the charging assembly is disposed on the fourth mounting portion.

16. The in-ear wearable device according to claim 15, wherein the in-ear wearable device further comprises a wearing state detector for detecting whether the user is wearing the in-ear wearable device;
the housing further comprises a fifth mounting portion, wherein when the user is wearing the in-ear wearable device, the fifth mounting portion is disposed corresponding to a crus of helix of the user; and
the vent is disposed on the third mounting portion, the charging assembly is disposed on the fourth mounting portion, and the wearing state detector is disposed on the fifth mounting portion.

17. The in-ear wearable device according to claim 1, wherein the in-ear wearable device further comprises a wearing state detector, a charging assembly, a main board and a flexible circuit board, the wearing state detector, the charging assembly, the main board and the flexible circuit board are all disposed in the accommodating cavity, and the vent, the wearing state detector and the charging assembly are electrically connected to the main board through the flexible circuit board.

18. The in-ear wearable device according to claim 17, wherein the flexible circuit board is provided with a bendable portion.

19. The in-ear wearable device according to claim 17, wherein when the flexible circuit board is unfolded, the vent, the wearing state detector and the charging assembly are disposed on the same side of the flexible circuit board.
